(19) United States
(12) Patent Application Publication
(10) Pub. No.: US 2002/0180159 A1
(43) Pub. Date: Dec. 5, 2002

(54) Sealing device and positioning device using the same

(75) Inventors: Tsuyoshi Nakamura, Kanagawa (JP); Nobuhito Saji, Kanagawa (JP)

Correspondence Address: SUGHRUE, MION, ZINN,, MACPEAK & SEAS, PLLC, 2100 Pennsylvania Avenue, N.W., Washington, DC, 20037-3202, US

(73) Assignee: NSK LTD.

(21) Appl. No.: 10/013,352

(22) Filed: Dec. 13, 2001

(30) Foreign Application Priority Data
Dec. 13, 2000 (JP) P.2000-378725
Feb. 2, 2001 (JP) P.2001-26502
Feb. 15, 2001 (JP) P.2001-37864
Apr. 13, 2001 (JP) P.2001-115298

(51) Int. Cl. F16J 15/16

(52) U.S. Cl. 277/500

(57) ABSTRACT

A sealing device comprising: a box including an opening, and a process chamber which communicates with an outside through the opening; a slider slidable relative to the box in a state in which the opening is closed while a gap is left between the box and the slider; a differential evacuation seal for sealing the gap, the differential evacuation seal provided on the box side; and a roller bearing disposed between the box and the slider.

### BACKGROUND OF THE INVENTION

1. Field of the Invention

The present invention relates to a positioning device for externally driving and positioning a work placed in a process chamber isolated from an external environment, and to a sealing device for sealing the process chamber from the external environment.

2. Detailed Description of the Related Art

In a semiconductor producing apparatus, a work mounted on a stage in a process chamber kept in a vacuum or in a special gas atmosphere is moved so as to be subjected to a working process. If a positioning device (drive device) is provided in the process chamber, there is a risk that the inside of the process chamber may be contaminated due to scattering of a lubricant or the like supplied to a movable portion on which the work is mounted.

For example, an integral-type vacuum-sealed gas-bearing assembly is disclosed in U.S. Pat. No. 4,191,385. In such a related art, a movable portion which can move two-dimensionally is provided on a bearing block and a process chamber is further formed between the bearing block and the movable portion and sealed with a differential pumping seal from an outside so that a work mounted on the movable portion can be processed in the inside of the process chamber while the process chamber is kept in a vacuum environment. Hence, a drive portion for driving the work can be set outside the process chamber. As a result, it is possible to prevent the process chamber from being contaminated and it is easy to perform maintenance of the drive portion.

In the related art, such a positioning device as shown in FIGS. 54 to 56 may be thought of in order to locally minimize the suction force of the differential pumping seal. FIG. 54 is a sectional view of the positioning device, FIG. 55 is a sectional view of the positioning device of FIG. 54 which is taken along the line LV-LV and shown in the direction of arrows (in a state in which a slider is removed), and FIG. 56 is a sectional view of the positioning device of FIG. 55 which is taken along the line LVI-LVI and viewed from the direction of arrows.

In the positioning device shown in FIGS. 54 to 56, a differential evacuation seal 203 is provided in a surface of a box 201 having a process chamber P, which is opposite to a slider (movable portion) 202. The differential evacuation seal 203 is shaped like a track extended along the circumference of a long hole 207 (in which a cylindrical shaft 208 extended from the slider 202 side is inserted) formed in the box 201. A surface 203a of the track-like portion opposite to the movable portion 202 functions as an evacuation surface. The differential evacuation seal 203 further has three track-like groove portions 204, 205 and 206. The groove portions 204 and 205 communicate with communicating passages 210 formed in the box 201, through internal passages of the differential evacuation seal 203. The communicating passages 210 are connected to a suction pump (not shown). On the other hand, the groove portion 206 communicates with opposite ends of the box 201 to thereby be opened to atmospheric pressure. In FIG. 55, a large number of static-pressure gas bearing portions 212 are provided outside the evacuation surface 203a.

Incidentally, in the technique of U.S. Pat. No. 4,191,385 and the technique described with reference to FIGS. 54 to 56, a static-pressure bearing is used for jetting out air to thereby isolate the bearing block and the movable portion from each other contactlessly. The static-pressure bearing functions as a bearing because the repulsion force of the static-pressure bearing balances with the suction force of the differential evacuation seal. Hence, in case where air supply stops due to some trouble, the repulsion force of the static-pressure bearing may be reduced or lost. As a result, repulsion force of the static-pressure bearing and the suction force of the differential evacuation seal become out of balance, so that there is a risk that opposite surfaces may come into contact with each other because the function of the static-pressure bearing is lost. In addition, the size of the device becomes large because the static-pressure bearing needs a gas supply source, a pipe laying, etc.

For example, in a device disclosed in U.S. Pat. No. 4,726,689, an introduction shaft is inserted into an opening and a gap is sealed with an differential evacuation seal. Alternatively, a box which has openings at its opposite ends so that an introduction shaft is inserted in the openings and which has a bearing in its inside so that the bearing supports the introduction shaft may be provided in the process chamber. In this case, there is a possibility that foreign matter (exhaust air in the case of a static-pressure gas bearing or lubricant in the case of a roller bearing) may be leaked from the internal bearing into the process chamber.

In the former case, it is therefore conceived that an opening is provided in a box surrounding the process chamber to make it possible to keep the cleanliness level of the process chamber high, that a slider (introduction shaft) is driven by a positioning device provided outside the process chamber in the condition that the slider is inserted through the opening, and that a gap between the slider and the box is sealed with a differential evacuation seal. According to such configuration, the slider can be supported while sealed. In the latter case, it is conceived that differential evacuation seals are provided between the bearing and the opening at one end of the box and between the bearing and the opening at the other end of the box in order to prevent the process chamber from being contaminated.

Further, in the related art, when an unforeseen load is applied onto the slider or when the function of a static-pressure bearing is spoiled in the case where supporting is performed by the slider and the static-pressure bearing, there is a risk that the differential evacuation seal may come into contact with the slider. Moreover, there is a risk that such contact may occur when the device is adjusted to be assembled or when the slider is inserted into the opening. On this occasion, it may be conceived that the gap between the box and the slider is increased so as to suppress galling or seizing owing to the contact. Sealing performance is, however, reduced because of the increase of the gap.

On the other hand, it may be conceived that the differential evacuation seal is made of a porous material having self-lubricity so that galling or seizing can be suppressed while the gap is retained. There is, however, a risk that the performance of the differential evacuation seal may be reduced because the porous material is permeable to gas. It may be therefore conceived that the porous material is impregnated with a resin to suppress permeability of gas to thereby attain compatibility of sealing performance with the self-lubricity of the porous material. When the process chamber is evacuated in use, however, gas (so-called outgas) generated from the resin incorporated in the porous material flows into the process chamber to thereby prevent the process chamber from being kept in a vacuum.

Further, in this positioning device, evacuation from each differential evacuation seal is generally performed in accordance with the differential evacuation seal individually while connecting a flexible pipe (such as a rubber hose or a bellows tube) to the differential evacuation seal because the movable portion is moved relative to the stationary portion.

The stiffness of the pipe, however, increases as the diameter of the pipe increases in order to obtain good evacuating efficiency. Hence, if the pipe is fixed to the movable portion, the fixation may have influence on the kinetic accuracy of the movable portion. As a countermeasure to this, the movable portion and the bearing for supporting the movable portion need to have high stiffness. As a result, the size of the device is increased undesirably. Moreover, the problem of influence on the kinetic accuracy may be unable to be solved by the countermeasure to make the stiffness of the bearing high. Accordingly, it is difficult to increase the diameter of the pipe to a value larger than a predetermined value. For this reason, in the existing circumstances of the aforementioned drive device, it is impossible to improve evacuating efficiency (conductance) to increase the sealing capacity of the differential evacuation seal to a value higher than a predetermined value.

In addition, in the device (such as the device described in U.S. Pat. No. 4,726,689) used for the aforementioned purpose, the introduction shaft suffers force proportional to the product (ΔP·A) of the axially sectional area (A) of the introduction shaft and the differential pressure (ΔP) between the process chamber (vacuum) and the outside (atmospheric pressure) as suction force (or repulsion force if the pressure of the process chamber is higher than that of the outside).

The suction force can be ignored when the sectional area of the introduction shaft is small, but cannot be ignored as the sectional area of the introduction shaft increases.

### SUMMARY OF THE INVENTION

In consideration of the problems in the related art, therefore, a first object of the present invention is to provide a sealing device and a positioning device which are configured more simply without necessity of any gas supply source and any piping.

A second object of the invention is to provide a sealing device and a positioning device in which reliability is improved while sealing performance is kept high.

A third object of the invention is to provide a positioning device in which evacuating efficiency can be improved to make the sealing capacity of a differential evacuation seal high.

A fourth object of the invention is to provide a positioning device in which suction force (or repulsion force) received by an introduction shaft inserted in a process chamber is small.

To achieve the foregoing objects, according to a first aspect of the invention, there is provided a sealing device having:

a box including a process chamber communicating with an outside through an opening;

a slider which is slidable relative to the box in a condition that the opening is closed with a gap between the box and the slider;

a differential evacuation seal provided on the box side for sealing the gap; and

a roller bearing disposed between the box and the slider.

The sealing device according to the first aspect of the invention is configured as a drive device having: a box including a process chamber communicating with an outside through an opening; a slider which is slidable relative to the box along an outer wall surface of the box in a condition that the opening is closed; an introduction shaft facing the process chamber through the opening; and a differential evacuation seal for sealing a gap between the box and the slider; wherein a roller bearing is disposed between the box and the slider. Hence, it is unnecessary to provide any gas supply source and any piping thereof. The box and the slider can be supported relatively movably by simpler configuration. In addition, the roller bearing functions as a bearing regardless of the magnitude of suction force caused by differential pressure between the inside and outside of the process chamber. Hence, the drive device can be assembled easily without necessity of any complex operation such as adjustment of pressure.

Further, the sealing device according to the invention is configured as a drive device having: a box including a process chamber communicating with an outside through an opening; a slider which is slidable relative to the box along an outer wall surface of the box in a condition that the opening is closed; an introduction shaft facing the process chamber through the opening; and a differential evacuation seal for sealing a gap between the box and the slider; wherein the differential evacuation seal is provided on the box side. Hence, the length of the differential evacuation seal in the direction of the movement of the slider can be short favorably. As a result, the total size of the drive device can be reduced. Moreover, suction force or repulsion force having a magnitude proportional to the area of an evacuation surface of the differential evacuation seal is reduced, so that the structure of the device does not require high stiffness.

The “differential evacuation seal” used herein means a substance which functions to keep the atmospheres (for example, atmospheric pressure and high vacuum) of opposite sides with respect to opposite surfaces of the slider and the box constant while keeping the opposite surfaces contactless with each other by discharging gas from a small gap between respective members (the slider and the evacuation surface of the box). In the following description of embodiments of the invention, a member having an evacuation surface will be called “differential evacuation seal”.

The drive device according to the invention can be applied not only to a case where differential pressure which can cause suction force in the differential evacuation seal is present between the inside and the outside of the process chamber, but also to a case where differential pressure which can cause suction force in the differential evacuation seal is absent between the inside and the outside of the process chamber (for example, the case where the process chamber is in an atmosphere of N₂ with a pressure of 1 atmosphere), to a case where differential pressure (vacuum pressure) which can cause repulsion force in the differential evacuation seal is present between the inside and the outside of the high-pressure process chamber, and to a case where differential pressure between the inside and outside of the process chamber changes (for example, a case where a gate valve is opened/closed).

Further, in the invention, the opposite surfaces of the box and the slider through a small gap (the opposite surfaces of members which move relative to each other) maybe flat surfaces or curved surfaces.

Further, in the invention, a linear roller bearing having a linear guide can be used as the roller bearing or a rotary roller bearing may be used as the roller bearing.

Further, in the invention, when a bearing having such a linear guide is used as the roller bearing, it is preferable that the linear guide bearing is fixed to the box. Hence, the position where the box receives suction force is kept constant regardless of the position of the slider.

Further, in the invention, it is preferable that the introduction shaft facing the process chamber through the opening is supported by the slider so as to be slidable in the axial direction of the introduction shaft. Hence, when the slider is slid relative to the box and the introduction shaft is slid relative to the slider (in a direction perpendicular to the direction of sliding the slider), the work supported by the introduction shaft can be driven two-dimensionally in the process chamber. On this occasion, the gap between the introduction shaft and the slider may be sealed with the differential evacuation seal.

According to a second aspect of the invention, there is provided a sealing device having:

a box including a process chamber communicating with an inside or inside through an opening;

a slider (introduction shaft) which is slidable relative to the box in a condition that the opening is closed with a gap between the box and the slider; and

a differential evacuation seal including an evacuating mechanism for sealing the gap, the differential evacuation seal having a first region adjacent to the process chamber, and a second region farther from the process chamber than the first region, wherein:

at least one portion of the first region is made of a material excellent in vacuum characteristic compared with the member of the second region; and

the distance between the first region and the slider is larger than the distance between the second region and the slider.

In the sealing device according to the second aspect of the invention, at least one portion of the first region adjacent to the process chamber is made of a material excellent in vacuum characteristic. Hence, there is no outgas generated from this portion. Moreover, even in the case where outgas is generated from the differential evacuation seal, the vacuum state of the process chamber can be retained effectively. It is because the first region is nearest to the process chamber so that evacuation by use of the differential evacuation seal can prevent the outgas from moving to the process chamber side. In addition, because the distance between the first region and the slider is set to be larger than the distance between the slider and the second region which is provided on the side farther from the process chamber than the first region, contact between the first region on the box side and the slider can be prevented to thereby suppress galling or seizing.

The “material excellent in vacuum characteristic” used herein means a material which is small in gas released from its surface and inside when the material is put in a vacuum. The process chamber is evacuated by a pump in order to the inside of the process chamber in a high vacuum state. On this occasion, when a large amount of gas is adsorbed/occluded to the surface/inside of the material exposed to the inside of the process chamber, a longtime is required for obtaining a desired degree of vacuum, or it is impossible to obtain a desired degree of vacuum if things come to the worst. Incidentally, the “high vacuum or a higher degree of vacuum”, for example, shows a pressure of 10⁻⁴ Pa or less.

Main factors having influence on the vacuum characteristic are the composition of the material, the surface roughness of the material and the cleanliness level of the material.

Examples of the material capable of being used without any surface modification which will be described later include ceramics, and various kinds of metals (such as 18Cr-8Ni austenitic stainless steel (SUS304), titanium alloy, and aluminum alloy). Specific examples of SUS304 may include: SUS304L in which the carbon content is suppressed in order to reduce carbide having a large influence on corrosion characteristic; SUS304 containing Ti (titanium) or Nb (niobium) as additives and stabilized by production of carbide of Ti or Nb; and SUS30LN containing nitrogen as additives compensating for reduction of mechanical strength caused by suppression of the carbon content. Any material such as martensitic stainless steel or ferritic stainless steel may be used as the stainless steel if a desired degree of vacuum can be obtained.

Further, baking (a process of heating the material put in the process chamber to thereby forcedly release gas from the surface and inside of the material) may be performed. In this case, heat resistance of hundreds of degrees centigrade is also required.

When charged particles are used in a process performed on the process chamber, the box is preferably made of a magnetic substance which can suppress the influence of external magnetic field. In this case, the box can be made of a magnetic substance only when the box is fixed. On the other hand, when the box is movable during the process, it is necessary that the box is made of a nonmagnetic substance. Hence, it is preferable that the stationary portion of the box facing the process chamber is made of a magnetic substance whereas the slider moving in the process chamber is made of a nonmagnetic substance.

Assuming now that two materials of the same are provided, larger one in surface roughness is apt to adsorb a larger amount of gas to its surface. Hence, a material as small in surface roughness as possible is preferably used and a polishing process is preferably applied thereto. Examples of the polishing process include electrolytic polishing, mechanical polishing and chemical polishing.

A pre-treatment such as high-temperature pre-baking, electric-discharge cleaning or thermal oxidation may be used as a treatment for improving the cleanliness level.

Even soft steel can be used in a high vacuum when a suitable surface modifying treatment is applied to the soft steel. For example, soft steel electroplated with chromium or nickel may be used. Otherwise, a method of precipitating boron nitride on the surface of soft steel may be used. Incidentally, the portion made of a material excellent in vacuum characteristic may be made of the same material as that of the box but the material of the position is not limited thereto. The second region far from the process chamber may be made of a porous material such as graphite or may be made of a resin material such as Teflon. The inside of the process chamber may be evacuated into a vacuum or may be filled with a corrosive gas. In the latter case, the first region is preferably made of a material excellent in corrosion resistance.

Further, the first region may be made of a porous material and the portion facing the process chamber may be coated or shielded with ceramics excellent in vacuum characteristic.

According to a third aspect of the invention, there is provided a sealing device having:

first, second and third members which is movable relative to one another; and

first and second differential evacuation seals for performing sealing among the first, second and third members, wherein the first and second differential evacuation seals communicate with each other through passages provided inside at least one of the first, second and third members; and

evacuation from the first and second differential evacuation seals is performed through the passages.

The drive device according to the invention is a sealing device having a plurality of members (first, second and third members) which is movable relative to one another, and a plurality of differential evacuation seals (first and second differential evacuation seals) for performing sealing among the members, wherein: the plurality of differential evacuation seals communicate with one another through passages provided inside the members; and evacuation from the plurality of differential evacuation seals is performed through the passages. Hence, evacuation from the differential evacuation seals is performed through the fixed passages provided inside of the members of each of which the diameter can be made larger than that of a flexible pipe, whereby evacuating efficiency can be improved to increase the sealing capacity of the differential evacuation seals. Because evacuating efficiency is improved, a vacuum pump small in capacity and size can be used in a condition that the pump is attached into each member. Further, because the passages through which evacuation from the plurality of differential evacuation seals is performed communicate with one another, it is unnecessary to connect pumps to the members individually. Hence, a pump can be connected to only one member having the final evacuation outlet among the communicating passages. All the members can be evacuated by use of the smallest number of pumps.

In the invention, the plurality of differential evacuation seals preferably communicate in series with one another through the passages provided inside the members. Hence, evacuating efficiency can be improved more greatly. In this case, one end of the connected in series communicating passages is preferably provided on a fixed member of the plurality of members. Hence, the evacuating point can be kept in a constant position.

Incidentally, in the invention, the differential evacuation seals may be provided on either of two opposite members. At least one passage can be provided between members. To improve evacuating efficiency, a plurality of passages may be preferably provided. It is preferable that the number of the passages and the thickness of each of the passages are determined suitably in accordance with the performance of the vacuum pump.

In the invention, bearings such as roller bearings or static-pressure bearings are preferably provided among the plurality of members. Hence, the members can be easily moved relative to one another.

According to a fourth aspect of the invention, there is provided a sealing device having:

a box including a pair of openings opposite to each other, and a process chamber communicating with an outside through the pair of openings; and

an introduction shaft which can move in at least one degree of freedom and which passes through the pair of openings while sealing the process chamber.

In the sealing device according to the invention, the introduction shaft passes through the pair of openings, so that suction forces (or repulsion forces) acting on the introduction shaft cancel out each other. That is, because no thrust force acts on the introduction shaft, there is no excessive load imposed on the device for driving the introduction shaft. Hence, imbalance in accordance with the direction of the movement is eliminated. When, for example, the introduction shaft is disposed nearly horizontally, the introduction shaft is supported by the pair of openings so that distortion of the introduction shaft can be suppressed compared with the case where the introduction shaft is supported by one side. Hence, positioning accuracy is improved. For example, a differential evacuation seal can be used as the seal.

In the invention, the introduction shaft is supported by a support member outside one or each of the pair of opposite openings. The support member may be a stationary member or maybe a movable member (so-called X-axis stage) which can move in a direction substantially perpendicular to the direction of the axis of the introduction shaft.

### BRIEF DESCRIPTION OF THE DRAWINGS

FIG. 1 is a sectional view of a positioning device according to a first embodiment of the present invention;

FIG. 2 is a sectional view taken along the line II-II and from the direction of arrows, showing the positioning device depicted in FIG. 1;

FIG. 3A is a sectional view taken along the line III-III and from the direction of arrows, showing the positioning device depicted in FIG. 1;

FIG. 3B is a view showing a bearing 13 depicted in FIG. 3A;

FIG. 4 is a plan view of a positioning device according to a second embodiment of the invention;

FIG. 5 is a sectional view taken along the line V-V and from the direction of arrows, showing the positioning device depicted in FIG. 4;

FIG. 6 is a side view of a drive device according to a third embodiment of the invention;

FIG. 7 is a sectional view taken along the line VII-VII and from the direction of arrows, showing the drive device depicted in FIG. 6;

FIG. 8 is a view showing a state in which the X-axis stage in the drive device depicted in FIG. 6 is slid;

FIG. 9 is a sectional view of a drive device according to a fourth embodiment of the invention;

FIG. 10A is a plan view of the X-axis stage used in the drive device depicted in FIG. 9, showing a surface opposite to the box 110;

FIG. 10B is a front view of FIG. 10A;

FIG. 10C is a sectional view taken along the line A-A in FIG. 10A;

FIG. 11A is a perspective view of a box used in the drive device depicted in FIG. 9;

FIG. 11B is a plan view of FIG. 11A;

FIG. 11C is a sectional view taken along the line B-B in FIG. 11B;

FIG. 11D is a side view in section taken along the line C-C in FIG. 11C;

FIG. 12 is a perspective view schematically showing a fifth embodiment of the invention;

FIG. 13 is a sectional view of the positioning device depicted in FIG. 12, cut at a plane parallel to the axial line of the slider;

FIG. 14 is a horizontal sectional view of a positioning device without using any static-pressure bearing according to a sixth embodiment of the invention;

FIG. 15 is a vertical sectional view taken along the line XV-XV in FIG. 14, showing the positioning device according to the sixth embodiment;

FIG. 16 is a view from the direction of the arrow XVI, showing the configuration of FIG. 14 as a modified example of the positioning device according to the sixth embodiment;

FIG. 17 is an enlarged view of the portion XVII in the configuration of FIG. 14 in the positioning device according to the sixth embodiment;

FIG. 18 is a sectional view showing a seventh embodiment of the invention;

FIG. 19 is a view similar to FIG. 13, showing a first modified example of the fifth embodiment;

FIG. 20 is a view similar to FIG. 18, showing a first modified example of the seventh embodiment;

FIG. 21 is a view similar to FIG. 13, showing a second modified example of the fifth embodiment;

FIG. 22 is a view similar to FIG. 18, showing a second modified example of the seventh embodiment;

FIG. 23A is a view showing a state in which the axial center of the opening 201a coincides with the axial center of the slider 202;

FIG. 23B is a view showing a state in which the slider 302 is inclined most greatly;

FIG. 24 is a typical plan view of a positioning device according to an eighth embodiment of the invention;

FIG. 25 is a sectional view taken along the line XXV-XXV and from the direction of arrows, showing the positioning device depicted in FIG. 24;

FIG. 26 is a sectional view taken along the line XXVI-XXVI and from the direction of arrows, showing the positioning device depicted in FIG. 24;

FIG. 27 is a detailed plan view of the positioning device according to the eighth embodiment of the invention;

FIG. 28 is a sectional view taken along the line XXVIII-XXVIII and from the direction of arrows, showing the positioning device depicted in FIG. 27;

FIG. 29 is a side view of the positioning device depicted in FIG. 27;

FIG. 30 is a sectional view taken along the line XXX-XXX and from the direction of arrows, showing the positioning device depicted in FIG. 27;

FIG. 31 is a typical plan view of a positioning device according to a ninth embodiment of the invention;

FIG. 32 is a sectional view taken along the line XXXII-XXXII and from the direction of arrows, showing the positioning device depicted in FIG. 31;

FIG. 33 is a sectional view taken along the line XXXIII-XXXIII and from the direction of arrows, showing the positioning device depicted in FIG. 31;

FIG. 34 is a typical plan view of a positioning device according to a tenth embodiment of the invention;

FIG. 35 is a sectional view taken along the line XXXV-XXXV and from the direction of arrows, showing the positioning device depicted in FIG. 34;

FIG. 36 is a detailed view showing important part of FIG. 35;

FIG. 37 is a typical plan view of a positioning device according to an eleventh embodiment of the invention;

FIG. 38 is a sectional view taken along the line XXXIIX-XXXIIX and from the direction of arrows, showing the positioning device depicted in FIG. 37;

FIG. 39 is a front view of a positioning device according to a twelfth embodiment of the invention;

FIG. 40 is a detailed view showing the vicinity of an opening containing a bearing portion in FIG. 39;

FIG. 41 is a sectional view of important part of a positioning device according to a thirteenth embodiment of the invention;

FIGS. 42A and 42B are a plan view and a front view of a positioning device according to a fourteenth embodiment of the invention;

FIG. 43 is a plan view (partial sectional view) of a positioning device according to a fifteenth embodiment of the invention;

FIG. 44 is a front view of the positioning device depicted in FIG. 43;

FIG. 45 is a right-side side view of the positioning device depicted in FIG. 43;

FIGS. 46A and 46B are left-side side views of the positioning device depicted in FIG. 43;

FIG. 47 is a plan view (partial sectional view) of a positioning device according to a sixteenth embodiment of the invention;

FIGS. 48A and 48B are detailed views of a Y-axis bearing portion in the positioning device depicted in FIG. 47;

FIG. 49 is a side view of a positioning device according to a seventeenth embodiment of the invention;

FIG. 50 is a side view of important part of a positioning device according to an eighteenth embodiment of the invention;

FIG. 51 is a sectional view taken along the line LI-LI in FIG. 50;

FIG. 52 is a typical view of a rotation stopper portion in the positioning device depicted in FIG. 50;

FIG. 53 is a sectional view of a shaft member incorporated in a positioning device according to a nineteenth embodiment of the invention;

FIG. 54 is a sectional view of a positioning device as the related art of a positioning device disclosed in U.S. Pat. No. 4,191,385;

FIG. 55 is a sectional view taken along the line LV-LV and from the direction of arrows, showing the positioning device depicted in FIG. 12; and

FIG. 56 is a sectional view taken along the line LVI-LVI and from the direction of arrows, showing the positioning device depicted in FIG. 13.

### DETAILED DESCRIPTION OF THE PREFERRED EMBODIMENTS

Embodiments of the present invention will be described below in detail with reference to the drawings.

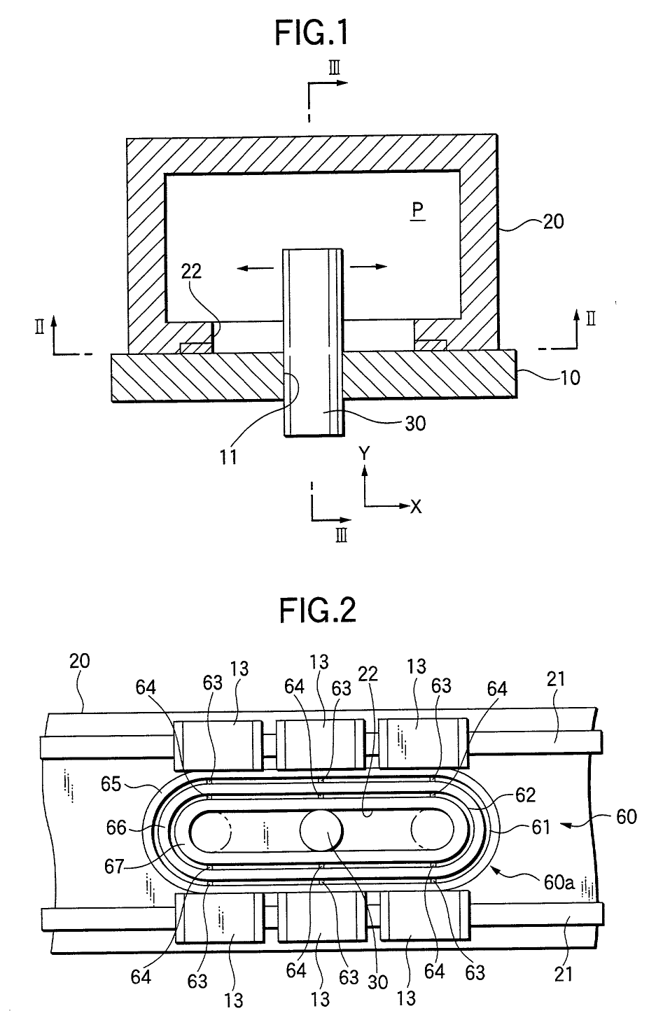

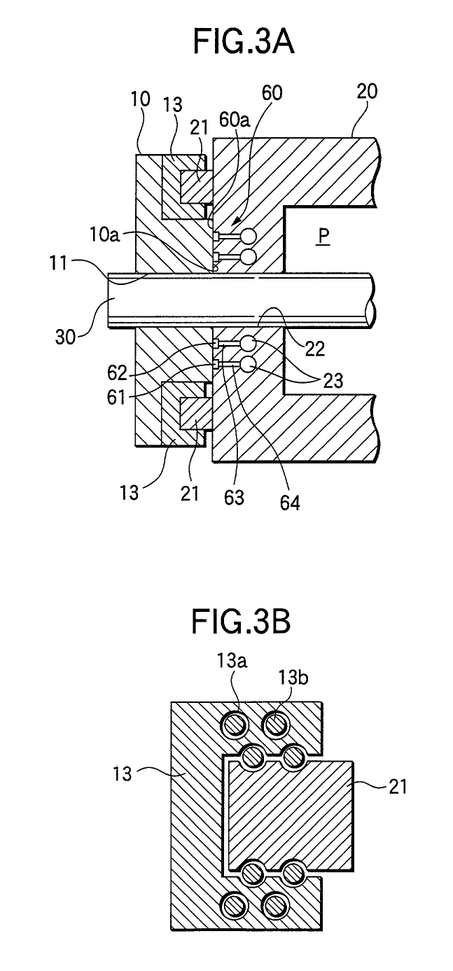

FIG. 1 is a sectional view of a positioning device according to a first embodiment of the present invention. FIG. 2 is a view taken along the line II-II and from the direction of arrows, showing the positioning device depicted in FIG. 1. FIG. 3A is a view taken along the line III-III and from the direction of arrows, showing the positioning device depicted in FIG. 1, and FIG. 3B is a view showing a bearing depicted in FIG. 3A.

An X-axis stage (slider) 10 which is a movable portion has a circular opening 11 in the center thereof. A cylindrical shaft (introduction shaft) 30 is inserted and fixed into the opening 11. A forward end portion of the cylindrical shaft 30 passes through the X-axis stage 10 and faces a process chamber P through a long hole 22 which will be described later.

As shown in FIG. 3A, upper three bearings (slide members) 13 and lower three bearings (slide members) 13, that is, six bearings (slide members) 13 are disposed in the right-side surface of the X-axis stage 10. Each of the bearings 13 is U-shaped in section. As shown in FIG. 3B, a pair of guide rails 21 are disposed on the box 20 which is a stationary portion, and the bearings 13 are fitted to the pair of guide rails 21 through a large number of rolling bodies 13b which circulate in circulation passages 13a in the bearings 13 so that the bearings 13 can slide freely along the guide rails 21 in a direction perpendicular to a plane on which FIG. 3A is drawn. The bearings 13, the guide rails 21 and the large number of rolling bodies 13b constitute a linear guide which is a kind of roller guide bearing. In FIG. 3A, the box 20 having the guide rails 21 attached to its left-side surface is provided on the right side of the X-axis stage 10. Incidentally, a process chamber P is formed in the inside of the box 20.

In FIG. 3A, a differential evacuation seal 60 (differential evacuation sealing device) for sealing a gap between the box 20 and the X-axis stage 10 is provided on the left-side surface of the box 20. As shown in FIG. 2, the differential evacuation seal 60 is shaped like a track extended along the circumference of the long hole 22 formed in the box 20. A surface 60a of the track-like portion opposite to the X-axis stage 10 functions as an evacuation surface of the differential evacuation seal 60. The differential evacuation seal 60 further forms two track-like grooves 61 and 62, which communicate with communicating passages 23 and 23 formed in the box 20, through internal passages 63 and 64 of the evacuation seal 60. The communicating passages 23 and 23 are connected to a suction pump (not shown). In the surface of the box 20 opposite to the X-axis stage 10, portions 65, 66 and 67 of the track-like evacuation surface 60a except for the groove portions 61 and 62 are slightly protruded frontward in FIG. 2 compared with portions provided outside the portions 65, 66 and 67. The linear guide sets the protruded portions and the surface 10a (opposite seal surface) of the X-axis stage 10 opposite thereto so that the protruded portions are opposite to the surface 10a at a sufficiently small distance compared with the portions provided outside the protruded portions.

The operation of this embodiment will be described below. In FIG. 1, the left-right direction is defined as an X-axis direction and the up-down direction as a Y-axis direction. Because the X-axis stage 10 is supported relative to the box 20 in a low friction state by the linear guide constituted by the guide rails 21, the bearings 13 and the large number of rolling bodies 13b, the X-axis stage 10 can be driven to move in the X-axis direction relative to the box 20 through a ball screw by an external drive source (not shown). On this occasion, the cylindrical shaft 30 moves together with the X-axis stage 10 in the X-axis direction because the long hole 22 (equivalent to the opening in the invention) in the box 20 allows the cylindrical shaft 30 to move in the X-axis direction. In other words, the X-axis stage 10 can move in the X-axis direction relative to the box 20 in a range defined by the length of the long hole 22.

On this occasion, the differential evacuation seal 60 having the evacuation surface 60a sucks air between the box 20 and the upper surface 10a (opposite seal surface) of the X-axis stage 10 through the communicating passages 23 of the box 20 on the basis of the suction force of the suction pump (not shown). Accordingly, external air and foreign matter can be prevented from entering the process chamber P through the gap between the X-axis stage 10 and the box 20. Hence, even in the case where the process chamber P in the box 20 is put in a vacuum environment in order to process the work, the process chamber P can be preferably kept in the vacuum environment because the differential evacuation seal 60 can prevent external air from entering the process chamber P. Also in the case where the process chamber P is filled with a gas, the gas can be recovered by the differential evacuation seal so that the gas can be prevented from leaking out of the process chamber P and so that the recovered gas can be re-used.

Incidentally, dust generated from the linear guide which is a rolling element is insignificant because the dust is sucked by the differential evacuation seal 60. Therefore, grease or oil allowed to be used in the air can be Generally used as a lubricant. The device as a whole, however, may be set in a clean room in the air. In such a case, grease of dust-free clean specifications or a solid lubricant may be preferably used in order to keep the environment of the clean room in which a positioning device is set.

Further, in accordance with this embodiment, it is possible to prevent contamination of the process chamber P and it is easy to perform maintenance of the drive system without necessity of provision of the drive system in the process chamber P because the X-axis stage 10 is driven from the outside of the box 20. Moreover, because the range on which the suction force of the differential evacuation seal 60 acts is defined in the track-like range shown in FIG. 2, the whole length of the differential evacuation seal 60 need not be made large even in the case where the size of the box 20 is made large. Accordingly, the supporting reaction force of the bearings 13 and the guide rails 21 constituting the linear guide does not change. Moreover, in the surface of the X-axis stage 10 opposite to the box 20, because the force received by the portion provided outside the evacuation surface 60a becomes equal to the atmospheric pressure, the portion having differential pressure between its front and rear surfaces is a limited area inside the evacuation surface 60a in consideration of the distribution of pressure acting on the front and rear surfaces of the X-axis stage 10. Hence, the force to be supported by the linear guide can be selected to be small because the force is only a force countering to the sum of differential pressure on the limited area.

Although this embodiment has shown the case where the groove portions 61 and 62 of the differential evacuation seal 60 are provided on the box 20 side so as to be adjacent to the long hole 22, the invention may be applied also to the case where the groove portions are provided on the X-axis stage 10 side. In this case, it is however necessary to form the evacuation surface 60a so that the evacuation surface 60a surrounds the long hole 22 in the all movable range of the X-axis stage 10 when the evacuation surface 60a is viewed from the direction (corresponding to FIG. 2) opposite to the long hole 22. Therefore, the evacuation surface 60a needs to have a length corresponding to the stroke (of long hole 22+cylindrical shaft 30) which is the movable range of the cylindrical shaft 30. It is therefore necessary to make the guide rails 21 long in accordance with increase in the length of the evacuation surface 60a. As a result, the size of the positioning device as a whole becomes large. Particularly when differential pressure exists between the inside and outside of the process chamber P, there is a demerit that the structure of the device need have high stiffness because suction force or repulsion force acting on the evacuation surface 60a of the differential evacuation seal 60 increases as the area of the evacuation surface 60a increases. Therefore, when the groove portions 61 and 62 of the differential evacuation seal 60 are provided on the box 20 side so as to be adjacent to the long hole 22 as described in this embodiment, there is a merit that the size of the device can be reduced and the structure of the device need not have high stiffness. When the box 20 and the X-axis stage 10 are provided as a stationary portion and as a movable portion respectively as in the embodiment, the differential evacuation seal 60 is provided in the stationary portion. Hence, even in the case where the X-axis stage 10 moves, the pipes between the communicating passages 23, 23 and the suction pump do not move. Though relatively large-diameter rigid pipes are required for evacuation, there is also a merit that the influence of the pipes is eliminated.

It may be conceived that a pipe connected to the suction pump is provided on the side of the box which is a stationary portion whereas an evacuation surface is provided on the X-axis stage side. In this case, however, the area of the evacuation surface is increased as described above. Moreover, because the evacuation surface is long, the flow quantity of gas from the small gap between the evacuation surface and each of portions 65, 66 and 60a increases. On the other hand, communicating passages equivalent to the internal passages 63 and 64 for evacuation need to be provided on the box side so as to be always opposite to the groove portions of the evacuation surface.

That is, like this embodiment, the range in which such passages can be provided is defined in a portion along the linear portion (the constant width range) of the opening. To obtain the same sealing performance as in the case where the groove portions are provided on the box side, it is therefore necessary to take measures in which a high performance (capacity) pump is used and in which the pipe diameter is increased to reduce evacuation resistance (increase conductance).

Further, in accordance with this embodiment, the linear guide which is a roller bearing is disposed between the box 20 and the X-axis stage 10. Hence, a gas supply source and laying pipes required of a static-pressure bearing need not be provided. Simplification and cost reduction of the positioning device can be attained. Moreover, because the linear guide functions as a roller bearing regardless of the magnitude of suction force caused by differential pressure between the inside and outside of the process chamber P, the positioning device can be assembled easily without necessity of any complex operation such as adjustment of pressure.

Incidentally, when differential pressure between the inside and outside of the process chamber P changes in the first embodiment, a highly stiff rolling element little in the change of height caused by the change of suction force may be used as the roller bearing so that the gap width of the differential evacuation seal 60 can be prevented from changing in accordance with the situation.

Although the first embodiment of the invention has been described above, various changes and modifications may be made on the embodiment. For example, the first embodiment has shown the case where two groove portions 61 and 62 are provided in the evacuation surface 60a. However, the invention is not limited thereto and one groove portion or three or more groove portions may be provided in accordance with the performance of the suction pump and the magnitude of differential pressure between the inside and outside of the process chamber. The size of the gap between the evacuation surface 60a and the opposite seal surface is also determined in accordance with the performance of the suction pump and can be selected suitably to be in a range of from the order of microns to the order of hundreds of microns. The roller bearing is not limited to the guide bearing constituted by guide rails 21 and bearings 13 as described in this embodiment. Any kind of roller bearing may be used as the roller bearing. For example, the linear guide used as the guide bearing for the X-axis stage 10 may be replaced by another roller guide bearing (such as a cross roller guide). The posture of setting of the positioning device is not particularly limited. For example, the positioning device may be set so that the direction shown in FIG. 1 or FIG. 3A is a frontal direction. For example, the state shown in FIG. 1 may be turned upside down so that the X-axis stage is disposed on the upside. When, for example, distortion of the shaft 30 is unfavorable, the posture maybe determined suitably so that the shaft 30 can be disposed vertically.

The differential evacuation seal 60 and the box 20 may be provided as an integral body or as separate bodies. Protrusions of the evacuation surface 60a from the outer portion of the box 20 may be replaced by grooves which are provided along the outer circumference of the evacuation surface 60a and on the outside of at least opposite end portions, that is, on the outside of circular arc portions in this embodiment so that the grooves communicate with the atmosphere. Further, the shapes of the long hole 22, the evacuation surface 60a and the grooves 61 and 62 of the evacuation surface are also not limited to the shapes shown in FIG. 2. The respective counter guide surfaces of the box 20 and the X-axis stage 10 may be flat surfaces as described in this embodiment or may be curved surfaces.

In addition, this embodiment has shown the case where the box 20 is provided as a stationary portion whereas the X-axis stage 10 is provided as a movable portion. Inversely, the X-axis stage 10 may be provided as a stationary portion whereas the box 20 may be provided as a movable portion.

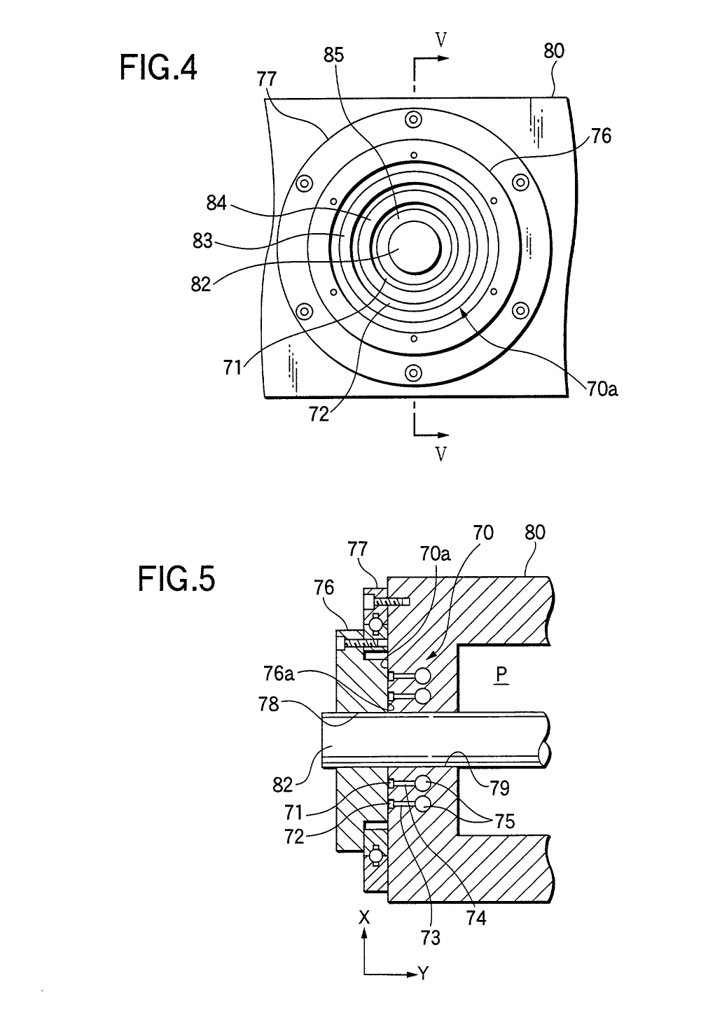

A second embodiment of the invention will be described below with reference to FIGS. 4 and 5. FIG. 4 is a plan view of a positioning device according to a second embodiment of the invention. FIG. 5 is a sectional view taken along the line V-V and from the direction of arrows, showing the positioning device depicted in FIG. 4. In this embodiment, a rotary type bearing is used as the roller bearing.

A disk-like rotary stage (slider) 76 which is a movable portion has a circular opening 78 in its center. A cylindrical shaft (introduction shaft) 82 is inserted and fixed into the opening 78. A forward end portion of the cylindrical shaft 82 passes through the rotary stage 76 and faces a process chamber P through a circular hole 79 which will be described later.

As shown in FIG. 5, the rotary stage 76 is supported at its edge portion by an annular bearing 77 which is a rotary type roller bearing fixed and disposed on the left side of the box 80 having the process chamber P formed in its inside. Hence, the rotary stage 76 can rotate around its center while the slight gap between the rotary stage 76 and the box 80 is retained.

In FIG. 5, a differential evacuation seal 70 (differential evacuation sealing device) for sealing a gap between the box 80 and the rotary stage 76 is provided on the left-side surface of the box 80. As shown in FIG. 5, the differential evacuation seal 70 is shaped like an annular shape extended along the circumference of the circular hole 79 formed in the box 80. A surface 70a of the annular portion opposite to the rotary stage 76 functions as an evacuation surface of the differential evacuation seal 70. Further, the differential evacuation seal 70 further forms two annular grooves 71 and 72, which communicate with communicating passages 75 and 75 formed in the box 80, through internal passages 73 and 74 of the evacuation seal 70. The communicating passages 75 and 75 are connected to a suction pump (not shown). In the portion of the box 80 opposite to the rotary stage 76, portions 83, 84, and 85 of the evacuation surface 70a except the groove portions 71 and 72 are slightly protruded frontward in FIG. 4 compared with portions provided outside the portions 83, 84, and 85. The bearing 77 (roller bearing) sets the protruded portions and the surface 76a (opposite seal surface) of the rotary stage 76 opposite thereto so that the protruded portions are opposite to the surface 76a at a sufficiently small distance compared with the portions provided outside the protruded portions.

The operation of this embodiment will be described below. In FIG. 5, the up-down direction is defined as an X-axis direction and the left-right direction as a Y-axis direction. Because the rotary stage 76 is supported relative to the box 80 in a low friction state by the bearing 77 (roller bearing), the rotary stage 76 can be driven to be ratotable around its axis and in parallel to the box 80 by an external drive source (not shown) this occasion, the cylindrical shaft 82 rotates around its axis together with the rotary stage 76.

On this occasion, the differential evacuation seal 70 having the evacuation surface 70a sucks air between the differential evacuation seal 70 and the upper surface 76a (opposite seal surface) of the rotary stage 76 through the communicating passages 75 of the box 80 on the basis of the suction force of the suction pump (not shown). Accordingly, external air and foreign matter can be prevented from entering the process chamber P through the gap between the rotary stage 76 and the box 80. Hence, even in the case where the process chamber P in the box 80 is put in a vacuum environment in order to process the work, the process chamber P can be preferably kept in the vacuum environment because the differential evacuation seal 70 can prevent external air from entering the process chamber P. Also in the case where the process chamber P is filled with a gas, the gas can be recovered by the differential evacuation seal so that the gas can be prevented from leaking out of the process chamber P.

In this embodiment, the groove portions 71 and 72 of he differential evacuation seal 70 are provided on the side of the box 80 so as to be adjacent to the circular hole 79. Hence, like the first embodiment, there is an advantage in that he structure of the device need not have high stiffness as well as the size of the device can be reduced. Further, in accordance with this embodiment, the bearing 77 which is a roller bearing is disposed between the box 80 and the rotary stage 76. Hence, simplification and cost reduction of the positioning device can be attained. Moreover, because the bearing 77 functions as a roller bearing regardless of the magnitude of suction force caused by differential pressure between the inside and outside of the process chamber P, the positioning device can be assembled easily without necessity of any complex operation such as adjustment of pressure.

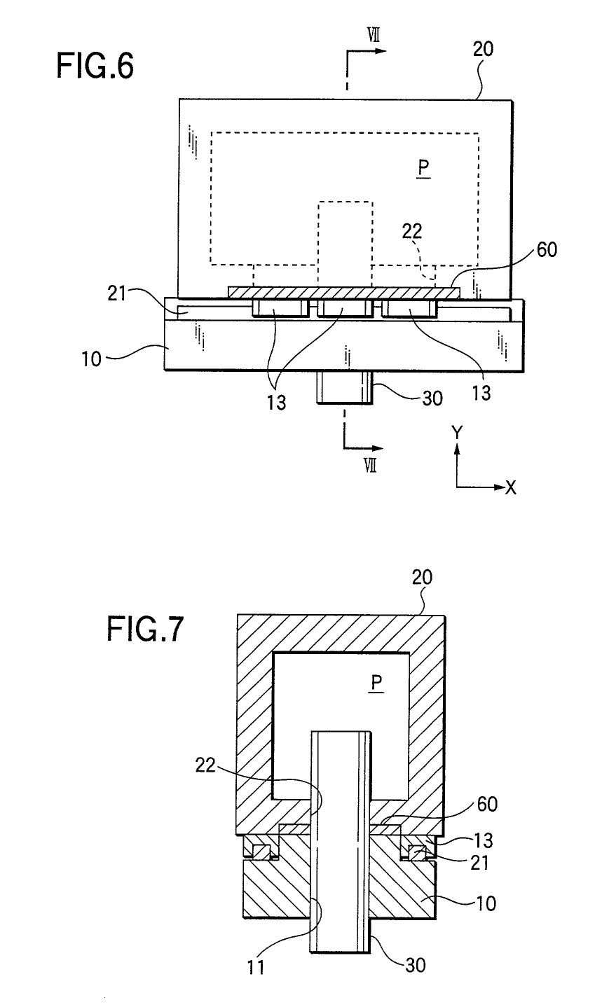

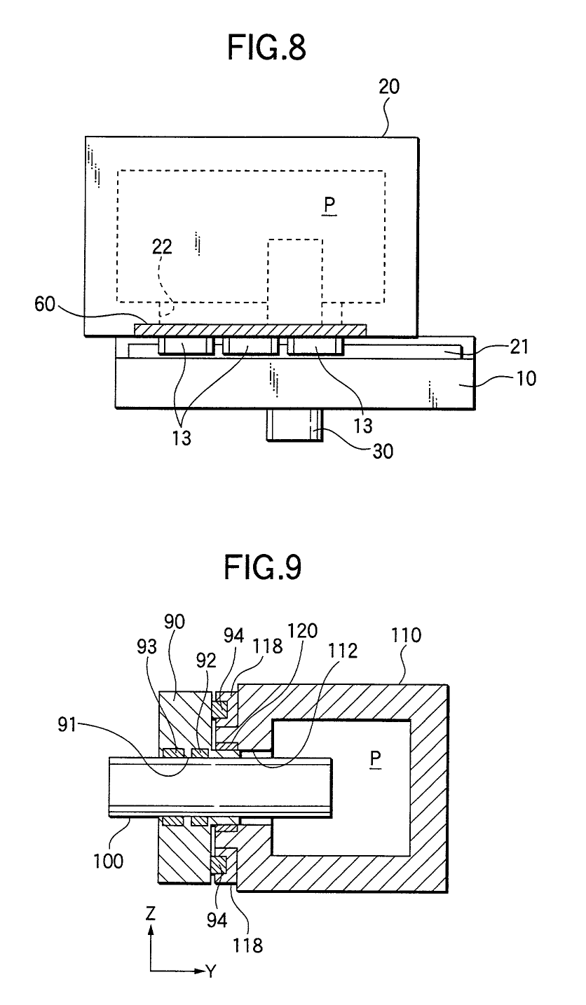

A third embodiment of the invention will be described below with reference to FIGS. 6 to 8. FIG. 6 is a side view of a positioning device according to a third embodiment of the invention. FIG. 7 is a sectional view taken along the line VII-VII and from the direction of arrows, showing the positioning device depicted in FIG. 6. FIG. 8 is a view showing a state in which the X-axis stage in the positioning device depicted in FIG. 6 is slid.

This embodiment is different from the first embodiment in that the bearing 13 of the linear guide is fixed to the box 20 and the guide rails 21 are fixed to the X-axis stage. In this embodiment, parts the same as those in the first embodiment are referenced correspondingly and the description of the parts will be therefore omitted.

As shown in FIGS. 6 to 8, in this embodiment, two guide rails 21 are disposed on a counter surface of the X-axis stage (slider) 10 as a movable portion opposite to the box 20. Three bearings 13 corresponding to each of the guide rails 21, that is, six bearings 13 in total are disposed on a counter surface of the box 20 opposite to the X-axis stage 10. In FIGS. 6 to 8, the differential evacuation seal 60 is shown schematically. Also in this embodiment, the X-axis stage 10 can be slid in the X direction relative to the box 20 in the same manner as in the first embodiment.

In this embodiment configured as described above, the same effect as in the first embodiment can be obtained. Moreover, the position of suction force given from the guide rails 21 to the box 20 through the bearings 13 can be kept constant regardless of the positional change of the X-axis stage 10 owing to sliding. That is, in this embodiment, the bearings 13 and the evacuation surface 60a of the differential evacuation seal 60 are provided on the side of the box 20. Hence, even in the case where the position of the X-axis stage 10 changes, the positions of the bearings 13 and the evacuation surface 60a relative to the box 20 do not change. In a state in which the differential evacuation seal 60 operates, forces acting on the stationary portion constituted by the box 20 and the movable portion constituted by the X-axis stage 10 are a suction force of a portion of the evacuation surface 60a and a force (bearing support force) acting on the bearings 13 and guide rails 21 against the suction force. The two forces balance with each other. In this embodiment, as described above, the position of the evacuation surface 60a and the positions of the bearings 13 do not change regardless of the position of the X-axis stage 10. Hence, even in the case where the X-axis stage 10 is moved to a one-sided position as shown in FIG. 8, the supporting force of each of the bearings 13 little changes. Hence, there is no moment load caused by the suction force of the differential evacuation seal 60 and acting to disorder the parallelism between the box 20 and the X-axis stage 10. Hence, the box 20 and the X-axis stage 10 are kept parallel to each other, so that there is no problem in reduction of sealing performance and reduction of the kinetic accuracy (straightness) of the X-axis stage 10 in the X-axis direction owing to partial widening of the gap between the evacuation surface 60a and a surface opposite to the evacuation surface 60a. On the other hand, when the bearings 13 are disposed on the X-axis stage 10 side as described in the first embodiment, the position from the bearings 13 changes as the position of the X-axis stage 10 changes. Hence, when the suction force is large, it maybe necessary to take measures in which the supporting bearings 13 are provided as highly stiff bearings in consideration of the influence of the moment load in the case where the X-axis stage 10 is located in a one-sided position. Particularly even in the case where the suction force is very large so as to reach the order of thousands of N, increase in size for making the stiffness of the device high can be avoided according to this embodiment.

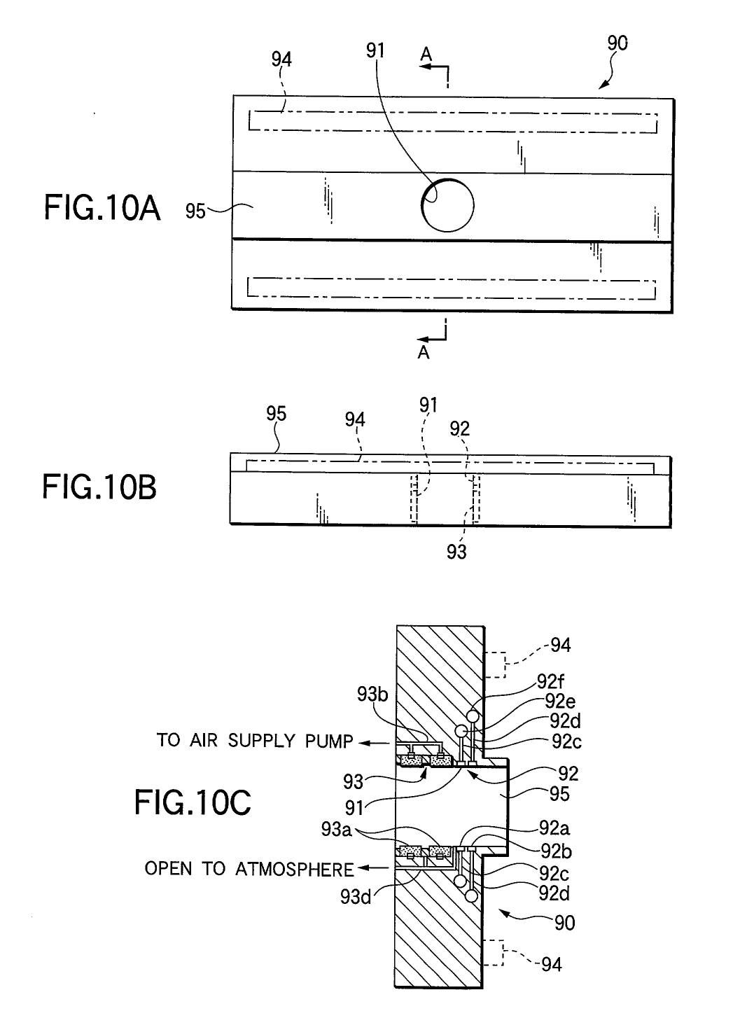

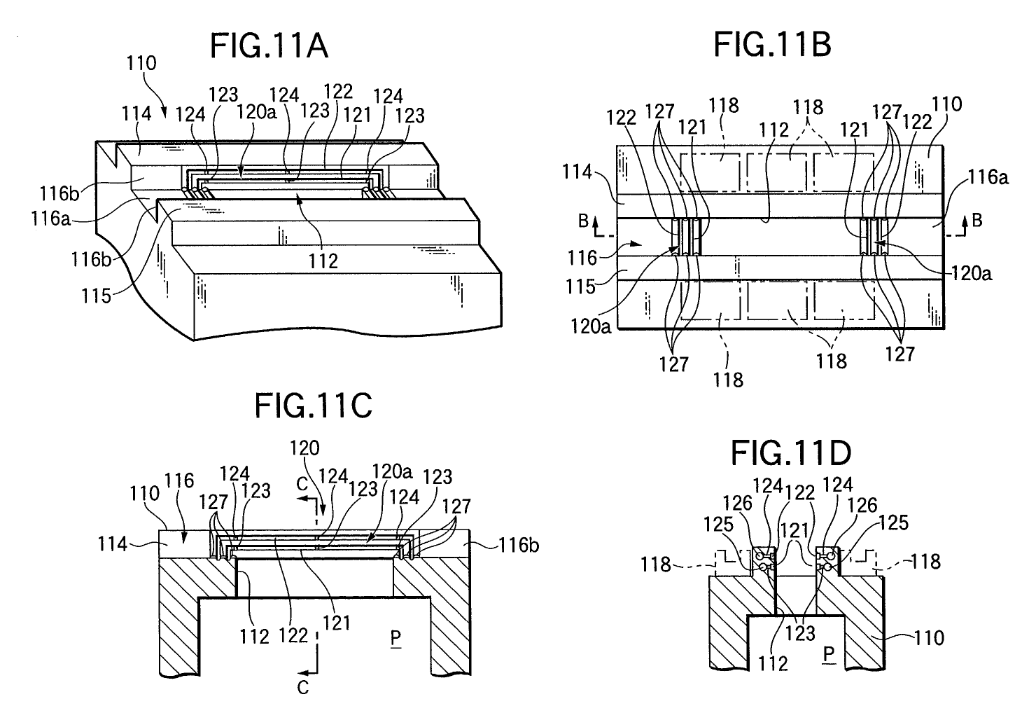

A fourth embodiment of the invention will be described below with reference to FIGS. 9 to 11. FIG. 9 is a sectional view of a positioning device according to the fourth embodiment of the invention. FIG. 10A is a plan view of an X-axis stage used in the positioning device depicted in FIG. 9 (and showing a surface opposite to the box 110). FIG. 10B is a front view of the X-axis stage. FIG. 10C is a sectional view taken along the line A-A in FIG. 10A. FIG. 11A is a perspective view of the box used in the positioning device depicted in FIG. 9. FIG. 11B is a plan view of the box. FIG. 11C is a sectional view taken along the line B-B in FIG. 11B. FIG. 11D is a side view in section taken along the line C-C in FIG. 11C. This embodiment is different from the third embodiment in the configuration of the differential evacuation seal between the box and the X-axis stage and the configuration of the cylindrical shaft slidable relative to the X-axis stage.

The X-axis stage (slider) 90 which is a first movable portion has a circular opening 91 in its center as will be described later. A differential evacuation seal (second differential evacuation sealing device) 92 is provided in the opening 91. Incidentally, the differential evacuation seal 92, a static-pressure bearing 93 which will be described later, and a differential evacuation seal 120 are schematically shown in FIGS. 9 and 10B. A cylindrical shaft (introduction shaft) 100 which is a second movable portion is inserted through the opening 91 of the X-axis stage 90. A forward end portion of the cylindrical shaft passes through the X-axis stage 90 and faces the process chamber P in the box 110 through a rectangular long hole 112 which will be described later. The cylindrical shaft 100 is formed so that a part of its circumferential surface which is a sealing surface is surrounded by the differential evacuation seal 92 provided in the opening 91. Further, the cylindrical shaft 100 is supported by the static-pressure bearing 93 provided in the left side of the differential evacuation seal 92 in FIG. 9. Hence, the gap between the cylindrical shaft 100 and the X-axis stage 90 is sealed and the cylindrical shaft 100 is supported contactlessly with the X-axis stage 90 so that the cylindrical shaft 100 can be slid left and right in FIG. 9 relative to the X-axis stage 90 without any frictional resistance. FIG. 10C shows the details of this state. The differential evacuation seal 92 has annular groove portions 92a and 92b provided in the inner circumferential surface of the opening 91, internal passages 92c and 92d, and communicating holes 92e and 92f communicating with the groove portions 92a and 92b through the internal passages 92c and 92d and connected to a suction pump (not shown). The static-pressure bearing 93 is made of a porous material. The static-pressure bearing 93 has bearing bodies 93a fitted into the opening 91, an air passage 93b through which air from an air supply pump (not shown) is supplied to the bearing bodies 93a, and an air exhaust passage 93d through which air exhausted from the bearing bodies 93a is led to the outside.

As shown in FIG. 9 and FIGS. 10A to 10C, two guide rails 94 are disposed in upper and lower portions in FIG. 9 on a surface of the X-axis stage 90 opposite to the box 110. An approximately parallelepiped rib 95 is provided straightly between the two guide rails 94 so as to be extended in parallel to the two guide rails 94. An opening 91 which passes through the X-axis stage 90 is provided in the center of the rib 95.

On the other hand, as shown in FIG. 9 and FIGS. 11A to 11D, two ribs 114 and 115 parallel to and isolated from each other by a distance approximately equal to the width of the rib 95 of the X-axis stage 90 are provided on a surface of the box 110 opposite to the X-axis stage 90. Thus, a concave portion 116 having a width approximately equal to the width of the rib 95 is formed between the two ribs 114 and 115. The concave portion 116 has a bottom surface, and two side surfaces 116b parallel to and opposite to each other. A rectangular long hole 112 is provided in the center of the bottom surface 116a of the concave portion 116.

Three upper bearings 118 and three lower bearings 118 in FIG. 9, that is, six bearings 118 in total are disposed on a surface of the box 110 opposite to the X-axis stage 90. Each of the bearings 118 is U-shaped in section. The bearings 118 are engaged with the two guide rails 94 disposed on the X-axis stage 90, through a large number of rolling bodies (not shown) but circulating in the bearings 118, so that the bearings 118 are slidable along the guide rails 94 in a direction perpendicular to the plane of FIG. 9. The bearings 118, the guide rails 94 and the large number of rolling bodies constitute a linear guide which is a kind of roller guide bearing.

In FIGS. 9 and 11A, the differential evacuation seal 120 (first differential evacuation sealing device) for sealing the gap between the box 110 and the X-axis stage 90 is provided on the bottom surface 116a and side surfaces 116b of the concave portion 116. As shown in FIGS. 11A to 11D, the differential evacuation seal 120 is shaped like a track which is extended along the circumference of the long hole 112 in the concave portion 116 formed in the box 110, to the bottom surface 116a and side surfaces 116b so as to surround the long hole 112. A surface 120a of the track-like portion opposite to the X-axis stage 90 functions as an evacuation surface of the differential evacuation seal 120. The differential evacuation seal 120 forms two track-like groove portions 121 and 122. The groove portions 121 and 122 communicate with the communicating passages 125 and 126 formed in the box 110, through the internal passages 123 and 124 of the differential evacuation seal 120. The communicating holes 125 and 126 are connected to a suction pump (not shown). The groove portions 121 and 122 are provided both in the bottom surface 116a and in the side surfaces 116b. Incidentally, a sealing material 127 of ceramics or of an adhesive agent heaped up and solidified is disposed in portions which are boundary corner portions of the bottom surface 116a and side surfaces 116b of the concave portion 116 and which are portions other than the groove portions 121 and 122 of the evacuation surface 120a. The corner portions of the rib 95 of the X-axis stage 90 are chamfered, so that a gap shaped approximately like a triangle in section viewed from a direction perpendicular to the X axis is generated between each corner and the concave portion 116. The gap has influence on the performance of the differential evacuation seal 120. The sealing material 127 is provided for locally minimizing the gap generated in each corner.

In the concave evacuation surface 120a, portions except the groove portions 121 and 122 are slightly protruded to the X-axis stage 90 side compared with outer portions in which the box 110 is opposite to the X-axis stage 90. Setting is made by the linear guide so that the protruded portions are opposite to the surface (opposite seal surface) of the X-axis stage 90 with a sufficiently small distance compared with the outer portions.

The operation of this embodiment will be described below. In FIG. 9, the up-down direction is defined as a Z-axis direction, the left-right direction as a Y-axis direction and the direction perpendicular to the plane of FIG. 9 as an X-axis direction. Because the X-axis stage 90 is supported relative to the box 110 in a low friction state by the linear guide constituted by the guide rails 94, the bearings 118 and the large number of rolling bodies after the rib 95 is fitted into the concave portion 116, the X-axis stage 90 can be driven to move in the X-axis direction relative to the box 110 through a ball screw by an external drive source (not shown). On this occasion, the cylindrical shaft 100 moves together with the X-axis stage 90 in the X-axis direction because the long hole 112 (equivalent to the opening in the invention) in the box 110 allows the cylindrical shaft 100 to move in the X-axis direction. In other words, the X-axis stage 90 can move in the X-axis direction relative to the box 110 in a range defined by the length of the long hole 112.

On this occasion, the differential evacuation seal 120 having the evacuation surface 120a sucks air between the differential evacuation seal 120 and the top surface and side surfaces (opposite seal surface) of the rib 95 of the X-axis stage 90 through the communicating passages 125 and 126 of the box 110 on the basis of the suction force of the suction pump (not shown). Accordingly, external air and foreign matter can be prevented from entering the process chamber P through the gap between the X-axis stage 90 and the box 110. Hence, even in the case where the process chamber P in the box 110 is put in a vacuum environment in order to process the work, the process chamber P can be preferably kept in the vacuum environment because the differential evacuation seal 120 can prevent external air from entering the process chamber P. Also in the case where the process chamber P is filled with a gas, the gas can be recovered by the differential evacuation seal so that the gas can be prevented from leaking out of the process chamber P. On the other hand, the left end of the cylindrical shaft 100 in FIG. 9 is connected to a drive source (not shown) disposed on the X-axis stage 90, so that the cylindrical shaft 100 is driven in the Y direction.

As described above, in accordance with this embodiment, the X-axis stage 90 and the cylindrical shaft 100 can be driven in directions crossing each other. Hence, the work supported at a forward end of the cylindrical shaft 100 can be positioned two-dimensionally in the process chamber P. Moreover, the effect according to the third embodiment can be obtained.

According to this embodiment, the evacuation surface 120a of the differential evacuation seal 120 is provided on the bottom surface 116a and side surfaces 116b of the concave portion 116 provided in the box 110. Hence, the opposite areas between the box and the X-axis stage in the Y direction is reduced and the suction force of the differential evacuation seal 120 acts on two orthogonal directions separately compared with the case where the opposite surfaces of the box and the X-axis stage are uncurved flat to each other as described in the first and third embodiments. Hence, in the suction force applied onto the structure of the positioning device, the magnitude of a component acting on the Y-axis direction is reduced compared with the case where the suction force acts on only one direction. That is, in this embodiment, a part of the suction force forms a component acting on the two side surfaces 116b. Because the component does not act on the Y-axis direction, the magnitude of the Y-direction component of the suction force applied onto the structure of the positioning device is reduced correspondingly. Hence, the length of the opening 112 can be made large without increase in stiffness of the structure of the device. Hence, the suction force in the Y direction can be reduced while the sealing function based on the suction force of the differential evacuation seal 120 is maintained. It is therefore unnecessary to use a highly stiff structure of the positioning device.

Incidentally, in this embodiment, the design may be changed, for example, as follows. First, roller bearings (such as ball bearings or roller bearings) may be used as the bearings of the cylindrical shaft 100. If a rotation drive mechanism is provided in the cylindrical shaft 100 as a shaft member, the cylindrical shaft 100 can be rotated relatively in any direction from the outside and, accordingly, a triaxial positioning device can be formed. When relative rotation needs to be stopped, a shaft shaped like a polygon such as a rectangle in section, an elliptic shaft or a spline shaft may be preferably used as the shaft member because it is unnecessary to provide a relative rotation stopping device separately. The side surfaces 116b of the concave portion 116 need not perpendicularly intersect the bottom surface 116a of the concave portion 116 but may be inclined thereto. When, for example, the concave portion 116 is shaped like a trapezoid in section and the rib 95 is shaped like a trapezoid in section correspondingly to the concave portion 116, the Y-direction component of the suction force can be reduced.

The sealing device according to any one of the first through fourth embodiments is configured as a sealing device having: a box including a process chamber communicating with an outside through an opening; a slider which is slidable relatively to the box along an outer wall surface of the box in the condition that the opening is closed; an introduction shaft facing the process chamber through the opening; and a differential evacuation seal for sealing a gap between the box and the slider; wherein a roller bearing is disposed between the box and the slider. Hence, it is unnecessary to provide any gas supply source and any piping thereof. The box and the slider can be supported relatively movably by simpler configuration. In addition, the roller bearing functions as a bearing regardless of the magnitude of suction force caused by differential pressure between the inside and outside of the process chamber. Hence, the positioning device can be assembled easily without necessity of any complex operation such as adjustment of pressure.

Further, the sealing device according to any one of the first through fourth embodiments is configured as a positioning device having: a box including a process chamber communicating with an outside through an opening; a slider which is slidable relatively to the box along an outer wall surface of the box in the condition that the opening is closed; an introduction shaft facing the process chamber through the opening; and a differential evacuation seal for sealing a gap between the box and the slider; wherein the differential evacuation seal is provided on the box side. Hence, the length of the differential evacuation seal in the direction of the movement of the slider can be short favorably. As a result, the total size of the positioning device can be reduced. Moreover, there is an advantage that suction force or repulsion force having a magnitude proportional to the area of an evacuation surface of the differential evacuation seal is reduced, so that the structure of the device does not require high stiffness.

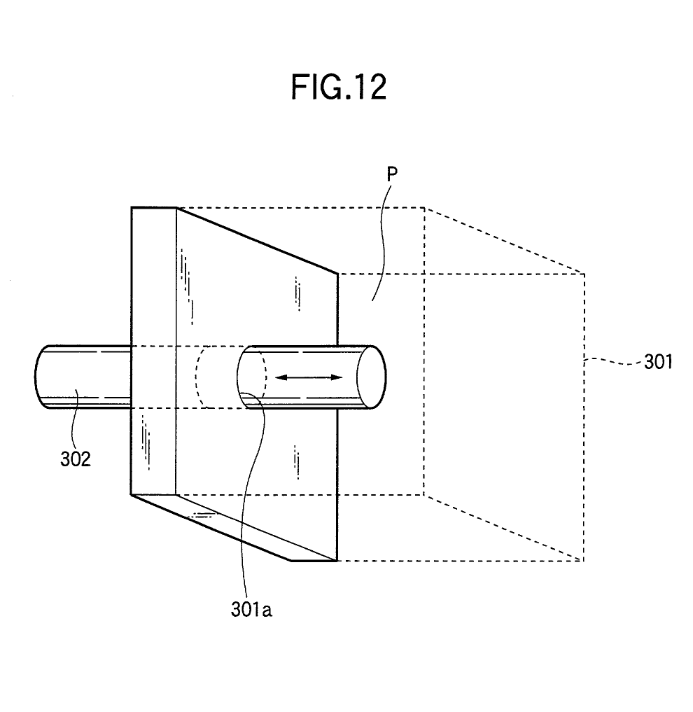

FIG. 12 is a perspective view schematically showing a fifth embodiment of the invention. The positioning device shown in FIG. 12 has: a box 301 including a process chamber P communicating with an outside through an opening 301a; and an introduction shaft (slider) 302 inserted in the opening 301a and relatively slidable along the opening 301a. A static-pressure bearing and a differential evacuation seal which will be described later are provided in the opening 301a opposite to the introduction shaft 302. Hence, a work (not shown) attached to a forward end of the introduction shaft 302 is supported so as to be movable in the process chamber P of the box 301 in the direction of the axis of the introduction shaft 302.

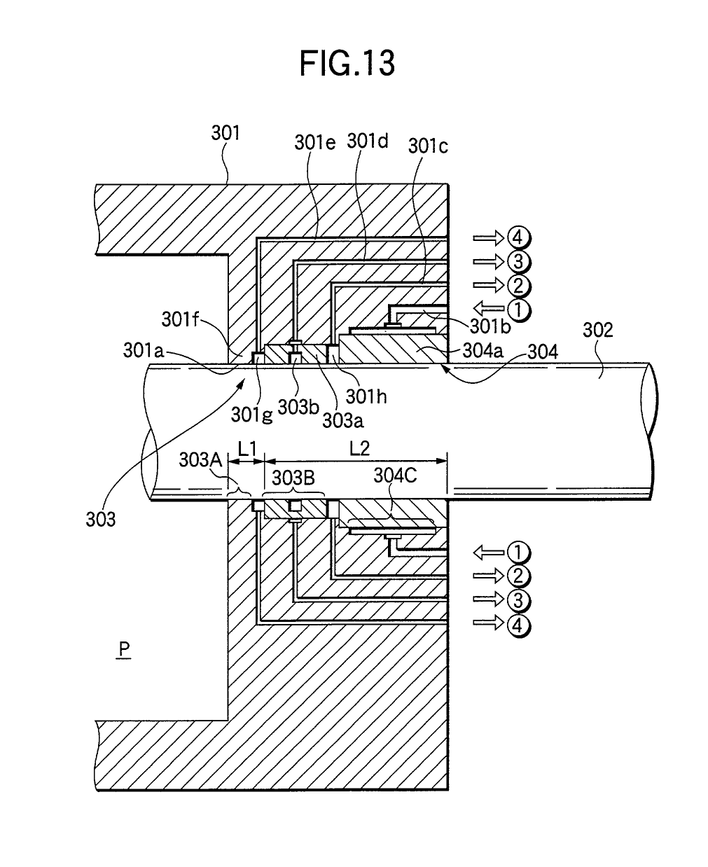

FIG. 13 is a sectional view of the positioning device depicted in FIG. 12, cut at a plane parallel to the axis of the introduction shaft. In FIG. 13, the differential evacuation seal 303 and the static-pressure bearing 304 are provided side by side in the opening 301a of the box 301. The static-pressure bearing 304 has: a cylindrical bearing portion 304a which is disposed on the outside (right side in FIG. 13) of the opening 301a so that air can be jetted out all over the inner circumference; and a passage 301b coupled with an external high-pressure portion \mathring{1} (not shown) for supplying high-pressure air to the bearing portion 304a and formed in the box 301.

The differential evacuation seal 303 is a portion on the inner side than the static-pressure bearing 304 (left side in FIG. 12). The differential evacuation seal 303 has a first region 303A adjacent to the process chamber P, a second region 303B adjacent to the static-pressure bearing 304, a flange portion 301f of the box 301, and passages 301d and 301e inside the box 301. A cylindrical sealing portion 303a is disposed in the second region 303B. The sealing portion 303a made of a porous material (graphite in this embodiment) excellent in anti-seizing characteristic is impregnated with a resin so that the resin reaches a depth sufficient to prevent gas from being leaked. An inner circumferential groove 303b is formed on the inner circumferential side of the axial center of the sealing portion 303a. Although a material having self-lubricity such as graphite can be preferably used as the porous material, another material may be used as the porous material if the material has at least anti-seizing characteristic. The inner circumferential groove 303b communicates with an external exhaust portion \mathring{3} (not shown), through the passage 301d formed in the box 301. The flange portion 301f of the box 301 is formed in the first region 303A so as to be opposite to the introduction shaft 302. Although this embodiment shows the case where the box 301 is made of stainless steel, the invention can be applied also to the case where the box 301 is made of another material excellent in vacuum characteristic such as ceramics, titanium alloy or aluminum alloy. An annular space 301g formed between the flange portion 301f and the sealing portion 303a communicates with an external exhaust portion \mathring{1} (not shown), through the passage 301e formed in the box 301.

An annular space 301h formed between the sealing portion 303a and the bearing portion 304a is opened to the atmosphere \mathring{2} through the passage 301c formed in the box 301.

In this embodiment, the gap between the flange portion 301f in the first region 303A of the differential evacuation seal 303 and the introduction shaft 302 is larger than the gap between the sealing portion 303a in the second region 303B of the differential evacuation seal 303 and the introduction shaft 302 and larger than the gap between the bearing portion 304a and the introduction shaft 302. Incidentally, each of the gap between the sealing portion 303a and the introduction shaft 302 and the gap between the bearing portion 304a and the introduction shaft 302 is so small that a necessary amount of resin remains both in the sealing portion 303a and in the bearing portion 304a though the inner circumferential surfaces thereof is mechanically processed.

The operation of this embodiment will be described. In FIG. 13, high-pressure air compressively fed from the external high-pressure portion \mathring{1} is supplied from the portion 304C in FIG. 13 into the bearing portion 304a through the passage 301b formed in the box 301. The external high-pressure portion (1) is constituted by an air supply pump (not shown). The introduction shaft 302 is movably supported by the pressure of air jetted from the inner circumference of the bearing portion 304a while the introduction shaft 302 is kept contactless with respect to the box 301. On the other hand, a part of air (inclusive of air supplied from the static-pressure bearing 304) flowing from the outside into the process chamber P through the opening 301a is exhausted from the annular space 301h to the atmosphere \mathring{2} through the passage 301c. The other part of the air is caught in the inner circumferential groove 303b of the sealing portion 303a and forcedly discharged by the external exhaust portion \mathring{3} constituted by an exhaust pump (not shown), through the passage 301d. The other part of the air is further caught in the annular space 301g between the sealing portion 303a and the flange portion 301f and forcedly exhausted by the external exhaust portion \mathring{4} constituted by an exhaust pump (not shown), through the passage 301e. As a result, the degree of vacuum of the process chamber P can be retained effectively. Even in the case where outgas is generated from the sealing portion 303a on this occasion, entrance of the outgas into the process chamber P is suppressed because the outgas is forcedly exhausted to the outside through the passage 301d or 301e.

Further, in this embodiment, the gap between the flange portion 301f in the first region 303A of the differential evacuation seal 303 and the introduction shaft 302 is larger than the gap between the sealing portion 303a in the second region 303B of the differential evacuation seal 303 and the introduction shaft 302. Hence, even in the case where the function of the static-pressure bearing 304 is spoiled by some reason, galling or seizing of the introduction shaft 302 can be suppressed effectively because the introduction shaft 302 comes into contact with the sealing portion 303a excellent in anti-seizing characteristic before the introduction shaft 302 comes into contact with the flange portion 301f. Incidentally, those gaps may be adjusted so that the introduction shaft 302 comes into contact with the bearing portion 304a before the introduction shaft 302 comes into contact with the flange portion 301f or the sealing portion 303a. In this case, the bearing portion 304a may be preferably made of a porous material so that galling and the like can be suppressed.

It is further preferable that there holds the expression (1):

Δa−Δb>(Δb+Δc)·L1/L2 (1)

in which Δa is the gap between the flange portion 301f in the first region 303A of the differential evacuation seal 303 and the introduction shaft 302 (the size in a state in which the axial centers of both the flange portion 301f and the introduction shaft 302 coincide with each other), Δb is the gap between the sealing portion 303a in the second region 303B of the differential evacuation seal 303 and the introduction shaft 302, Δc is the gap between the bearing portion 304a of the static-pressure bearing 304 and the introduction shaft 302, L1 is the axial length from the flange portion 301f to the annular space 301g, and L2 is the axial thickness of a portion of the box 301 from the second region 303B on the outer side than L1 to the static-pressure bearing 304. This is because the portions which may have a fear to come into contact with the introduction shaft 302 are limited to the sealing portion 303a and the bearing portion 304a each made of a material excellent in anti-seizing characteristic.

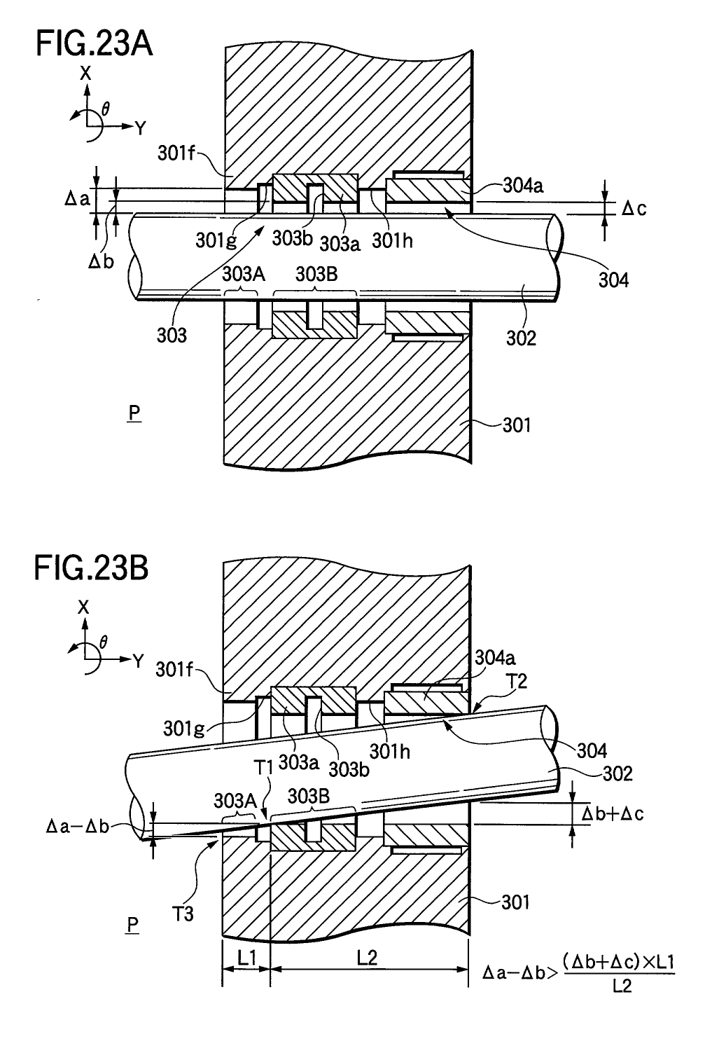

FIGS. 23A and 23B typically show this relation. FIG. 23A is a view showing a state in which the axial center of the opening 301a coincides with the axial center of the introduction shaft 302. FIG. 23B is a view showing a state in which the introduction shaft 302 is inclined most greatly. To make understanding easy, the gaps Δa, Δb and Δc are shown while enlarged. In the expression (1), the upper limit of the size of Δa−Δb is preferably selected to be as small as possible in the range allowable to satisfy the expression, from the point of view of the performance of the seal. The upper limit is determined suitably in accordance with such as the performance of the vacuum pump in the differential evacuation seal. When the expression (1) is satisfied, agap (T3) can be formed between the flange portion 301f and the introduction shaft 302 (that is, the flange portion 301f and the introduction shaft 302 can be prevented from coming into contact with each other) even in the case where the process chamber side end portion (T1) of the differential evacuation seal 303 abuts against the introduction shaft 302 and the external side end portion (T2) of the static-pressure bearing 304 abuts against the introduction shaft 302.

It is preferable that the lower limit of Δa−Δb satisfies the expression. When, for example, the introduction shaft is supported by a bearing (not shown) but other than the static-pressure bearing 304 and the inclination of the introduction shaft is limited to be smaller than that shown in FIG. 23B, the lower limit of Δa−Δb may be smaller than that determined by the expression.

Although it is further preferable that the relations Δa>Δb and Δa>Δc hold, the relation Δa>Δc need not always hold. That is, there may be the case where the relation Δa<Δc holds.

It is a matter of course that the inner diameter of the sealing portion 303a may be selected to be equal to the inner diameter of the bearing portion 304a. That is, the equation Δb=Δc may hold.

Although this embodiment has shown the case where the introduction shaft 302 can be moved along the axial line, the invention maybe applied also to the case where the introduction shaft 302 can be rotated around the axial line or the case where the introduction shaft 302 can be moved along the axial line and rotated around the axial line.

The shape of the introduction shaft 302 is not limited to the cylindrical shape. When rotation is not required, the introduction shaft 302 may be shaped, for example, like a polygon in section.

A portion including the opening 301a in which the differential evacuation seal 303 and the static-pressure bearing 304 are provided may be provided separately from the box body so that the portion including the opening 301a can be slid relative to the box body in a direction crossing the direction of the axis of the introduction shaft 302. When electrically charged particles are used for a process executed in the process chamber on this occasion, the portion including the opening 301a and the introduction shaft 302 are preferably made of a nonmagnetic substance.

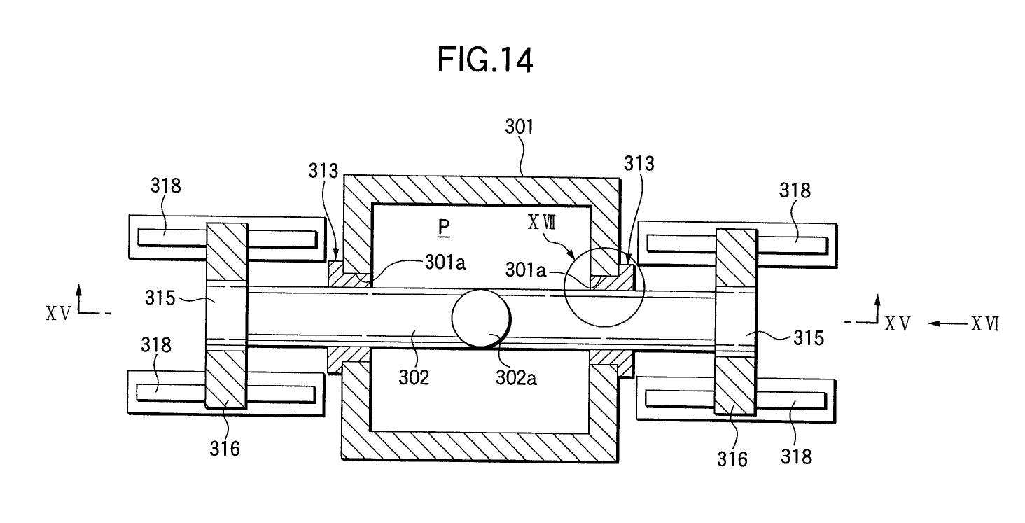

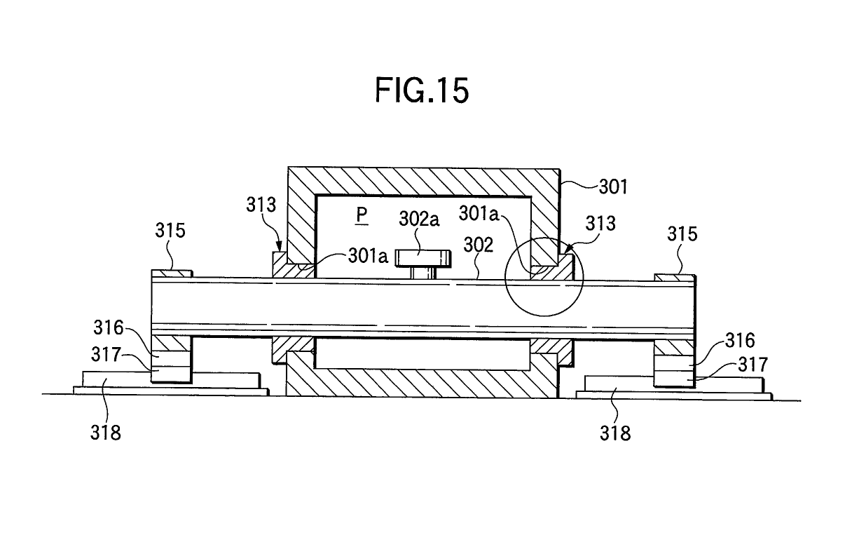

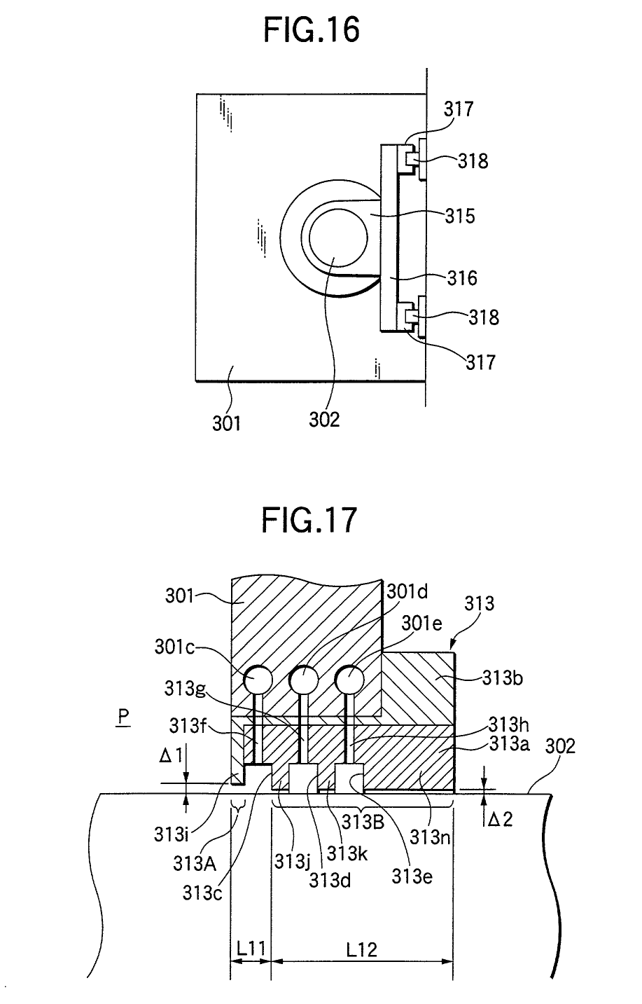

FIGS. 14 to 17 are views for explaining a modified example (sixth embodiment) of the positioning device using no static-pressure bearing. FIG. 14 is a horizontal sectional view of the modified example. FIG. 15 is a vertical sectional view (taken along the line XV-XV in FIG. 14) of the modified example. FIG. 16 is a view of the configuration of FIG. 14 from the direction of the arrow XVI. FIG. 17 is an enlarged view of the portion XVII in the configuration of FIG. 14.

In FIG. 14, a shaft-like introduction shaft 302 is inserted into a pair of openings 301a formed in opposite sides of a box 301 mounted on a rigid body, through differential evacuation seals 313 which will be described later in detail. A circular work table 302a is provided in the center of the introduction shaft 302 so that a work (not shown) can be placed on the work table 302a and processed in the process chamber P inside the box 301.

Opposite ends of the introduction shaft 302 are supported by support members 315 respectively. Each of the support members 315 is disposed on a pair of guide bearings 317 through coupling tables 316 respectively. As shown in FIG. 16, the guide bearings 317 each approximately U-shaped in section are disposed so as to be laid over the linear guide rails 318 disposed linearly on the rigid body, so that the guide bearings 317 are movable on the linear guide rails 318. The guide bearing 317 and the linear guide rails 318 constitute a linear guide. The introduction shaft 302 is coupled with an actuator (not shown). Incidentally, it is considered that the example of the actuator is a combination of a rotary motor and a ball screw, a combination of a rotary motor, a belt and a pulley, or a linear motor but the actuator is not limited thereto.

The differential evacuation seals 313 will be described below. Because the pair of differential evacuation seals 313 have the same configuration, description will be made upon one differential evacuation seal 313 disposed on the right side in FIGS. 14 and 15. In FIG. 17, the differential evacuation seal 313 has a cylindrical portion 313a of a porous material (impregnated with a resin) excellent in anti-seizing characteristic, and a holder portion 313b of stainless steel for holding the cylindrical portion 313a to the box 301. The cylindrical portion 313a has three inner circumferential grooves 313c, 313d and 313e formed in its inner circumference. The inner circumferential grooves 313c, 313d and 313e communicate with exhaust passages 301c, 301d and 301e formed in the box 301, through passages 313f, 313g and 313h extended radially. The exhaust passages 301c, 301d and 301e are connected to an external exhaust portion (not shown).

The differential evacuation seal 313 has a first partition wall 313i between the process chamber P and the inner circumferential groove 313c, a second partition wall 313j between the inner circumferential grooves 313c and 313d, a third partition wall 313k between the inner circumferential grooves 313d and 313e, and a fourth partition wall 313n between the inner circumferential groove 313e and the outside. In this embodiment, the first partition wall 313i which is a part of the holder portion 313b constitutes a first region 313A whereas the partition walls 313j, 313k and 313n which are parts of the cylindrical portion 313a constitute a second region 313B. The gap Δ1 between the inner circumference of the differential evacuation seal 313 and the outer circumference of the introduction shaft 302 in the first region 313A is set to be larger (Δ1>Δ2) than the gap A2 between the inner circumference of the differential evacuation seal 313 and the outer circumference of the introduction shaft 302 in the second region 313B. It is further preferable to satisfy the following expression.

(Δ1−Δ2)>2·Δ2·L11/L12 (2)

Incidentally, the gaps with respect to the second, third and fourth partition walls 313j, 313k and 313n may be set to have different values Δ2a, Δ2b and Δ2c respectively. In this case, it is preferable that each of the values Δ2a, Δ2b and Δ2c is smaller than Δ1 and that the value Δ2a is smaller than each of the values Δ2b and Δ2c.

The operation of this embodiment will be described. In FIGS. 14 to 16, when the actuator (not shown) starts, the introduction shaft 302 supported with low friction by the linear guides 317 and 318 can move along the linear guide rails 318. That is, the accurate movement of the introduction shaft 302 can be achieved by the use of the linear guides 317 and 318.

On the other hand, air flowing from the outside into the process chamber P is caught in the inner circumferential grooves 313c, 313d and 313e of the differential evacuation seal 313 and released to the atmosphere through the passage 313h and the exhaust passage 301e of the box 301 or discharged from an external exhaust portion (not shown) through the passages 313f and 313g and the exhaust passages 301c and 301d of the box 301. As a result, the degree of vacuum of the process chamber P can be retained effectively.

Further, in this embodiment, as shown in FIG. 17, the gap Δ1 between the inner circumference of the differential evacuation seal 313 and the outer circumference of the introduction shaft 302 in the first region 313A of the differential evacuation seal 313 is set to be larger than the gap Δ2 between the inner circumference of the differential evacuation seal 313 and the outer circumference of the introduction shaft 302 in the second region 313B. Hence, even in the case where the differential evacuation seal 313 and the introduction shaft 302 comes into contact with each other by some reason, the contact between the holder portion 313b and the introduction shaft 302 can be suppressed so that galling or seizing can be suppressed effectively.

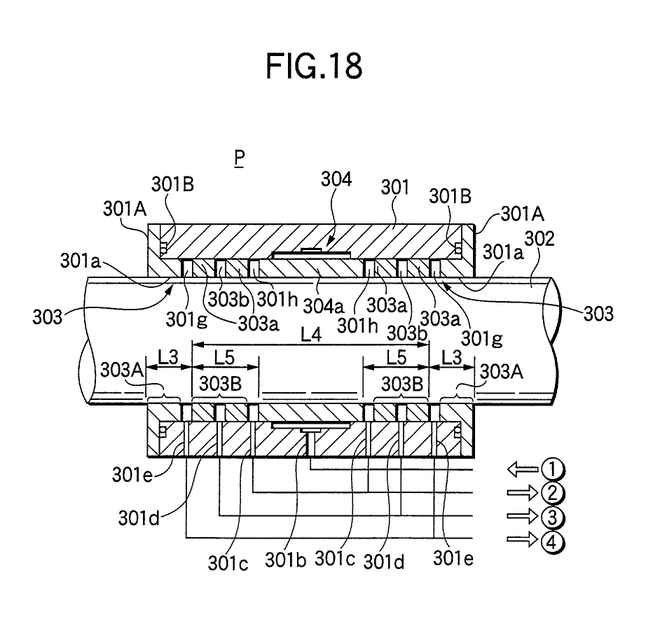

FIG. 18 is a sectional view showing a seventh embodiment of the invention. The point of difference from the embodiment of FIG. 13 will be described chiefly. In FIG. 18, this embodiment which can be used under a vacuum environment (in the process chamber P in this embodiment) has a feature in that differential evacuation seals 303 are disposed on opposite sides of a static-pressure bearing 304. Incidentally, the process chamber P is enclosed in a box (not shown) but provided separately.

To describe more specifically, an annular box 301 disposed in the process chamber P has opposite ends covered with a pair of flanges 301A. An introduction shaft 302 passes through a pair of openings 301a formed in the flanges 301A. The box 301 and the pair of flanges 301A are sealed with a pair of O-rings 301B respectively. Each of the differential evacuation seals 303 has first regions 303A adjacent to the process chamber P on the outside of the box 301, and second regions 303B adjacent to the static-pressure bearing 304. Cylindrical sealing portions 303a are disposed in each of the second regions 303B of the differential evacuation seals 303 respectively. Each of the sealing portions 303a is made of a porous material excellent in anti-seizing characteristic and impregnated with a resin. An annular space 303b is formed between adjacent ones of the sealing portions 303a. The inner circumferential grooves 303b communicate with an external exhaust portion \mathring{3} (not shown), through passages 301d formed in the box 301. The openings 301a of the flanges 301A of the box 301 are formed in the first regions 303A so as to be opposite to the introduction shaft 302. Although this embodiment has shown the case where the box 301 is made of stainless steel, the invention may be applied also to the case where the box 301 is made of a material excellent in vacuum characteristic such as ceramics, titanium alloy or aluminum alloy. The annular spaces 301g held between the flanges 301A and the sealing portions 303a communicate with an external exhaust portion \mathring{4} (not shown), through passages 301e formed in the box 301.

Further, the annular spaces 301h formed between the sealing portions 303a and the static-pressure bearing 304 are opened to the atmosphere \mathring{2} through passages 301c formed in the box 301.

In this embodiment, the gap between the flange 301A and the introduction shaft 302 in each first region 303A in each of the differential evacuation seals 303 is set to be larger than the gap between the sealing portion 303a and the introduction shaft 302 in the second region 303B of the differential evacuation seal 303.

The operation of this embodiment will be described. In FIG. 18, high-pressure air compressively fed from the external high-pressure portion \mathring{1} is supplied to the static-pressure bearing 304 through the passage 301b formed in the box 301. The introduction shaft 302 is movably supported relative to the box 301 by the pressure of air jetted from the inner circumference of the static-pressure bearing 304. On the other hand, a part of air (inclusive of air supplied from the static-pressure bearing 304) flowing from the outside into the process chamber P through the openings 301a is exhausted from the annular spaces 301h to the atmosphere \mathring{2} through the passages 301c. The other part of the air is caught in the inner circumferential grooves 303b of the sealing portions 303a and forcedly exhausted by the external exhaust portion \mathring{3} through the passages 301d. The other part of the air is further caught in the annular spaces 301g between the flanges 301A and the sealing portions 303a and forcedly exhausted by the external exhaust portion \mathring{4} through the passages 301e. As a result, the degree of vacuum of the process chamber P can be retained effectively. Even in the case where outgas is generated from the sealing portions 303a on this occasion, entrance of the outgas into the process chamber P is suppressed because the outgas is forcedly discharged to the outside through the passages 301d or 301e.

Further, in this embodiment, the gap between the flange portion 301A in the first region 303A of each of the differential evacuation seals 303 and the introduction shaft 302 is larger than the gap between each sealing portion 303a in the second region 303B of each of the differential evacuation seals 303 and the introduction shaft 302. Hence, even in the case where the function of the static-pressure bearing 304 is spoiled by some reason, galling or seizing of the introduction shaft 302 can be suppressed effectively because the introduction shaft 302 comes into contact with the sealing portions 303a excellent in anti-seizing characteristic before the introduction shaft 302 comes into contact with the flange portions 301A.

It is further preferable that there holds the expression (3):

Δ−Δb>2·Δb·L3/L4 (3)

in which Δa is the gap between the flange 301A and the introduction shaft 302 in the first region 303A in each of the differential evacuation seals 303, Δb is the gap between each sealing portion 303a and the introduction shaft 302 in the second region 303B in each of the differential evacuation seals 303, L3 is the axial length of each of the flanges 301A, and L4 is the axial length of the configuration except the axial lengths of the flanges 301A.

Incidentally, in the case of Δb>Δc, it may be preferable that the expression (3) is replaced by the expression (4):

Δa−Δb>(Δb+Δc)·L3/(L4−L5) (4)

in which Δc is the gap between the bearing portion 304a and the introduction shaft 302, and L5 is the axial length from each of the second regions to corresponding one of the annular spaces 301h. Which expression is preferably used can be determined on the basis of judgment as to whether the introduction shaft 302 comes into contact with the bearing portion 304a or not when the introduction shaft 302 is inclined. When the introduction shaft 302 does not come into contact with the bearing portion 304a, the expression (3) is preferred. When the introduction shaft 302 comes into contact with the bearing portion 304a, the expression (4) is preferred. Further, in the case of Δb>Δc, the introduction shaft 302 may be designed so that it does not come into contact with the differential evacuation seals 303 but comes into contact only with the bearing portion 304a. Also in this case, the same thought as described above can be used so that one of the expressions is selected suitably in accordance with the condition to thereby prevent the introduction shaft 302 from coming into contact with the flanges 301A.

Although this embodiment has shown the case where one static-pressure bearing 304 is disposed in the center of the box 301, the invention may be applied also to the case where two static-pressure bearings are disposed so that another element can be disposed between the two static-pressure bearings. For example, magnetic poles may be formed in the outer circumferential surface of the introduction shaft 302 and in the inner circumferential surface of the box 301 so that a motor can be formed between the two static-pressure bearings 304.

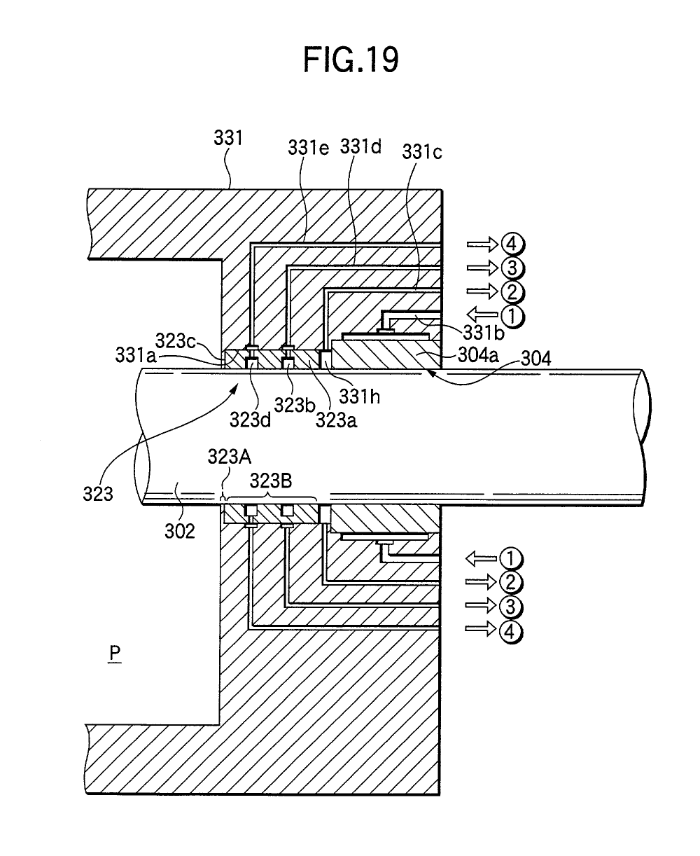

FIG. 19 is a view similar to FIG. 13, showing a first modified example of the fifth embodiment. The modified example in FIG. 19 is different from the embodiment in FIG. 13 only in the configuration of the differential evacuation seal 323. In other configuration, identical parts are referenced correspondingly and the description thereof will be therefore omitted.

This modified example is different from the embodiment of FIG. 13 in that the flange portion (301f in FIG. 13) of the box 331 is replaced by an extended sealing portion 323a and that a surface 323c of the sealing portion 323a facing the process chamber P is coated with a material excellent in vacuum characteristic by ceramic spray coating or the like. Incidentally, if coating is performed after the gap between the sealing portion 323a and the introduction shaft 302 is adjusted, there is a risk that the adjusted gap may become wrong. It is therefore preferable that the gap is adjusted after coating. Hence, a coating material is preferably provided in a position where an adjusting process can be avoided. In this embodiment, the inner edge of the surface 323c constitutes a first region 323A whereas all the inner circumference of the sealing portion 323a except the inner edge of the surface 323c constitutes a second region 323B. The gap between the inner edge of the surface 323c in the first region 323A and the introduction shaft 302 is larger than the gap between the sealing portion 323a in the second region 323B and the introduction shaft 302. Hence, even in the case where the function of the static-pressure bearing 304 is spoiled by some reason, galling or seizing of the introduction shaft 302 can be suppressed effectively because the introduction shaft 302 comes into contact with the sealing portion 323a excellent in anti-seizing characteristic before the introduction shaft 302 comes into contact with the inner edge of the surface 323c.

In this modified example, high-pressure air compressively fed from the external high-pressure portion \mathring{1} is supplied to the bearing portion 304a through the passage 331b formed in the box 331. The introduction shaft 302 is movably supported relative to the box 331 by the pressure of air jetted out from the inner circumference of the static-pressure bearing 304. On the other hand, a part of air (inclusive of air supplied from the static-pressure bearing 304) flowing from the outside into the process chamber P through the opening 331a is exhausted from the annular space 331h to the atmosphere \mathring{2} through the passage 331c. The other part of the air is caught in the inner circumferential groove 323b of the sealing portions 323a and forcedly exhausted by the external exhaust portion \mathring{3} through the passage 331d. The other part of the air is further caught in the inner circumferential groove 323d of the sealing portion 323a and forcedly exhausted by the external exhaust portion \mathring{4} through the passage 331e. As a result, the degree of vacuum in the process chamber P can be retained effectively. Even in the case where outgas is generated from the sealing portion 323a on this occasion, the outgas is prevented from flowing into the process chamber P by the coating surface 323c and forcedly discharged to the outside through the passage 331d or 331e.

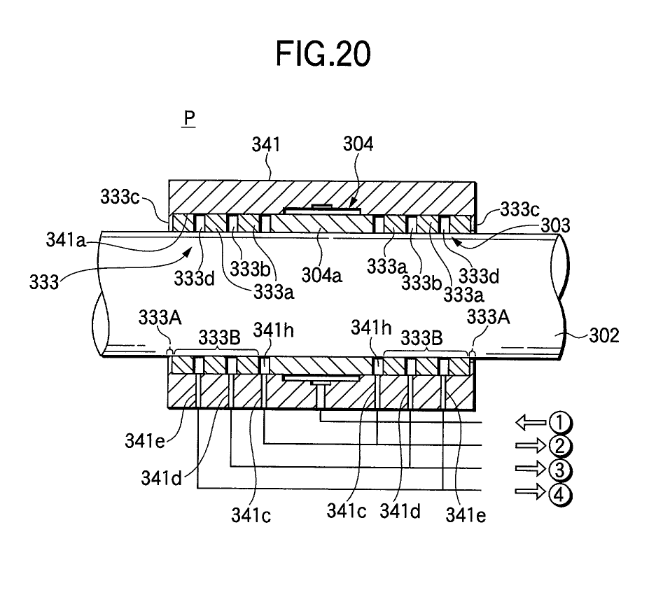

FIG. 20 is a view similar to FIG. 18, showing a first modified example of the seventh embodiment. The modified example shown in FIG. 20 is different from the embodiment shown in FIG. 18 only in the configuration of a differential evacuation seal 333. In other configuration, identical parts are referenced correspondingly and the description thereof will be therefore omitted. The configuration of the differential evacuation seal 333 in this modified example is equivalent to that of the differential evacuation seal 323 shown in FIG. 19. In this embodiment, the inner edge of each surface 333c constitutes a first region 333A whereas all the inner circumference of corresponding one of sealing portions 333a except the inner edge of the surface 333c constitutes a second region 333B. The gap between the inner edge of the surface 333c in each of the first regions 333A and the introduction shaft 302 is larger than the gap between the sealing portion 333a in each of the second regions 333B and the introduction shaft 302. Hence, even in the case where the function of the static-pressure bearing 304 is spoiled by some reason, galling or seizing of the introduction shaft 302 can be suppressed effectively because the introduction shaft 302 comes into contact with the sealing portions 333a excellent in anti-seizing characteristic before the introduction shaft 302 comes into contact with the inner edges of the surfaces 333c.

In this modified example, high-pressure air compressively fed from the external high-pressure portion \mathring{1} is supplied to the bearing 304 through the passage 341b formed in the box 341. The introduction shaft 302 is movably supported relative to the box 341 by the pressure of air jetted out from the inner circumference of the static-pressure bearing 304. On the other hand, a part of air (inclusive of air supplied from the static-pressure bearing 304) flowing from the outside into the process chamber P through the openings 341a is exhausted from the annular spaces 341h to the atmosphere \mathring{2} through the passages 341c. The other part of the air is caught in the inner circumferential grooves 333b of the sealing portions 333a and forcedly exhausted by the external exhaust portion \mathring{3} through the passages 341d. The other part of the air is further caught in the inner circumferential grooves 333d of the sealing portions 333a and forcedly exhausted by the external exhaust portion \mathring{4} through the passages 341e. As a result, the degree of vacuum in the process chamber P can be retained effectively. Even in the case where outgas is generated from the sealing portions 333a on this occasion, the outgas is prevented from flowing into the process chamber P by the coating surfaces 333c and forcedly discharged to the outside through the passages 341d or 341e.

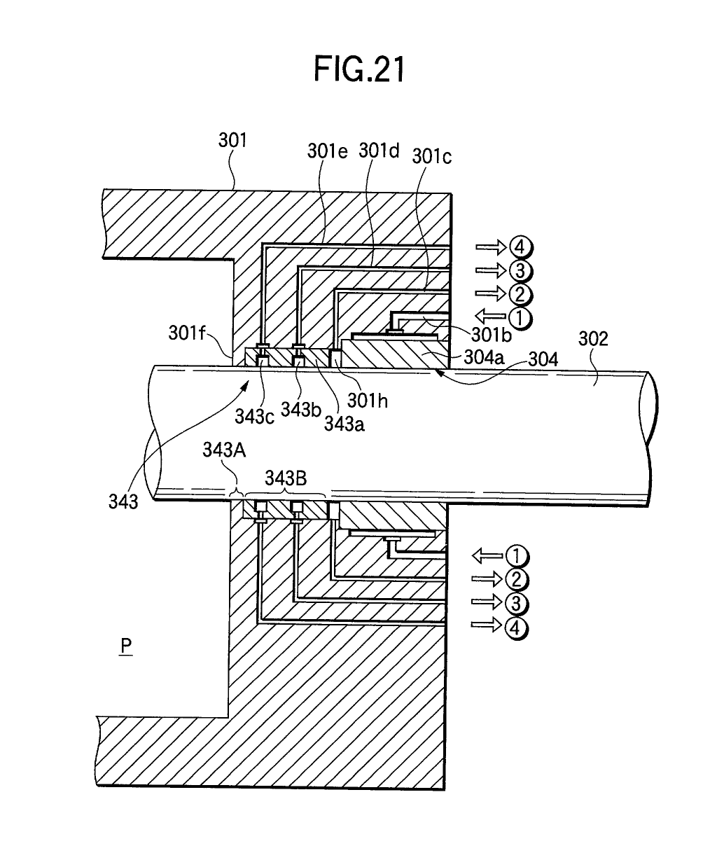

FIG. 21 is a view similar to FIG. 13, showing a second modified example of the fifth embodiment. The modified example in FIG. 21 is different from the embodiment in FIG. 13 only in the configuration of the differential evacuation seal 343. In other configuration, identical parts are referenced correspondingly and the description thereof will be therefore omitted. This modified example is different from the embodiment shown in FIG. 13 only in the configuration of a differential evacuation seal 343, but operation and effect of this modified example is equivalent to the embodiment shown in FIG. 13. That is, in the differential evacuation seal 343 in this modified example, the axial thickness of the flange portion 301f is reduced and the axial length of the sealing portion 343a is increased instead. Hence, the description of this modified example will be omitted. Incidentally, in this embodiment, a portion equivalent to the first region is 343A and a portion equivalent to the second region is 343B.

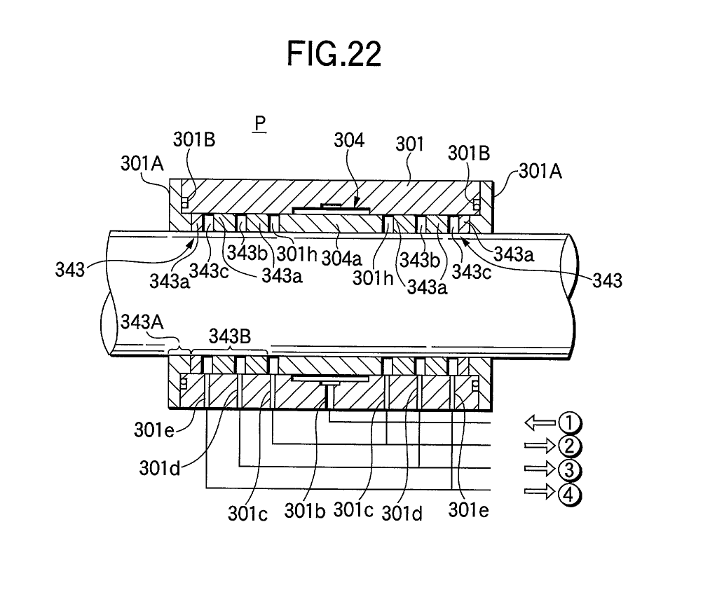

FIG. 22 is a view similar to FIG. 18, showing a second modified example of the seventh embodiment. The modified example in FIG. 22 is different from the embodiment in FIG. 18 only in the configuration of the differential evacuation seal 343. In other configuration, identical parts are referenced correspondingly and the description thereof will be therefore omitted. This modified example is different from the embodiment shown in FIG. 18 only in the configuration of a differential evacuation seal 343, but operation and effect of this modified example is equivalent to the embodiment shown in FIG. 18. That is, in the differential evacuation seal 343 in this modified example, the axial thickness of the flanges 301A is reduced and the axial length of the sealing portions 343a is increased instead. Hence, the description of this modified example will be omitted.

Although the fifth, sixth and seventh embodiments have been described above, various changes or modifications may be made upon the embodiments. For example, the method for supporting the slider (introduction shaft) relative to the box is not limited to the static-pressure bearing or the linear guide but another supporting method may be used.

Although the fifth, sixth and seventh embodiments have shown the case where the introduction shaft is used as a slider sliding into the opening of the box, the invention maybe applied also to the case where, for example, the X-axis stage described in any one of the first, second, third and fourth embodiments is used as a slider.

An example of application to the X-axis stage is as follows. In the evacuation surface 60a in the first embodiment shown in FIG. 2, the range from the innermost evacuation surface 67 to the groove portion 62 is provided as a first region whereas the range from the evacuation surface 66 to the evacuation surface 65 outside the evacuation surface 67 is provided as a second region. That is, the portion from the evacuation surface 67 to the groove portion 62 is made of a material excellent in vacuum characteristic. Further, the height of the evacuation surface 67 is set to be lower (for example, by several microns) than the height of each of the evacuation surfaces 66 and 65 so that the gap between the evacuation surface 67 and the X-axis stage is larger than the gap between each of the evacuation surfaces 66 and 65 and the X-axis stage.

According to the sealing device described in any one of the fifth, sixth and seventh embodiments, at least one portion of the first region adjacent to the process chamber P is made of a material excellent in vacuum characteristic. Hence, there is no outgas generated from this portion. Even in the case where outgas is generated from the differential evacuation seal, the vacuum state of the process chamber can be retained effectively because the first region is nearest to the process chamber so that evacuation owing to the differential evacuation seal can prevent the outgas from migrating to the process chamber side. Moreover, the gap between the first region and the slider is set to be larger than the gap between the second region provided to be farther from the process chamber than the first region and the slider. Hence, the first region on the box side and the slider can be prevented from coming into contact with each other, so that galling or seizing can be suppressed.

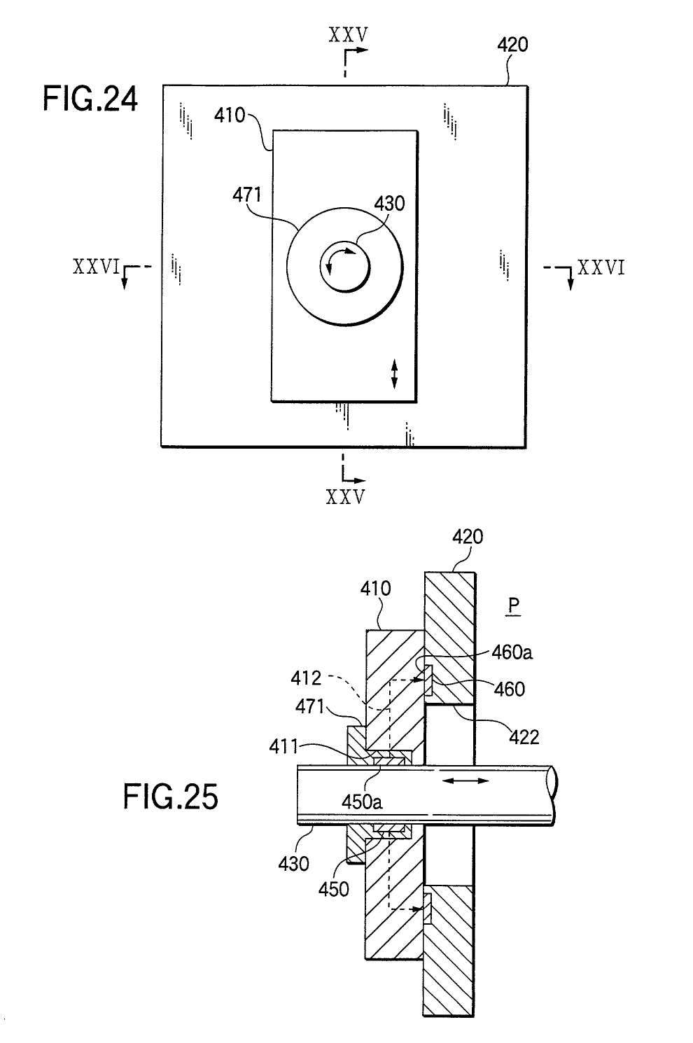

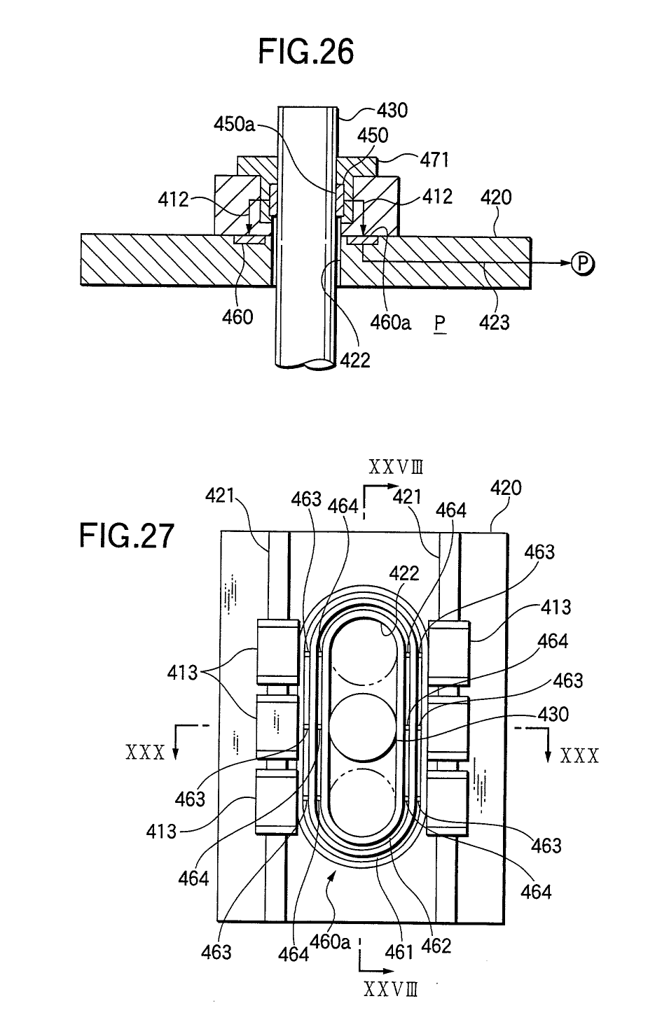

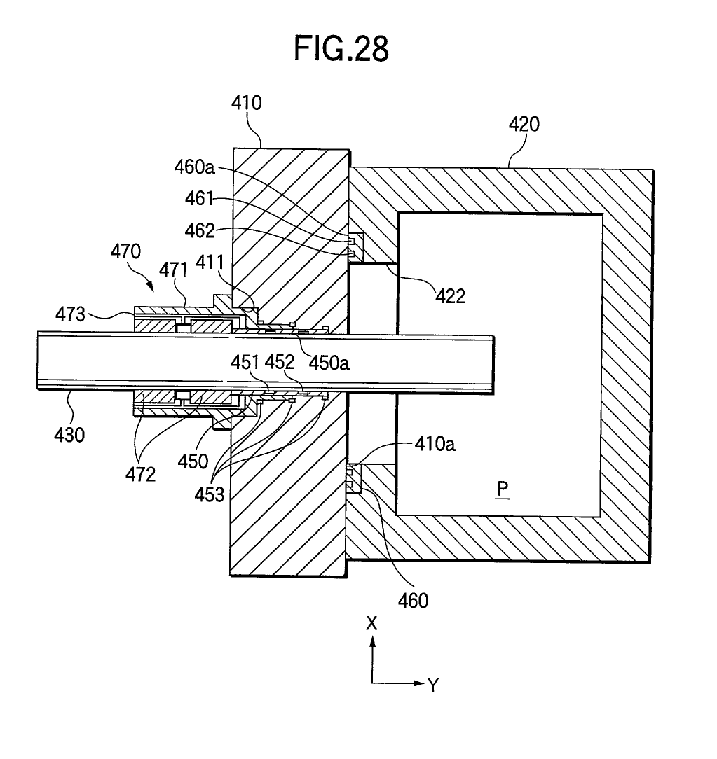

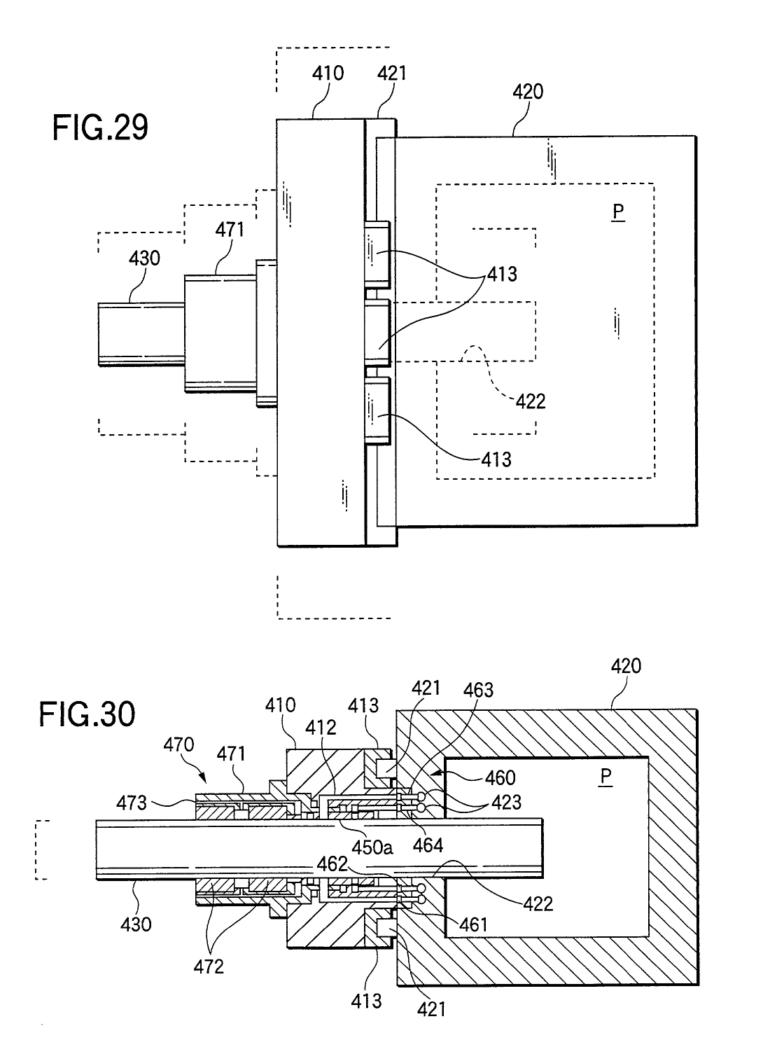

An eighth embodiment of the invention will be described below with reference to FIGS. 24 to 30. The positioning device according to this embodiment can perform biaxial movement and rotation. FIG. 24 is a typical plan view of the positioning device according to the embodiment of the invention. FIG. 25 is a sectional view taken along the line XXV-XXV and from the direction of arrows, showing the positioning device depicted in FIG. 24. FIG. 26 is a sectional view taken along the line XXVI-XXVI and from the direction of arrows, showing the positioning device depicted in FIG. 24. FIG. 27 is a detailed plan view of the positioning device according to the embodiment in a state in which the X-axis stage 410 is removed. FIG. 28 is a sectional view taken along the line XXVIII-XXVIII and from the direction of arrows, showing the positioning device depicted in FIG. 27. FIG. 29 is a side view of the positioning device depicted in FIG. 27. FIG. 30 is a sectional view taken along the line XXX-XXX and from the direction of arrows, showing the positioning device depicted in FIG. 27.

An X-axis stage (slider) 410 which is a movable portion has a circular opening 411 in its center. A differential evacuation seal (second differential evacuation sealing device) 450 is provided in the opening 411. The differential evacuation seal 450 is shaped approximately like a cylinder so as to be fitted to the opening 411. An inner circumferential surface 450a of the differential evacuation seal 450 constitutes an evacuation surface. The evacuation surface 450a has two annular groove portions 451 and 452 which communicate with a surface of the X-axis stage 410 opposite to a box 420, through communicating passages 412 (FIG. 30) which are stationary pipes passing through the inside of the X-axis stage 410. Incidentally, the reference numeral 453 designates a contact sealing O-ring for performing sealing between the X-axis stage 410 and a housing 471 which will be described below.

The housing 471 having a bearing portion 470 (second bearing, which will be described later) and the differential evacuation seal 450 in its inside is fitted into the opening 411 of the X-axis stage 410 in a state in which sealing is performed between the housing 471 and the box 420. A cylindrical shaft 430 which is a shaft member (second movable portion) is inserted through the inside of the housing. A portion of cylindrical shaft's the circumferential surface which is a sealing surface is enclosed in the differential evacuation seal 450. In a surface opposite to the outer circumferential surface of the cylindrical shaft 430, portions of the evacuation surface 450a except the groove portions 451 and 452 and the inner circumferential surfaces of the static-pressure bearing portions 472 are set so that the gap from the outer circumferential surface of the cylindrical shaft 430 is sufficient small as shown also in FIGS. 28 and 30 compared with the other portions, that is, the right portion of the evacuation surface 450a, the portion between the evacuation surface 450a and each static-pressure bearing portion 472 and the portion held between the two static-pressure bearing portions 472. As shown in FIG. 30, three upper sliders 413 and three lower sliders 413 in FIG. 30, that is, six sliders 413 in total are disposed on the right side of the X-axis stage 410. Each of the sliders 413 is U-shaped in section. The sliders 413 are engaged with guide rails 421 disposed on the box 420 which is a stationary portion, through a large number of rolling bodies (not shown) but circulating in the sliders 413, so that the sliders 413 are slidable along the guide rails 421 in a direction perpendicular to the plane of FIG. 30. The sliders 413, the guide rails 421 and the large number of rolling bodies constitute a linear guide which is a kind of a roller guide bearing (first bearing). The box 420 which is a stationary portion having a left-side surface to which the guide rails 421 are attached, as shown in FIG. 28, is provided on the right of the X-axis stage 410. Incidentally, the process chamber P is formed in the inside of the box 420.

In FIGS. 25, 28 and 30, a differential evacuation seal 460 (first differential evacuation sealing device) for sealing a gap between the box 420 and the X-axis stage 410 is provided on the left-side surface of the box 420. As shown in FIG. 27, the differential evacuation seal 460 is shaped like a track extended along the circumference of the long hole 422 formed in the box 420. A surface 460a of the track-like portion opposite to the X-axis stage 410 functions as an evacuation surface of the differential evacuation seal 460. The differential evacuation seal 460 further forms two track-like grooves 461 and 462. The grooves 461 and 462 communicate with communicating passages 423 and 423, which are fixed pipes passing through the inside of the box 420, through internal passages 463 and 464 of the evacuation seal 460. The communicating passages 423 and 423 are connected to a suction pump (not shown). The evacuation surface 460a except the groove portions 461 and 462 is slightly protruded frontward in FIG. 27 compared with the portion of the box 420 opposite to the X-axis stage 410 provided outside the evacuation surface 460a. The linear guide (first bearing) sets the protruded portions and the surface 410a (opposite seal surface) of the X-axis stage 410 opposite thereto so that the protruded portions are opposite to the surface 410a at a sufficiently small distance compared with the portions provided outside the protruded portions.

In FIG. 28, the bearing portion 470 shaped approximately like a cylinder is attached to the opening 411 of the X-axis stage 410. The bearing portion 470 has: the housing 471 having one end fitted to the opening 411; and the pair of cylindrical static-pressure bearing portions 472 disposed in the housing 471.

The static-pressure bearing portions 472 surround the cylindrical shaft 430 and are connected to a pressure pump (not shown), through communicating holes and air supply pipes which are (not shown) but formed in the housing 471. Further, passages 473 are provided in the housing 471 so that gas exhausted from side portions of the two static-pressure bearing portions 472 can be released into the atmosphere. Incidentally, known porous bearings are used in the static-pressure bearing portions 472 but the invention is not limited thereto and another system may be used. Although this embodiment has shown the case where air is used as a fluid supplied to the static-pressure bearing portions 472, the invention may be applied also to the case where another gas or magnetic fluid is used.

In this embodiment, the groove portions 461 and 462 of the differential evacuation seal 460 are provided in positions of the evacuation surface 460a opposite to outlets of the communicating passages 412 on the surface 410a of the X-axis stage 410 regardless of the position of the X-axis stage 410. Hence, the two differential evacuation seals 450 and 460 communicate with each other through the communicating passages 412 provided in the inside of the X-axis stage 410. The communicating passages 412 are connected to a suction pump through the differential evacuation seal 460 and communicating passages 423. Hence, when the suction pump operates, air discharged from the differential evacuation seal 450 is led to the outside from the groove portions 451 and 452 through the communicating passages 412, the groove portions 461 and 462 of the differential evacuation seal 460, the internal passages 463 and 464 and the communicating passages 423. Similarly, air discharged from the differential evacuation seal 460 is led to the outside from the communicating passages 423.

Incidentally, the communicating passages 412 and the communicating passages 423 which are stationary pipes are provided in the X-axis stage 410 and in the inside of the box 420 respectively. Hence, each of the communicating passages 412 and 423 can be formed to have a large diameter. The communicating passages 412 and the internal passages 463 and 464, however, may be shorter than the communicating passages 423 structurally. Hence, in this embodiment, the diameter of each of the communicating passages 412 and the internal passages 463 and 464 is set to be smaller than the diameter of each of the communicating passages 423 because the load applied on the suction pump is small even in the case where the diameter of each of the communicating passages 412 and the internal passages 463 and 464 is smaller.

Next, the operation of this embodiment will be described below. In FIG. 28, the left-right direction is defined as a Y-axis direction and the up-down direction as an X-axis direction. Because the X-axis stage 410 is supported relative to the box 420 in a low friction state by the linear guide (first bearing) constituted by the guide rails 421, the bearings 413 and the large number of rolling bodies, the X-axis stage 410 can be driven to move in the X-axis direction relative to the box 420 through a ball screw by an external drive source (not shown). On this occasion, the cylindrical shaft 430 moves together with the X-axis stage 410 in the X-axis direction because the long hole 422 in the box 420 allows the cylindrical shaft 430 to move in the X-axis direction. In other words, the X-axis stage 410 can move in the X-axis direction relative to the box 420 in a range defined by the length of the long hole 422.

On the other hand, the left end of the cylindrical shaft 430 is connected to a drive source (not shown) disposed on the X-axis stage 410, so that the cylindrical shaft 430 can be driven in the Y direction. On this occasion, air is compressively fed from a pressure pump (not shown) through air supply pipes and communicating holes (not shown), so that the air is jetted out from the inner circumferential surfaces of the static-pressure bearing portions 472 which are second bearings. Hence, the cylindrical shaft 430 is supported contactlessly with the static-pressure bearing portions 472 by the pressure of the air so that the cylindrical shaft 430c an be moved relative to the X-axis stage 410 without any frictional resistance.

On this occasion, the differential evacuation seal 460 having the evacuation surface 460a sucks air between the differential evacuation seal 460 and the side surface 410a (opposite seal surface) of the X-axis stage 410 through the communicating passages 423 of the box 420 on the basis of the suction force of a suction pump (not shown). The differential evacuation seal 460 further sucks air between the differential evacuation seal 450 and the surface (opposite seal surface) of the cylindrical shaft 430 through the communicating passages 412 of the X-axis stage 410. Hence, the process chamber P can be prevented from being invaded by external air or foreign matter through the gap between the X-axis stage 410 and the box 420 and the gap between the X-axis stage 410 and the cylindrical shaft 430. Accordingly, even in the case where the process chamber P in the box 420 is put in a vacuum environment in order to process the work, the process chamber P can be preferably kept in the vacuum environment because the differential evacuation seals 450 and 460 can prevent external air from entering the process chamber P. Also in the case where the process chamber P is filled with a gas, the gas can be recovered by the differential evacuation seals so that the gas can be prevented from leaking out of the process chamber P.

The cylindrical shaft 430 can be rotated around its axis by a drive mechanism (not shown). Hence, in this embodiment, the cylindrical shaft 430 can be rotated around its axis as well as moved in the two, X and Y directions.

As described above, in accordance with this embodiment, the two differential evacuation seals 450 and 460 communicate with each other through the communicating passages 412 provided in the inside of the X-axis stage 410. The differential evacuation seal 460 further communicates with the outside through the communicating passages 423 provided in the inside of the box 420 and a suction pump. Hence, evacuation from the differential evacuation seals 450 and 460 is performed through the communicating passages 412 and 423. Hence, when evacuation from the differential evacuation seals 450 and 460 is performed through the communicating passages 412 and 423 which are fixed in the X-axis stage 410 and in the inside of the box 420 respectively and each of which can have a larger diameter than that of a flexible pipe, evacuating efficiency can be improved more than ever to thereby enhance the sealing capacity of the differential evacuation seals 450 and 460. Particularly the provision of relatively long-distance communicating passages 423 in the box 420 which is a stationary portion is effective in improving evacuating efficiency. There is no problem even in the case where the box 420 which is a stationary portion is relatively large-sized in order to increase stiffness. Hence, it is convenient that the diameter of each of the communicating passages 423 provided in the inside of the box 420 is set to be large.

Moreover, because sliding in the X and Y directions is achieved by a combination of the box having the long hole, the X-axis stage, and the shaft sliding the opening provided in the X-axis stage in the Y direction as described in this embodiment, the distance from the differential evacuation seal 450 to the communicating passages 423 can be shortened. Hence, even in the case where the diameter of each of the passages (communicating passages 412 and internal passages 463 and 464) up to the communicating passages 423 is set to be relatively small, the influence on reduction of evacuating efficiency is small. Particularly reducing the diameter of the communicating passages 412 is effective in reducing the size of the movable portion such as the X-axis stage 410 and the size of the bearing for supporting the movable portion. In other words, when the diameter of the relatively long-distance communicating passages 423 provided in the box 420 is set to be larger than that of the other passages, improvement of evacuating efficiency and reduction in size of the movable portion can be attained simultaneously. To improve evacuating efficiency, a small-capacity small-sized vacuum pump can be attached into the box 420 and used. Because the communicating passages 412 and 423 through which evacuation from the two differential evacuation seals 450 and 460 is performed communicate with each other, it is unnecessary to connect a vacuum pump to the X-axis stage 410, that is, the vacuum pump needs to be connected to none but the box 420. Hence, all the members can be evacuated with the smallest number of pumps. Incidentally, pipes also need to be laid in the movable portion in order to supply air from the pressure pump to the static-pressure bearing portions 472. However, there is no problem because the diameter of the pipes required in this case can be set to be smaller than that of the pipes required for evacuation.

Incidentally, the same effect as in the first embodiment can be obtained in the eighth embodiment and various changes and modifications may be made upon the eighth embodiment in the same manner as in the first embodiment.

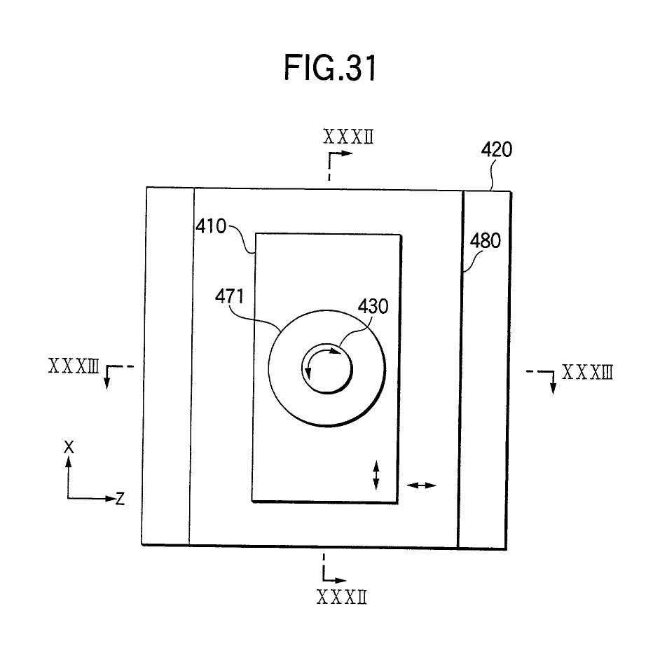

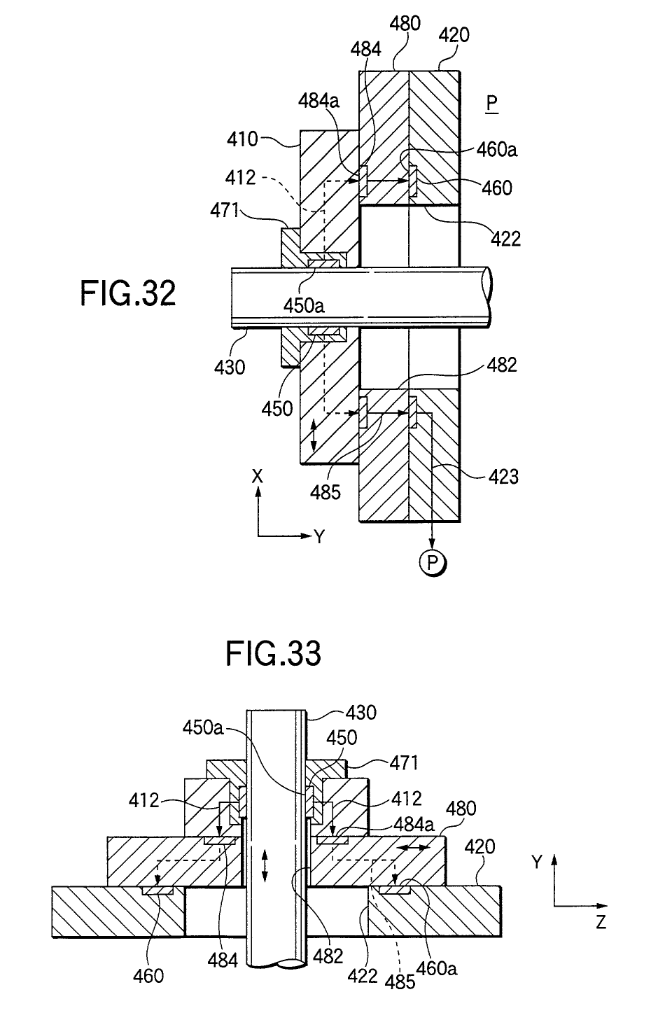

Next, a ninth embodiment of the invention will be described below with reference to FIGS. 31 to 33. The positioning device according to this embodiment can perform positioning with four degrees of freedom by further addition of a stage moving in the Z direction to the positioning device of the eighth embodiment. FIG. 31 is a typical plan view of a positioning device according to the embodiment. FIG. 32 is a sectional view taken along the line XXXII-XXXII and from the direction of arrows, showing the positioning device depicted in FIG. 31. FIG. 33 is a sectional view taken along the line XXXIII-XXXIII and from the direction of arrows, showing the positioning device depicted in FIG. 31. In the following description, parts the same as those in the eighth embodiment are referenced correspondingly and the description of the parts will be omitted as well as the description of the configuration common to the eighth embodiment will be omitted.

As shown in FIGS. 31 to 33, in this embodiment, a Z-axis stage 480 is disposed between the X-axis stage (slider) 410 and the box 420. This embodiment is different from the eighth embodiment in that the long hole 422 in the box 420 is shaped like a rectangle extended both in the X direction and in the Z direction to make it possible to move the Z-axis stage 480 in the Z direction. A long hole 482 extended in the X direction is provided in the Z-axis stage 480 to make it possible to move the X-axis stage in the X direction.

A differential evacuation seal (third differential evacuation sealing device) 484 shaped like a track to surround the long hole 482 is provided on a surface of the Z-axis stage 480 opposite to the X-axis stage 410. Though not shown in detail, the differential evacuation seal 484 has the same configuration as that of the differential evacuation seal 460 in the eighth embodiment. Groove portions (not shown) of the differential evacuation seal 484 are provided in positions which are opposite to outlets of the communicating passages 412 of the X-axis stage 410 and which is in an evacuation surface 484a of the differential evacuation seal 484. Further, communicating passages 485 which are the same as the internal passages 463 and 464 in the eighth embodiment, which are opened to the groove portions (not shown) of the differential evacuation seal 484 and which are stationary pipes passing through the inside of the Z-axis stage 480 are provided between a surface of the Z-axis stage 480 opposite to the box 420 and the differential evacuation seal 484. Further, the groove portions (see FIG. 28) of the differential evacuation seal 460 are provided in positions which are opposite to outlets of the communicating passages 485 of the Z-axis stage 480 and which are in the evacuation surface 460a of the differential evacuation seal 460, regardless of the position of the Z-axis stage 480.

Therefore, the three differential evacuation seals 450, 484 and 460 communicate with one another through the communicating passages 412 provided in the inside of the X-axis stage 410 and the communicating passages 485 provided in the inside of the Z-axis stage 480. The communicating passages 412 and 485 are connected to a suction pump through the differential evacuation seal 460 and the communicating passages 423. Hence, when the suction pump operates, air discharged from the differential evacuation seal 450 is given from the groove portions 451 and 452 to the groove portions 461 and 462 of the differential evacuation seal 460 through the communicating passages 412, the differential evacuation seal 484 and the communicating passages 485 and led to the outside through the communicating passages 423. Air discharged from the differential evacuation seals 484 and 460 is led to the outside from the communicating passages 423 in the same manner as described above.

Incidentally, because the communicating passages 485, 412 and 423 which are fixed pipes are provided in the inside of the Z-axis stage 480, the X-axis stage 410 and the box 420 respectively, each of the communicating passages 485, 412 and 423 can be formed to have a large diameter. Particularly because each of the long-distance communicating passages 423 provided in the box 420 which is a stationary portion can be easily formed to have a large diameter, increase in diameter of the communicating passages 423 is effective in improving evacuating efficiency.

In this embodiment, the positioning device operates in the X, Y and Z directions independently and the cylindrical shaft 430 rotates around its axis.

On this occasion, the differential evacuation seal 460 having the evacuation surface 460a sucks air between the box 420 and the Z-axis stage 480 through the communicating passages 423 of the box 420 on the basis of the suction force of a suction pump (not shown). The differential evacuation seal 460 further sucks air between the Z-axis stage 480 and the X-axis stage 410 through the communicating passages 485, and air between the differential evacuation seal 450 and the surface (opposite seal surface) of the cylindrical shaft 430 through the communicating passages 412. Hence, the process chamber P can be prevented from being invaded by external air and foreign matter through the gaps between the respective members. Accordingly, even in the case where the process chamber P in the box 420 is put in a vacuum environment in order to process the work, the process chamber P can be preferably kept in the vacuum environment because the differential evacuation seals 450, 484 and 460 can prevent external air from entering the process chamber P. Also in the case where the process chamber P is filled with a gas, the gas can be recovered by the differential evacuation seals so that the gas can be prevented from leaking out of the process chamber P.

As described above, in accordance with this embodiment, the three differential evacuation seals 450, 484 and 460 communicate with one another through the communicating passages 412 provided in the inside of the X-axis stage 410 and the communicating passages 485 provided in the inside of the Z-axis stage 480. The differential evacuation seal 460 further communicates with the outside through the communicating passages 423 provided in the inside of the box 420 and a suction pump. Hence, evacuation from the differential evacuation seals 450, 484 and 460 is per formed through the communicating passages 412, 485 and 423. Hence, when evacuation from the differential evacuation seals 450, 484 and 460 is performed through the communicating passages 412, 485 and 423 which are fixed in the inside of the X-axis stage 410, in the inside of the Z-axis stage 480 and in the inside of the box 420 respectively and each of which can have a larger diameter than that of a flexible pipe, evacuating efficiency can be improved more than ever to thereby enhance the sealing capacity of the differential evacuation seals 450, 484 and 460. Particularly the provision of relatively long-distance communicating passages 423 in the box 420 which is a stationary portion is effective in improving evacuating efficiency. There is no problem even in the case where the box 420 which is a stationary portion is relatively large-sized in order to increase stiffness. Hence, it is convenient that the diameter of each of the communicating passages 423 provided in the inside of the box 420 is set to be large. Moreover, because movement in the X, Y and Z directions is achieved by the configuration of this embodiment, the distance from the differential evacuation seal 450 to the communicating passages 423 can be shortened. Hence, even in the case where the diameter of each of the passages (communicating passages 412, 485 and so on) up to the communicating passages 423 is set to be relatively small, the influence on reduction of evacuating efficiency is small. Particularly reducing the diameter of the communicating passages 412 and 485 is effective in reducing the size of the movable portion such as the X-axis stage 410 and the Z-axis stage 480 and the size of the bearing for supporting the movable portion. In other words, when the diameter of the relatively long-distance communicating passages 423 provided in the box 420 is set to be larger than that of the other passages, improvement of evacuating efficiency and reduction in size of the movable portion can be attained simultaneously. To improve evacuating efficiency, a small-capacity small-sized vacuum pump can be attached into the box 420 and used. Because the communicating passages 412, 485 and 423 through which evacuation from the three differential evacuation seals 450, 484 and 460 is performed communicate with one another, it is unnecessary to connect a pump to the X-axis stage 410 and the Z-axis stage 480, that is, the pump needs to be connected to none but the box 420. Hence, all the members can be evacuated with the smallest number of pumps.

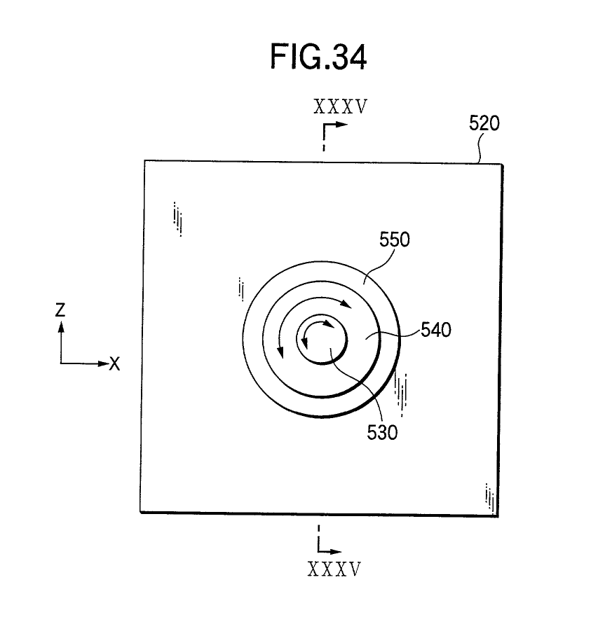

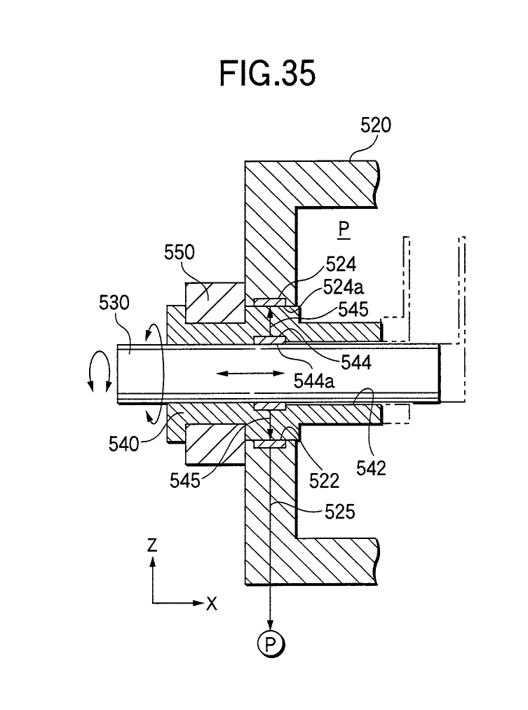

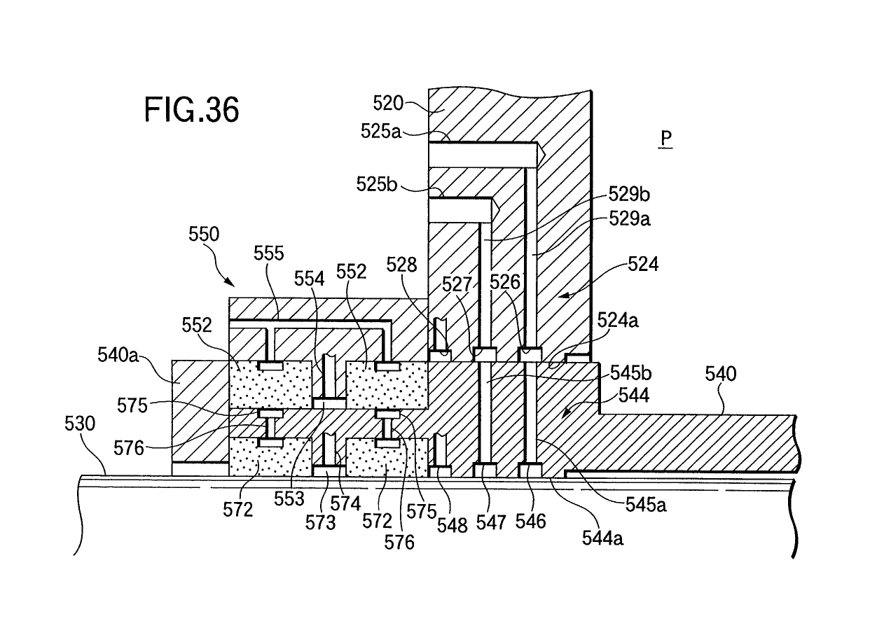

Next, a tenth embodiment of the invention will be described below with reference to FIGS. 34 to 36. The positioning device according to this embodiment can rotate a cylindrical shaft (center shaft) and an intermediate shaft, which is provided to surround the cylindrical shaft (center shaft), around centers of their axes respectively. FIG. 34 is a typical plan view of the positioning device according to the embodiment. FIG. 35 is a sectional view taken along the line XXXV-XXXV and from the direction of arrows, showing the positioning device depicted in FIG. 34. FIG. 36 is a detailed view showing important part of FIG. 35.

As shown in FIGS. 34 to 36, in this embodiment, a circular opening 522 is provided in a box 520 having a process chamber P. A cylindrical intermediate shaft 540 is inserted through the opening 522. An opening 542 is formed in the intermediate shaft 540 so that a center shaft 530 is inserted through the opening 542. Both the intermediate shaft 540 and the center shaft 530 face the process chamber P at their one-end sides. Works (not shown) can be disposed at forward ends of the their one-sides of the shafts 540 and 530 respectively. An annular bearing unit 550 fixed to the box 520 is disposed in a portion of the intermediate shaft 540 protruded out from the box 520.

Differential evacuation seals 524 and 544 each having the same configuration as the differential evacuation seal 450 described in the eighth embodiment are provided on opposite surfaces of the intermediate shaft 540 and the box 520 and on opposite surfaces of the intermediate shaft 540 and the center shaft 530 respectively. Further, communicating passages 545 (constituted by two communicating passages 545a and 545b as shown in FIG. 36) which are fixed pipes passing through the inside of the intermediate shaft 540 are provided between the surface of the intermediate shaft 540 opposite to the box 520 and the differential evacuation seal 544. Communicating passages 525 (constituted by two communicating passages 525a and 525b as shown in FIG. 36) for connecting the differential evacuation seal 524 to a vacuum pump are provided in the inside of the box 520.

As shown in FIG. 36, the differential evacuation seal 524 has three annular groove portions 526, 527 and 528 in its opposite surface (evacuation surface) 524a opposite to the intermediate shaft 540. The groove portions 526 and 527 are connected to the communicating passages 525a and 525b through holes 529a and 529b respectively. The groove portion 528 is opened to the atmosphere. On the other hand, the differential evacuation seal 544 has three annular groove portions 546, 547 and 548 in its opposite surface (evacuation surface) 544a opposite to the center shaft 530. The groove portions 546 and 547 are connected to the communicating passages 545a and 545b respectively. The groove portion 548 is opened to the atmosphere.

The groove portions 526 and 527 of the differential evacuation seal 524 are provided in positions opposite to outlets of the communicating passages 545a and 545b of the intermediate shaft 540 in the evacuation surface 524a of the differential evacuation seal 524. Hence, the two differential evacuation seals 524 and 544 communicate with each other through the communicating passages 545a and 545b provided in the inside of the intermediate shaft 540. The communicating passages 545a and 545b are connected to suction pumps (which are configured so that the capacity of one suction pump connected to the communicating passage 525a is larger than that of the other suction pump connected to the communicating passage 525b) through the differential evacuation seal 524, the holes 529a and 529b and the communicating passages 525a and 525b. Hence, when the suction pumps operate, air exhausted from the differential evacuation seal 544 is led to the outside from the groove portions 546 and 547 to the outside through the communicating passages 545a and 545b, the differential evacuation seal 524, the holes 529a and 529b and the communicating passages 525a and 525b. Air exhausted from the differential evacuation seal 524 is led to the outside from the communicating passages 525 in the same manner as described above.

Incidentally, because the communicating passages 545a and 545b, the holes 529a and 529b, and the communicating passages 525a and 525b are fixed pipes and provided in the inside of the intermediate shaft 540 and the box 520, each of the communicating passages 545a, 545b, 525a and 525b and the holes 529a and 529b can be formed to have a large diameter.

Further, as shown in FIG. 36, two annular static-pressure bearings (radial support) 572 are disposed in a portion of the intermediate shaft 540 facing the center shaft 530. A groove portion 573 is provided between the two static-pressure bearings 572. The groove portion 573 is opened to the atmosphere through a pipe 574. On the other hand, a bearing unit 550 has two static-pressure bearings (radial and thrust support) 552 disposed in positions opposite to a part of the outer circumferential surface of the intermediate shaft 540. A groove portion 553 is provided between the two static-pressure bearings 552. The groove portion 553 is opened to the atmosphere through a pipe 554. The static-pressure bearings 552 are respectively supplied with air through a pipe 555 connected to an air supply pump (not shown). Two annular groove portions 575 are provided in positions which are opposite to the static-pressure bearings 552 and in a surface of the intermediate shaft 540 opposite to the bearing unit 550. The groove portions 575 are connected to the static-pressure bearings 572 through pipes 576. Hence, air from the air supply pump is supplied to the static-pressure bearings 572 as well as to the static-pressure bearings 552. In FIG. 36, the reference numeral 540a designates a flange portion fixed to an end portion of the intermediate shaft 540. Hence, the intermediate shaft 540 can restrict so as not to be moved axially relative to the box 520.

Incidentally, each of the radial and thrust support static-pressure bearings 552 and the radial support static-pressure bearings 572 used herein has the same configuration and the same function as the static-pressure bearing 572 used in the eighth embodiment. That is, the static-pressure bearings 552 support the intermediate shaft 540 contactlessly with the box 520 by air jetted out from their inner circumferential surfaces and their opposite end surfaces so that the intermediate shaft 540 can be rotated without any frictional resistance. The static-pressure bearings 572 support the center shaft 530 contactlessly with the intermediate shaft 540 by air jetted out from their inner circumferential surfaces so that the center shaft 530 can be rotated and relatively moved in the Y direction without any frictional resistance.

In the positioning device configured as described above according to this embodiment, the center shaft 530 and the intermediate shaft 540 can be rotated around an axial center independently of each other and the center shaft 530 can be moved in the Y direction. Incidentally, when the intermediate shaft 540 does not have a stepped shape shown in this embodiment, the intermediate shaft 540 may be configured so that the intermediate shaft 540 can be also moved in the Y direction within a range in which communication of the groove portions 526 and 527 with the communicating passages 545a and 545b can be guaranteed. Alternatively, the center shaft 530 may be configured so that the center shaft 530 can be either rotated around its axis or moved in the Y direction.

On this occasion, the differential evacuation seal 524 having the evacuation surface 524a sucks air between the box 520 and the intermediate shaft 540 through the communicating passages 525 of the box 520 on the basis of the suction force of a suction pump (not shown). The differential evacuation seal 524 further sucks air between the intermediate shaft 540 and the center shaft 530 through the communicating passages 545. Hence, the process chamber P can be prevented from being invaded by external air and foreign matter through the gaps between the respective members. Accordingly, even in the case where the process chamber P in the box 520 is put in a vacuum environment in order to process the work, the process chamber P can be preferably kept in the vacuum environment because the differential evacuation seals 524 and 544 can prevent external air from entering the process chamber P. Also in the case where the process chamber P is filled with a gas, the gas can be recovered by the differential evacuation seals so that the gas can be prevented from leaking out of the process chamber P.

As described above, in accordance with this embodiment, the two differential evacuation seals 524 and 544 communicate with each other through the communicating passages 545 provided in the inside of the intermediate shaft 540. The differential evacuation seal 524 further communicates with the outside through the communicating passages 525 provided in the inside of the box 520 and a suction pump. Hence, evacuation from the differential evacuation seals 524 and 544 is performed through the communicating passages 525 and 545. Hence, when evacuation from the differential evacuation seals 524 and 544 is performed through the communicating passages 525 and 545 which are fixed in the inside of the box 520 and in the inside of the intermediate shaft 540 respectively and each of which can have a larger diameter than that of a flexible pipe, evacuating efficiency can be improved more than ever to thereby enhance the sealing capacity of the differential evacuation seals 524 and 544. To improve evacuating efficiency, a small-capacity small-sized vacuum pump can be attached into the box 520 and used. Because the communicating passages 525 and 545 through which evacuation from the two differential evacuation seals 524 and 544 is performed communicate with each other, it is unnecessary to connect a pump to the intermediate shaft 540, that is, the pump needs to be connected to none but the box 520. Hence, all the members can be evacuated with the smallest number of pumps.

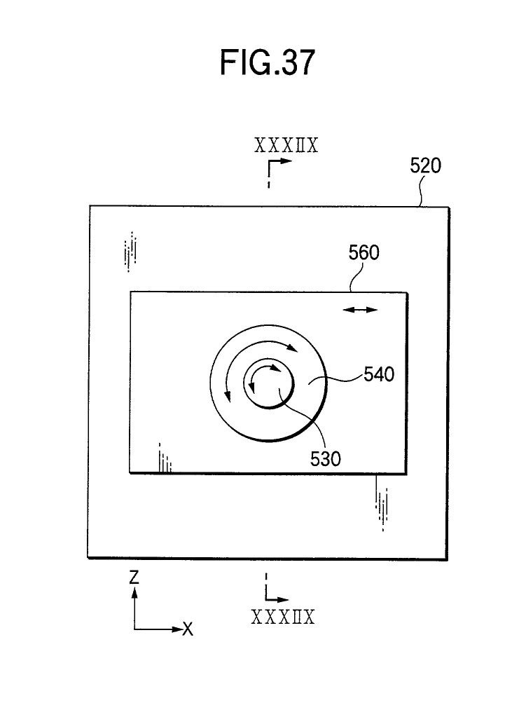

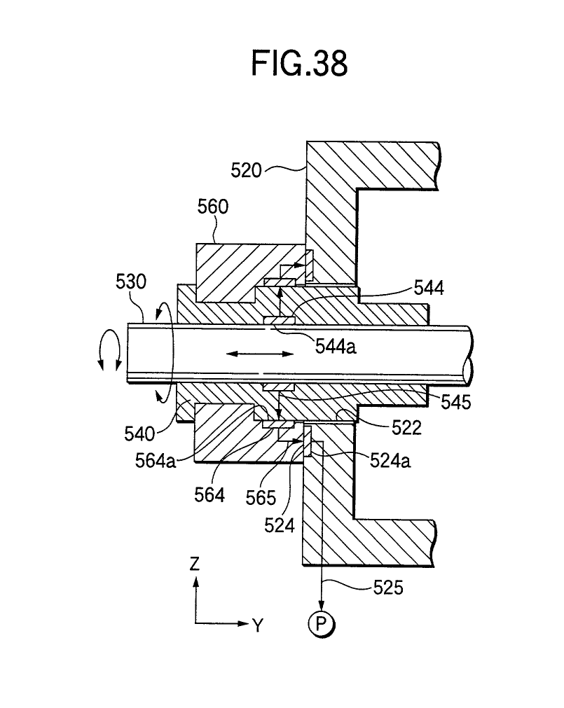

Next, an eleventh embodiment of the invention will be described below with reference to FIGS. 37 and 38. The positioning device according to this embodiment can perform positioning with four degrees of freedom by further addition of a stage moving in the X direction to the positioning device of the tenth embodiment. FIG. 37 is a typical plan view of a positioning device according to the embodiment. FIG. 38 is a sectional view taken along the line XXXIIX-XXXIIX and from the direction of arrows, showing the positioning device depicted in FIG. 37. In the following description, parts the same as those in the tenth embodiment are referenced correspondingly and the description of the parts will be omitted as well as the description of the configuration common to the tenth embodiment will be omitted.

As shown in FIGS. 37 and 38, in this embodiment, an X-axis stage (slider) 560 is disposed outside the box 520 so as to surround the intermediate shaft 540. This embodiment is different from the tenth embodiment in that the opening 522 of the box 520 is formed as a long hole extended in the X direction so that the X-axis stage 560 can be moved in the X direction.

Further, a track-like differential evacuation seal 524 is provided in a surface of the box 520 opposite to the X-axis stage 560 so that the differential evacuation seal 524 surrounds the opening 522. An annular differential evacuation seal 564 is provided in a surface of the X-axis stage 560 opposite to the intermediate shaft 540. Though not shown in detail, the differential evacuation seal 564 has the same configuration as the differential evacuation seal 544. Groove portions (not shown) of the differential evacuation seal 564 are provided in positions opposite to outlets of the communicating passages 545 of the intermediate shaft 540 and in the evacuation surface 564a of the differential evacuation seal 564. Further, communicating passages 565 which are fixed pipes passing through the inside of the X-axis stage 560 are provided between a surface of the X-axis stage 560 opposite to the box 520 and the differential evacuation seal 564. Groove portions (not shown) of the differential evacuation seal 524 are provided in positions opposite to outlets of the communicating passages 565 of the X-axis stage 560 and in the evacuation surface 524a of the differential evacuation seal 524.

Therefore, the three differential evacuation seals 544, 564 and 524 communicate with one another through the communicating passages 545 provided in the inside of the intermediate shaft 540 and the communicating passages 565 provided in the inside of the X-axis stage 560. The communicating passages 545 and 565 are connected to a suction pump through the differential evacuation seal 524 and the communicating passages 525. Hence, when the suction pump operates, air discharged from the differential evacuation seal 544 is given to the differential evacuation seal 524 through the communicating passages 545, the differential evacuation seal 564 and the communicating passages 565 and led to the outside through the communicating passages 525. Air discharged from the differential evacuation seals 564 and 524 is led to the outside from the communicating passages 525 in the same manner as described above.

Incidentally, because the communicating passages 545, 565 and 525 which are fixed pipes are provided in the inside of the intermediate shaft 540, the X-axis stage 560 and the box 520 respectively, each of the communicating passages 545, 565 and 525 can be formed to have a large diameter. Particularly because each of the long-distance communicating passages 525 is provided in the box 520 which is a stationary portion, and can be easily formed to have a large diameter, increase in diameter of the communicating passages 525 is effective in improving evacuating efficiency. On the other hand, the other communicating passages 545 and 565 can be selected to be structurally relatively short. Hence, the diameter of each of the communicating passages 545 and 565 maybe set small because the influence of the small diameter on reduction of evacuating efficiency is small. In this case, both the effect that increase in size of the X-axis stage 560, the intermediate shaft 540 and the center shaft 530 which are movable portions can be avoided and the effect that evacuating efficiency can be improved can be achieved simultaneously.

In this embodiment, the positioning device operates in the X and Y directions independently and the center shaft 530 and the intermediate shaft 540 rotate around an axis independently.

On this occasion, the differential evacuation seal 524 having the evacuation surface 524a sucks air between the box 520 and the X-axis stage 560 through the communicating passages 525 of the box 520 on the basis of the suction force of a suction pump (not shown). The differential evacuation seal 524 further sucks air between the X-axis stage 560 and the intermediate shaft 540 through the communicating passages 565, and air between the differential evacuation seal 544 and the surface (opposite seal surface) of the cylindrical shaft 530 through the communicating passages 545. Hence, the process chamber P can be prevented from being invaded by external air and foreign matter through the gaps between the respective members. Accordingly, even in the case where the process chamber P in the box 520 is put in a vacuum environment in order to process the work, the process chamber P can be preferably kept in the vacuum environment because the differential evacuation seals 544, 564 and 524 can prevent external air from entering the process chamber P. Also in the case where the process chamber P is filled with a gas, the gas can be recovered by the differential evacuation seals so that the gas can be prevented from leaking out of the process chamber P.

As described above, in accordance with this embodiment, the three differential evacuation seals 544, 564 and 524 communicate with one another through the communicating passages 545 provided in the inside of the intermediate shaft 540 and the communicating passages 565 provided in the inside of the X-axis stage 560. The differential evacuation seal 524 further communicates with the outside through the communicating passages 525 provided in the inside of the box 520 and a suction pump. Hence, evacuation from the differential evacuation seals 544, 564 and 524 is performed through the communicating passages 545, 565 and 525. Hence, when evacuation from the differential evacuation seals 544, 564 and 524 is performed through the communicating passages 545, 565 and 525 which are fixed in the inside of the intermediate shaft 540, the X-axis stage 560, and the box 520 respectively and each of which can have a larger diameter than that of a flexible pipe, evacuating efficiency can be improved more than ever to thereby enhance the sealing capacity of the differential evacuation seals 544, 564 and 524. To improve evacuating efficiency, a small-capacity small-sized vacuum pump can be attached into the box 520 and used. Because the communicating passages 545, 565 and 525 through which evacuation from the three differential evacuation seals 544, 564 and 524 is performed communicate with one another, it is unnecessary to connect a pump to the X-axis stage 560 and the intermediate shaft 540, that is, the pump needs to be connected to none but the box 520. Hence, all the members can be evacuated with the smallest number of pumps.

The positioning device according to any one of the eighth, ninth, tenth and eleventh embodiments is a positioning device including a plurality of members which can move relative to one another, and a plurality of differential evacuation seals for performing sealing among the plurality of members, wherein: the plurality of different evacuation seals communicate with one another through passages provided in the inside of the members; and evacuation from the plurality of differential evacuation seals is performed through the passages. Hence, when evacuation from the differential evacuation seals is performed through the passages which are provided and fixed into the inside of the members and each of which can have a diameter larger than that of a flexible pipe, evacuating efficiency can be improved more greatly than ever to thereby enhance the sealing capacity of the differential evacuation seals. Moreover, because evacuating efficiency is improved, a small-capacity small-sized vacuum pump can be attached into each of the members and used. Moreover, because the passages through which evacuation from the plurality of differential evacuation seals is performed communicate with one another, it is unnecessary to connect pumps to the members respectively, that is, it is possible to connect a pump to only one member having the final outlet in the communicating passages. Hence, all the members can be evacuated by use of the smallest number of pumps.

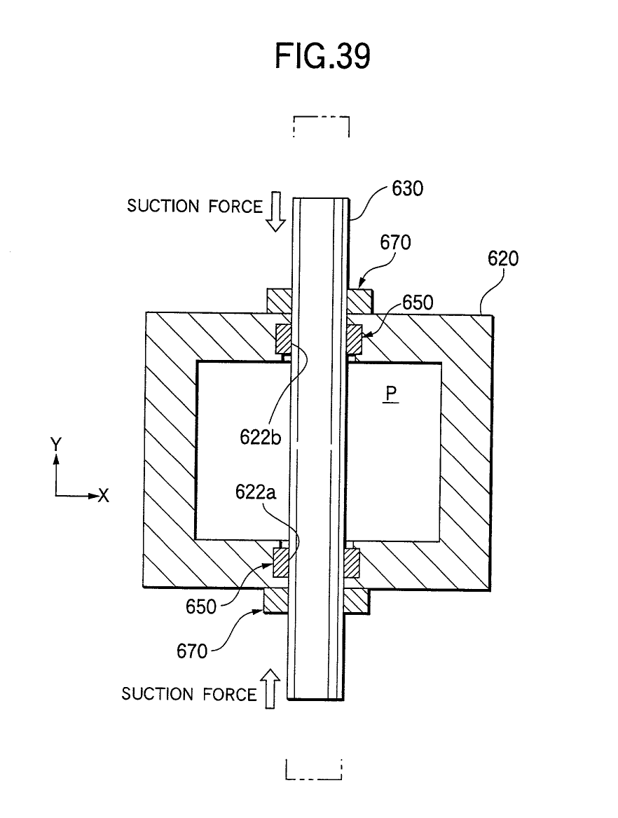

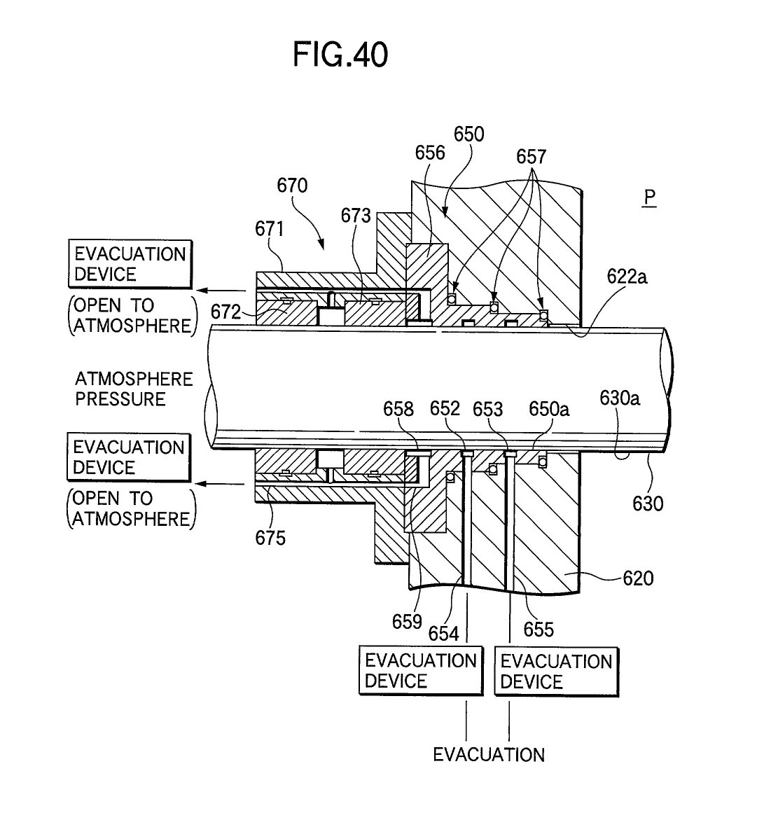

FIG. 39 is a front view of a positioning device according to a twelfth embodiment of the invention. In FIG. 39, the up-down direction is defined as a Y-axis direction and the left-right direction is defined as an X-axis direction. FIG. 40 is a detailed view showing the vicinity of an opening including the bearing portion depicted in FIG. 39.

As shown in FIG. 39, in the positioning device according to this embodiment, a columnar shaft member 630 driven in the Y-axis direction is inserted through a pair of holes 622a and 622b provided in opposite surfaces of a box 620 having a process chamber P. Differential evacuation seals 650 are provided on the inner circumferential surfaces of the holes 622a and 622b respectively to thereby make the process chamber P be sealed. Bearing portions 670 are provided on the outside of the holes 622a and 622b respectively so as to surround the shaft member 630.

As shown in FIG. 40 (which shows only the hole 622a but the same configuration applies to the hole 622b), the Y-axis differential evacuation seal 650 is provided in the hole 622a. The Y-axis differential evacuation seal 650 has a housing 656 shaped approximately like a cylinder and fitted to each of the holes 622a and 622b. An inner circumferential surface 650a of the Y-axis differential evacuation seal 650 forms an evacuation surface. The evacuation surface 650a has two annular groove portions 652 and 653 which are connected to suction pumps (not shown) through communicating passages 654 and 655 formed in the box 620.

Incidentally, O-rings 657 are disposed in corner portions of the housing 656. A groove portion 658 is provided in a portion of the housing 656 which is nearest to the bearing portion 670 and which touches the shaft portion 630. The groove portion 658 is connected to a passage 675 which is formed in the bearing portion 670 as will be described later, through a communicating passage 659 formed in the housing 656.

In the Y-axis differential evacuation seal 650, a region of the evacuation surface 650a (except the groove portions 652 and 653) and the static-pressure bearings 672 and 673 of the bearing portion 670 is set so that the gap between the region and the outer circumferential surface of the shaft member 630 is sufficient smaller than the gap between the other region and the outer circumferential surface of the shaft member 630.

Bearing portions 670 each shaped approximately like a cylinder are attached to the outside of the holes 622a and 622b respectively so as to be adjacent to the box 620. As shown in FIG. 40, each of the bearing portions 670 is constituted by a combination of a housing 671 having one end fitted to the housing 656 and a pair of cylindrical static-pressure bearings (static-pressure gas bearings) 672 and 673 disposed in the housing 671.

The static-pressure bearings 672 and 673 surround the shaft member 630 and are connected to a pressure pump (not shown) through communicating passages and air-supply pipes (not shown) formed in the housing 671. Further, the passage 675 is provided in the housing 671 so that gas discharged from side portions of the two static-pressure bearings 672 and 673 can be released into the atmosphere through the passage 675. Incidentally, a porous throttle type bearing is used as each of the static-pressure bearings but the invention is not limited thereto. Although this embodiment has shown the case where air is used as a fluid supplied to the static-pressure bearings, the invention may be applied also to the case where another gas or magnetic fluid is used.

The operation of the positioning device according to this embodiment will be described below. An end portion of the shaft member 630 is connected to a drive source (not shown) so that the shaft member 630 is driven in the Y-axis direction. On this occasion, air compresively fed from the pressure pump (not shown) through the communicating passages (not shown) but formed in the bearing portion 670 is jetted out from the inner circumferential surfaces of the static-pressure bearings 672 and 673. Hence, the shaft member 630 is supported contactlessly with the static-pressure bearings 672 and 673 by such air pressure, so that the shaft member 630 can move relative to the box 620 without any frictional resistance.

The Y-axis differential evacuation seal 650 having the evacuation surface 650a sucks air between the evacuation surface 650a and the circumferential surface 630a (opposite seal surface) of the shaft member 630 through the groove portions 652 and 653 and the communicating passages 654 and 655 by the suction pump (not shown). Hence, the process chamber P can be prevented from being invaded by external air or air leaked out from the static-pressure bearings 672 and 673 through the gap (kept constant by the static-pressure bearings 672 and 673) between the evacuation surface 650a and the shaft member 630. Particularly even in the case where the process chamber P in the box 620 is put in a vacuum environment to process the work, the vacuum environment of the process chamber P can be preferably retained because the differential evacuation seals 650 can prevent the process chamber P from being invaded by external air.

As described above, in accordance with this embodiment, suction forces (or repulsion forces) acting on the shaft member 630 cancel out each other because the shaft member 630 passes through the pair of opposite holes 622a and 622b. That is, because there is no thrust force acting on the shaft member 630, an excessive load is not imposed on the device driving the shaft member 630 so that imbalance due to the direction of the movement is eliminated. Further, when, for example, the shaft member 630 is disposed nearly horizontally, the shaft member 630 is supported by the pair of holes 622a and 622b so that distortion of the shaft member 630 is suppressed compared with the case where the shaft member 630 is supported by only one side. Hence, positioning accuracy is also improved.

Moreover, in accordance with this embodiment, contamination of the process chamber P can be prevented and maintenance of the drive system can be made easy without necessity of providing any drive system in the process chamber P because the shaft member 630 is driven from the outside of the box 620. Moreover, this embodiment has an advantage in that distortion of the shaft member 630 is small because the shaft member 630 is supported at two points.

Although the invention has been described with reference to embodiments thereof, the invention is not interpreted to be limited to the embodiments and it is a matter of course that various changes and modifications may be made suitably. For example, the case two groove portions are formed in each evacuation surface 650a has been shown but the invention is not limited thereto. One groove portion or three or more groove portions may be formed in each evacuation surface 650a in accordance with the performance of the suction pump and the magnitude of differential pressure between the inside and outside of the process chamber. The size of the gap between the evacuation surface and the opposite seal surface can be determined in accordance with the performance of the suction pump and can be selected suitably to be in a range of from the order of micrometers to the order of hundreds of micrometers. Besides the static-pressure bearings 672 and 673 shown in the embodiments, various kinds of bearings may be used as the bearings. For example, anti-friction bearings (such as ball bearings or roller bearings) may be used. The differential evacuation seal 650 may be integrated with the box 620 or may be provided separately.

In addition, in the embodiments, the box 620 is provided as a stationary portion and the shaft member 630 as a movable portion. Inversely, the shaft member 630 may be provided as a stationary portion and the box 620 as a movable portion. Further, the shaft member 630 may be provided to be rotated around its axis so that positioning can be made with two degrees of freedom.

Incidentally, the seals used in the embodiments and provided between the shaft member 630 and the openings 622a and 622b of the box 620 may be other seals than the differential evacuation seals, such as O-rings or stretchable metal bellows which are provided on the outside of the box so as to cover the shaft member.

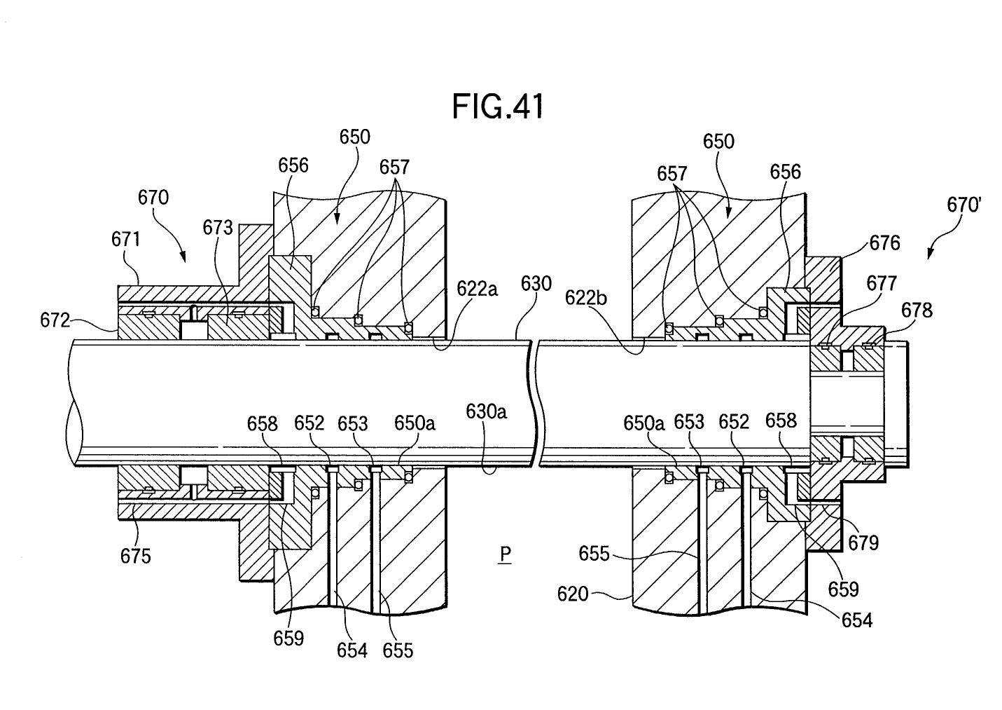

A thirteenth embodiment of the invention will be described below. This embodiment is configured so that the shaft member provided in the positioning device according to the twelfth embodiment and movable in the Y-axis direction is replaced by a shaft member which can rotate around its axis. FIG. 41 is a sectional view showing important part of the positioning device according to this embodiment. Incidentally, in this embodiment, parts the same as those in the twelfth embodiment are referenced correspondingly and the description thereof will be therefore omitted.

As shown in FIG. 41, this embodiment is different from the twelfth embodiment in that a bearing portion 670′ is provided on a portion which is provided as a concave portion on one end side of the stepped shaft member 630. The bearing portion 670′ is constituted by a combination of a housing 676 having one end fitted to the housing 656 and a pair of cylindrical static-pressure bearings (static-pressure gas bearings) 677 and 678 disposed in the housing 676.

The static-pressure bearings 677 and 678 surround the shaft member 630. The static-pressure bearings 677 and 678 are connected to a pressure pump (not shown) through communicating passages and air-supply pipes (not shown) formed in the housing 676. Passages 679 are provided in the housing 676 so that gas discharged from side portions of the two static-pressure bearings 677 and 678 can be released into the atmosphere through the passages 679. Incidentally, the static-pressure bearings 677 and 678 have the same configuration as the static-pressure bearings 672 and 673 except that the static-pressure bearings 677 and 678 are different in size from the static-pressure bearings 672 and 673 and except that opposite end surfaces of the static-pressure bearings 677 and 678 opposite to the stepped side surface of the shaft member 630 are provided as bearing surfaces. Although this embodiment has shown the case where air is used as a fluid supplied to the static-pressure bearings, the invention may be applied also to the case where another gas or magnetic fluid is used.

One stepped end of the shaft member 630 is rotatably supported on the outside of the bearing portion 670′ by a drive device (not shown). Hence, the shaft member 630 can rotate around its axis.

Also in this embodiment, the shaft member 630 passes through the pair of holes 622a and 622b opposite to each other in the same manner as in the twelfth embodiment, so that suction forces (or repulsion forces) acting on the shaft member 630 cancel out each other. That is, because no thrust force acts on the shaft member 630 so that there is no excessive load imposed on the device of driving the shaft member 630, imbalance due to the direction of the movement is eliminated. Further, when, for example, the shaft member 630 is disposed nearly horizontally, the shaft member 630 is supported by the pair of holes 622a and 622b so that distortion of the shaft member 630 is suppressed compared with the case where the shaft member is supported by only one side. Hence, positioning accuracy is also improved.

Moreover, in accordance with this embodiment, because the shaft member 630 is driven from the outside of the box 620, contamination of the process chamber P can be prevented and maintenance of the drive system can be made easily without necessity of providing any drive system in the process chamber P. Moreover, this embodiment has an advantage in that distortion of the shaft member 630 is small because the shaft member 630 is supported at two points.

Also in this embodiment, other seals than the differential evacuation seals may be used as the seals. Roller bearings may be used as the rolling bearings.

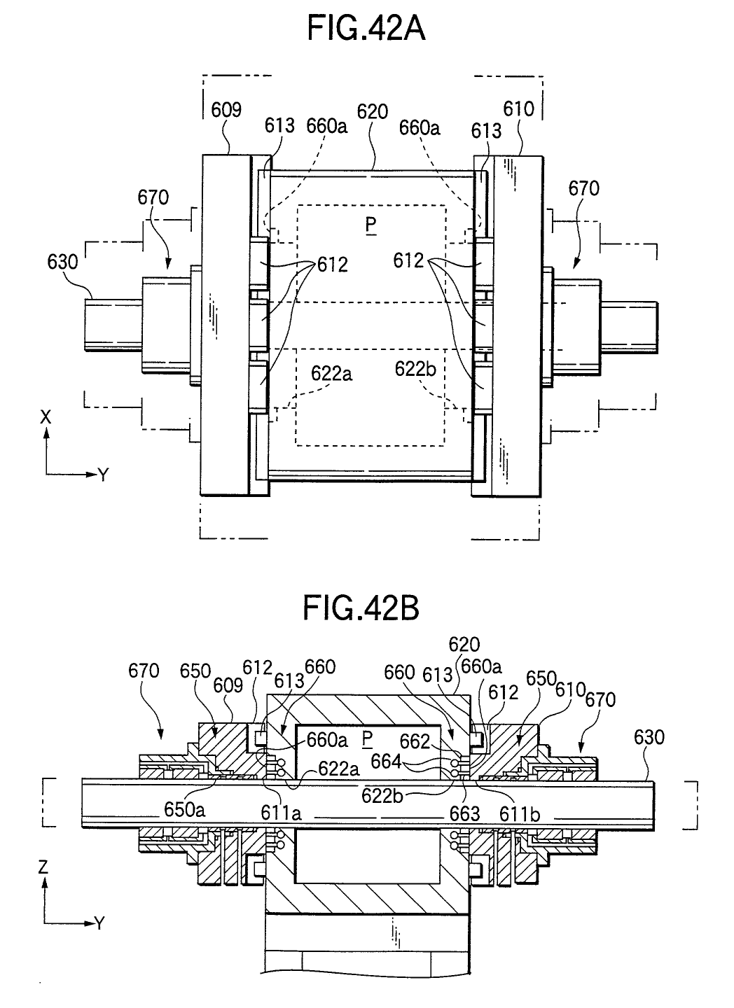

A fourteenth embodiment of the invention will be described below. This embodiment is configured so that the shaft member in the positioning device according to the twelfth embodiment is supported by an X-axis stage which can move in the X-axis direction. FIG. 42A is a plan view of the positioning device according to this embodiment. FIG. 42B is a front view of the positioning device according to this embodiment. In FIG. 42A, the up-down direction is defined as an X-axis direction and the left-right direction as a Y-axis direction. In FIG. 42B, the up-down direction is defined as a Z-axis direction. Incidentally, in this embodiment, parts the same as those in the twelfth embodiment are referenced correspondingly and the description thereof will be therefore omitted.

As shown in FIGS. 42A and 42B, in the positioning device according to this embodiment, a columnar shaft member 630 is inserted through a pair of slit-like long holes 622a and 622b which are provided in opposite surfaces of a box 620 having a process chamber P and which are extended in the X-axis direction. Further, a pair of X-axis stages 609 and 610 through which the shaft member 630 passes and which support the shaft member 630 so that the shaft member 630 can slide in the Y-axis direction are provided on the outside of the box 620. In such a manner, the pair of X-axis stages 609 and 610 can slide relatively in the X-axis direction along the outer wall surface of the box 620 in a state in which the pair of long holes 622a and 622b are closed with the pair of X-axis stages 609 and 610 respectively.

The X-axis stages 609 and 610 have circular openings 611a and 611b in their centers respectively. Y-axis differential evacuation seals 650 as described in the twelfth embodiment are provided in the openings 611a and 611b respectively. The columnar shaft member 630 is inserted through the openings 611a and 611b of the X-axis stages 609 and 610 and the circumferential surface of the columnar shaft member 630 which is a seal surface is partially surrounded by the differential evacuation seals 650.

Sliders 612 each U-shaped in section are disposed on the right-side surface of the X-axis stage 609 and the left-side surface of the X-axis stage 610. The sliders 612 are engaged with guide rails 613 disposed on the box 620 which is a stationary portion, through a large number of rolling bodies (not shown) but circulating in the sliders 612, so that the sliders 612 are slidable along the guide rails 613 in the X direction. The sliders 612, the guide rails 613 and the large number of rolling bodies constitute a linear guide which is a kind of a roller guide bearing.

In FIG. 42B, X-axis differential evacuation seals 660 are provided on the left-side surface and the right-side surface of the box 620. The differential evacuation seals 660 are shaped like tracks extended along the circumferences of the long holes 622a and 622b, respectively, formed in the box 620. A surface 660a of the track-like portion opposite to the X-axis stage 609 (610) functions as an evacuation surface of the differential evacuation seal 660. Each of the differential evacuation seals 660 further forms two track-like grooves (not shown). The grooves communicate with communicating passages 664, which are formed in the box 620, through internal passages 662 and 663 of the evacuation seal 660. The communicating passages are connected to a suction pump (not shown). The evacuation surface 660a except the groove portions is slightly protruded outward to the X-axis stage 609 (610) compared with the portion of the box 620 opposite to the X-axis stage 609 (610) provided outside the evacuation surface 660a. The linear guides 612 and 613 set the protruded portions and the surfaces (opposite seal surface) of the X-axis stages 609 and 610 opposite thereto so that the protruded portions are opposite to the surfaces at a sufficiently small distance compared with the portions provided outside the protruded portions.

Cylindrical bearing portions 670 as described in the twelfth embodiment are attached into the openings 611a and 611b of the X-axis stages 609 and 610 respectively.

The operation of the positioning device according to this embodiment will be described below. The X-axis stages 609 and 610 are supported relative to the box 620 in a low friction state by the linear guides 612 and 613. Hence, the X-axis stages 609 and 610 are driven interlockingly by an external drive source (not shown) so that the X-axis stages 609 and 610 can move in the X-axis direction relative to the box 620. On this occasion, the shaft member 630 moves together with the X-axis stages 609 and 610 in the X-axis direction. The long holes 622a and 622b (equivalent to openings in the invention) of the box 620 permit the shaft member 630 to move in the X-axis direction. In other words, the X-axis stages 609 and 610 can move in the X-axis direction relative to the box 620 within a range defined by the length of each of the long holes 622a and 622b in the longitudinal direction.

On this occasion, the differential evacuation seals 660 having the evacuation surfaces 660a sucks air between the box 620 and the left-side surface of the X-axis stage 609 and between the box 620 and the right-side surface of the X-axis stage 610 through the communicating passages of the box 620 on the basis of the suction force of a suction pump (not shown). Hence, the process chamber P can be prevented from being invaded by external air and foreign matter through the gaps between the box 620 and the X-axis stage 609 and between the box 620 and the X-axis stage 610. Accordingly, even in the case where the process chamber P in the box 620 is put in a vacuum environment in order to process the work, the process chamber P can be preferably kept in the vacuum environment because the differential evacuation seals 660 can prevent external air from entering the process chamber P.

On the other hand, the left end of the shaft member 630 is connected to a drive source (not shown) disposed on the X-axis stage 609 so that the shaft member 630 is driven left and right. On this occasion, air compresively fed from the pressure pump (not shown) through the communicating passages (not shown) but formed in the bearing portions 670 is jetted out from the inner circumferential surfaces of the static-pressure bearings. Hence, the shaft member 630 is supported contactlessly with the static-pressure bearings by such air pressure, so that the shaft member 630 can move relative to the X-axis stages 609 and 610 without any frictional resistance.

Further, the differential evacuation seals 650 having the evacuation surface 650a sucks air between the evacuation surfaces 650a and the circumferential surface (opposite seal surface) of the shaft member 630 through the grooves and the communicating passages by the suction pump (not shown). Hence, the process chamber P can be prevented from being invaded by external air or air leaked out from the static-pressure bearings through the gaps (kept constant by the static-pressure bearings) between the evacuation surfaces 650a and the shaft member 630. Particularly even in the case where the process chamber P in the box 620 is put in a vacuum environment to process the work, the vacuum environment of the process chamber P can be preferably retained because the differential evacuation seals 650 can prevent the process chamber P from being invaded by external air.

According to this embodiment, in the same manner as in the twelfth embodiment, suction forces (or repulsion forces) acting on the shaft member 630 cancel out each other because the shaft member 630 passes through the pair of opposite holes 622a and 622b. That is, because there is no thrust force acting on the shaft member 630, an excessive load is not imposed on the device driving the shaft member 630 so that imbalance due to the direction of the movement is eliminated. In addition, distortion of the shaft member 630 is also suppressed. Hence, positioning accuracy is also improved.

Moreover, in accordance with this embodiment, contamination of the process chamber P can be prevented and maintenance of the drive system can be made easy without necessity of providing any drive system in the process chamber P because the shaft member 630 is driven from the outside of the box 620. Moreover, this embodiment has an advantage in that distortion of the shaft member 630 is small because the shaft member 630 is supported at two points.

Further, the suction force of each of the differential evacuation seals 660 is defined in the track-like range. Hence, even in the case where the size of the box 620 is made large, the total length of the differential evacuation seal 660 is not necessarily made large. Hence, supporting reaction force of sliders and guide rails constituting roller guide bearings does not change. Moreover, in surfaces of the X-axis stages 609 and 610 opposite to the box 620, portions outside the evacuation surfaces 660a receive force equal to the atmospheric pressure. Hence, in consideration of the distribution of pressure acting on the front and rear surfaces of the X-axis stages 609 and 610, differential pressure between the front and rear surfaces is present in limited portions inside the evacuation surfaces 660a. Hence, force to be supported by the linear guides 612 and 613 may be small so long as the force can act against the sum of differential pressures in the limited area. Even in the case where the volume of the box 620 is increased to increase the stroke quantity of the shaft member 630 when the process chamber P is in a vacuum environment, the force received by the shaft member 630 does not change and, accordingly, the force applied on end surfaces of the shaft member 630 due to differential pressure generated between the inside and outside of the process chamber does not change.

The positioning device according to this embodiment has an advantage in that its structure is compact.

Although the invention has been described above with the embodiment, not to say, various changes and modifications may be made on the embodiment without limiting the explanation of the invention to the embodiment. For example, description has been made on the case where two groove portions are provided in each of the evacuation surface 650a and 660a. However, the invention is not limited thereto and one groove portion or three or more groove portions may be provided in accordance with the performance of the suction pump and the magnitude of differential pressure between the inside and outside of the process chamber. The size of the gap between each evacuation surface and the opposite seal surface is also determined in accordance with the performance of the suction pump and can be selected suitably to be in a range of from the order of microns to the order of hundreds of microns. The bearings are not limited to the static-pressure bearings or the linear guides 612 and 613 as described in this embodiment. Any kind of bearings maybe used as the bearings. For example, roller bearings (such as ball bearings or roller bearings) may be used as the bearings of the shaft member 630, and the linear guides 612 and 613 used as the guide bearings for the X-axis stages 609 and 610 may be replaced by static-pressure guide bearings each using a known gas or a known magnetic fluid as the medium, or other roller guide bearings (such as cross roller guides).

The differential evacuation seals 660 may be integrated with the box 620 or may be provided separately from the box 620. Further, the evacuation surfaces 660a protruded out from the outer portion of the box 620 may be replaced by evacuation surfaces having grooving portions communicate with the atmosphere, so that outer one of the two groove portions in each of the evacuation surfaces 660a communicates with the atmosphere. In addition, when a rotation drive mechanism is provided in the shaft member 630, the shaft member 630 can be rotated freely relative to the X-axis stages 609 and 610 remotely from the outside and, accordingly, a triaxial positioning device can be formed. On the contrary, when relative rotation is to be stopped, a shaft shaped like a polygon such as a rectangle in section, an elliptic shaft or a spline shaft can be preferably used as the shaft member without necessity of providing any relative rotation stop device separately. Further, the shapes of the long holes 622a and 622b, the evacuation surfaces 660a and the groove portions of the evacuation surfaces are not limited to the aforementioned shapes.

Although this embodiment has shown the case where the differential evacuation seals 660 are provided on the box 620 sides so as to be adjacent to the long holes 622a and 622b, the invention may be applied also to the case where the differential evacuation seals 660 are provided on the sides of the X-axis stages 609 and 610. In this case, it is however necessary to form the evacuation surfaces 660a so that the evacuation surfaces 660a surround the long holes 622a and 622b respectively in the all movable range of the X-axis stages 609 and 610 when the evacuation surfaces 660a are viewed from the direction opposite to the long holes 622a and 622b. Incidentally, in order to suppress the magnitude of supporting reaction force received by the guide bearings, it is preferable that the area surrounded by each of the evacuation surfaces 660a is set to be as small as possible within a range satisfying the condition.

In addition, this embodiment has shown the case where the box 620 is provided as a stationary portion and the X-axis stages 609 and 610 as movable portions. Inversely, the invention may be applied also to the case where the X-axis stages 609 and 610 are provided as stationary portions and the box 620 as a movable portion. In this case, two differential evacuation seals may be disposed collectively on the side of the X-axis stages as stationary portions so that pipes can be laid easily.

Fifteenth, sixteenth, seventeenth, eighteenth and nineteenth embodiments obtained by more concretizing the twelfth, thirteenth and fourteenth embodiments will be described below. These embodiments will be described on equipment which can be used preferably in a predetermined process applied to a work mounted in a high vacuum and which particularly hates the influence of magnetic field. That is, these embodiments are configured so that a motor having influence on magnetic field is disposed as far from the process chamber as possible and so that the motor itself does not move.

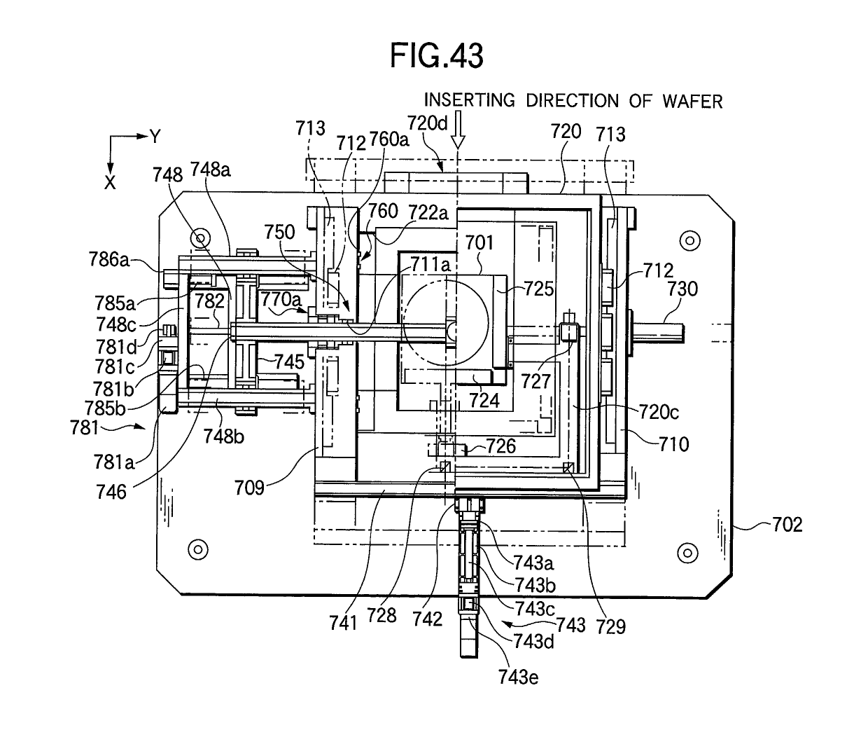

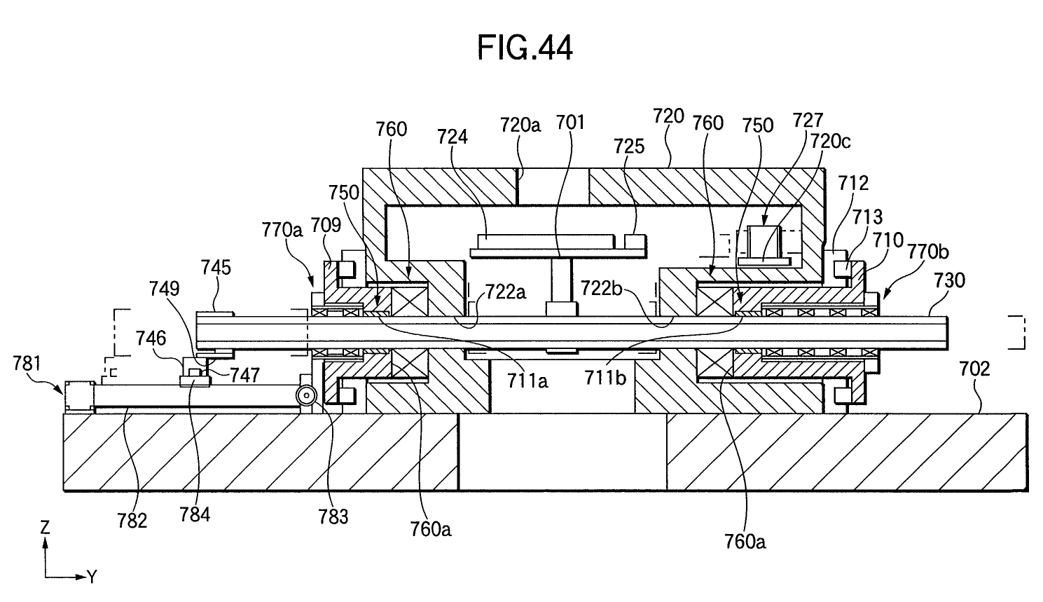

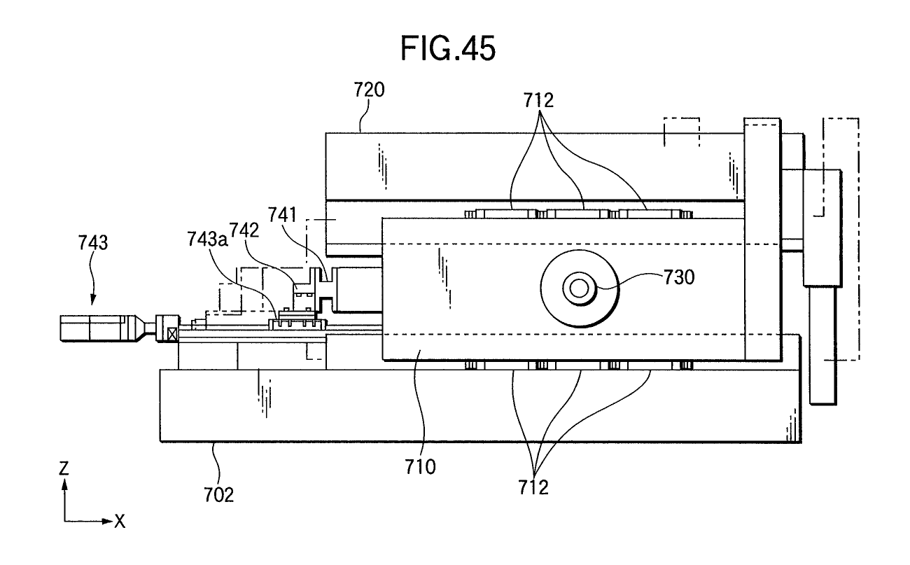

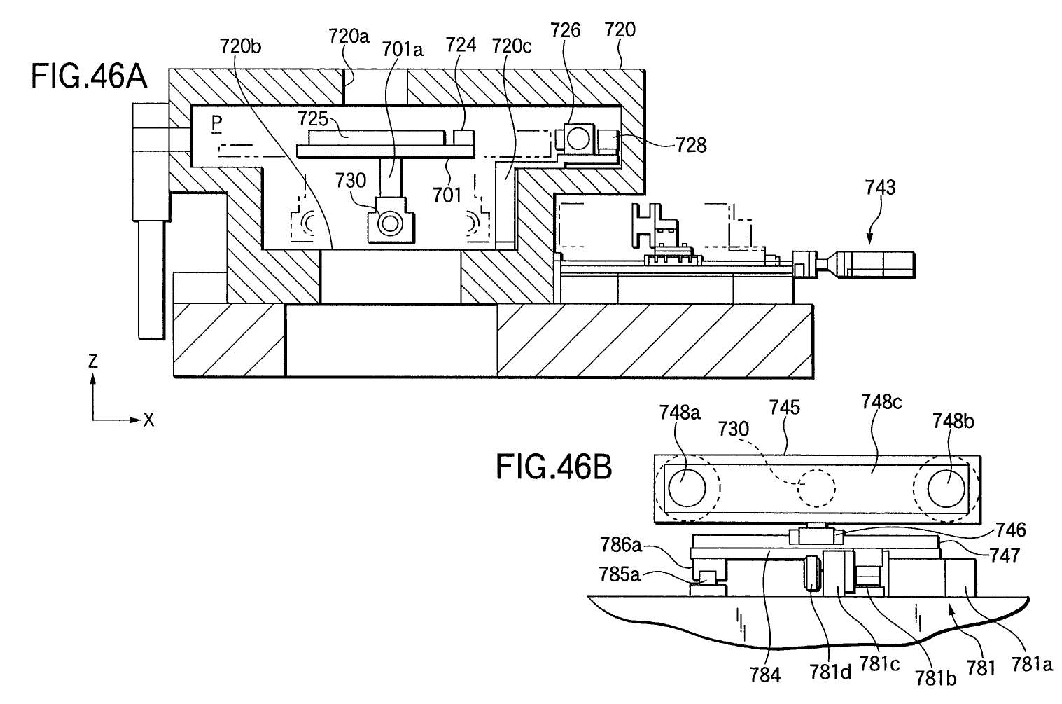

First, the fifteenth embodiment of the invention will be described with reference to FIGS. 43 to 45, and FIGS. 46A and 46B. FIG. 43 is a plan view (partial sectional view) of a positioning device according to the embodiment. FIG. 44 is a front view of the positioning device depicted in FIG. 43. FIG. 45 is a right-side side view of the positioning device depicted in FIG. 43. FIGS. 46A and 46B are left-side side views of the positioning device depicted in FIG. 43 (FIG. 46A is the whole view while. FIG. 46B is the partial view). In FIG. 43, the up-down direction is defined as an X-axis direction and the left-right direction as a Y-axis direction. In FIG. 44, the up-down direction is defined as a Z-axis direction.

The positioning device according to this embodiment is configured in the same manner as in the fourteenth embodiment as follows. A columnar shaft member 730 is inserted through a pair of slit-like long holes 722a and 722b which are provided in opposite surfaces of a box (chamber) 720 having a process chamber P and which are extended in the X-axis direction. A pair of X-axis stages 709 and 710 through which the shaft member 730 passes and which support the shaft member 730 so that the shaft member 730 can slide in the Y-axis direction are disposed on the outside of the box 720 respectively. In such a manner, the pair of X-axis stages 709 and 710 can slide relatively in the X-axis direction along the outer wall surface of the box 720 in a state in which the pair of long holes 722a and 722b are filled with the pair of X-axis stages 709 and 710 respectively. In this embodiment, the pair of X-axis stages 709 and 710 are coupled with each other by coupling members 741 and 742 so that the pair of X-axis stages 709 and 710 are integrally driven by an actuator 743 including a motor 743e.

Incidentally, a table 701 on which a work will be mounted is protruded from the shaft member 730 so that the table 701 is located in the process chamber P. In this embodiment, the X-axis stages 709 and 710, the box 720 and the shaft member 730 are disposed on a base 702. An opening 720a is provided in the upper surface of the box 720 so that the opening 720a communicates with a chamber prepared for a processing device (not shown). As occasion demands, a window of quartz glass may be attached to the opening. An X bar mirror 724 and a Y bar mirror 725 are disposed on the table 701. A positioning X-axis laser interferometer 726 and a positioning Y-axis laser interferometer 727 are disposed in the box 720 so as to be opposite to the X bar mirror 724 and the Y bar mirror 725 respectively. A beam splitter 728 splits a laser beam emitted from a laser light source (not shown) into two beams to be led to two laser interferometers 726 and 727. A beam bender 729 changes the direction of a laser beam to lead the laser beam to the laser interferometer 727. A gate valve 720d for transferring a wafer is provided on a side surface of the box 720. Incidentally, openings provided in the bottom surface of the box 720 and in the base 702 respectively form a space in which a vacuum pump is put in order to evacuate the box. The process chamber P is shaped so that its upper portion receiving the table 701 is wide whereas its lower portion adjacent to a floor surface 720b is narrow. This configuration is made for the purpose of minimizing the volume of the process chamber while the range of movement of the table 701 is retained. Therefore, the table 701 is erected through a support post 701a. In this manner, evacuation force received by the process chamber can be minimized. Moreover, because the width of the lower portion of the process chamber is small, there is a merit that minimization of distortion of the shaft member 730 can be attained.

The X-axis stages 709 and 710 have circular openings 711a and 711b in their centers respectively. Y-axis differential evacuation seals 750 as described in the twelfth embodiment are provided in the openings 711a and 711b respectively. The columnar shaft member 730 is inserted through the openings 711a and 711b of the X-axis stages 709 and 710. The circumferential surface of the shaft member 730 as a seal surface is partially surrounded by differential evacuation seals 750.

Sliders 712 each U-shaped in section are disposed on the right-side surface and the left-side surface of the box 720 which is a stationary portion. The sliders 712 are engaged with guide rails 713 disposed on the X-axis stages 709 and 710, through a large number of rolling bodies (not shown) but circulating in the sliders 712, so that the sliders 712 are slidable along the guide rails 713 in the X direction. The sliders 712, the guide rails 713 and the large number of rolling bodies constitute a linear guide which is a kind of a roller guide bearing.

Further, X-axis differential evacuation seals 760 are provided on the left-side surface and the right-side surface of the box 720 in the same manner as described in the fourteenth embodiment. The differential evacuation seals 760 are shaped like tracks extended along the circumferences of the long holes 722a and 722b, respectively, formed in the box 720. A surface 760a of the track-like portion opposite to the X-axis stage 709 (710) functions as an evacuation surface of the differential evacuation seal 760. The evacuation surfaces 760a of each differential evacuation seal 760 further forms two track-like grooves (not shown). The grooves communicate with communicating passages (not shown), which are formed in the box 720, through internal passages (not shown) of the differential evacuation seal 760. The communicating passages are connected to a suction pump (not shown). The evacuation surface 760a except the groove portions is slightly protruded outward to the X-axis stage 709 (710) compared with the portion of the box 720 opposite to the X-axis stage 709 (710) provided outside the evacuation surface 760a. The linear guides 712 and 713 set the protruded portions and the surfaces (opposite seal surface) of the X-axis stages 709 and 710 opposite thereto so that the protruded portions are opposite to the surfaces at a sufficiently small distance compared with the portions provided outside the protruded portions.

Approximately cylindrical bearing portions 770a and 770b as described in the twelfth embodiment are attached onto the openings 711a and 711b of the X-axis stages 709 and 710 respectively.

As described above, in this embodiment, the two X-axis stages 709 and 710 are coupled with each other by coupling members 741 and 742 so that the two X-axis stages 709 and 710 are integrally driven by an actuator 743. The actuator 743 includes a nut bearing unit 743a, guide rails 743b, a ball screw shaft 743c, a coupling 743d and a motor 743e. The nut bearing unit 743a fixed and connected to the coupling member 742 moves in the X-axis direction with the rotation of the ball screw shaft 743c.

As a mechanism for driving the X-axis stages 709 and 710 other than the coupling members 741 and 742 and the motor 743, a linear guide having an X-axis auxiliary guide bearing 746 and an X-axis auxiliary guide rail 747 is provided under a rotation stopper 745 into which the shaft member is inserted and fixed. A leaf spring 749 is disposed between the rotation stopper 745 and the X-axis auxiliary guide bearing 746 in order to prevent force from acting on the radial direction of the shaft member 730. Opposite ends of the rotation stopper 745 form rotation stopper guides 748a and 748b supported by static-pressure bearings. One end of the rotation stopper guides 748a and 748b is fixed to the X-axis stage 709 and the other end is fixed to a receiving member 748c.

On the other hand, in this embodiment, an actuator 781 (including a motor 781a, a coupling 781b, a pulley support portion 781c, and a drive pulley 781d), a drive belt 782 stretched on the drive pulley 781d, a driven pulley 783 paired with the drive pulley 781d, a Y-axis slider 784 fixed onto the upper side of the drive belt 782, a pair of Y-axis guide rails 785a and 785b disposed in parallel to the Y-axis slider 784, and Y-axis guide bearings 786a and 786b (786b not shown) paired with the Y-axis guide rails 785a and 785b respectively and fixed to the bottom portion of the Y-axis slider 784 are provided in order to drive the shaft member 730 in the Y-axis direction. In this manner, when the motor 781a is driven, the shaft member 730 can be moved in the Y direction. Incidentally, the X-axis auxiliary guide rail 747 is fixed on the upper surface of the Y-axis slider 784.

That is, the positioning device according to this embodiment has an X-axis actuator, a Y-axis actuator, and an auxiliary stage. The X-axis actuator includes an X-axis motor 743e fixed to the base, and an X-axis drive mechanism for converting the rotation motion of the motor into linear movement in the X-axis direction to thereby position the X-axis stage in the X-axis direction. On the other hand, the Y-axis actuator includes a Y-axis motor 781a fixed to the base, and a Y-axis drive mechanism for converting the rotation motion of the motor into linear movement in the Y-axis direction to thereby position the shaft member 730 in the Y-axis direction. The auxiliary stage permits the shaft member to move in the X-axis direction with the movement of the X-axis stage by the X-axis actuator. Incidentally, the laser interferometers 726 and 727, the beam splitter 728 and the beam bender 729 are placed and fixed on a support member 720c fixed to the bottom surface 720b of the box 720. The support member 720c is configured so that the support member 720c touches only the floor surface 720b in the box 720 but touches neither the side walls nor the floor surface which is the widened portion of the upper portion. This configuration is made for the purpose of applying a vibration absorbing mechanism (not shown) to the laser interferometers set on the floor surface 720b little in vibration through the support member to thereby locally minimize the influence of vibration to improve positioning accuracy. The upper portion of the box 720 than the side walls is slightly deformed by the pressure difference between the inside and outside of the process chamber when the inside of the process chamber is decompressed. Hence, also from this point of view, the provision of the laser interferometers through the support member 720c fixed on the floor surface 720b little deformed by the pressure difference between the inside and outside of the process chamber is favorable for high-accurate positioning.

The same effect as in the fourteenth embodiment can be obtained also in this embodiment. This embodiment has a further feature in that the two X-axis stages 709 and 710 are coupled with each other so as to be integrally driven. Moreover, in this embodiment, the motors 743e and 781a for performing driving in the two, X and Y directions are far from the process chamber P and the motors 743e and 781a themselves do not move. Hence, the influence of magnetic field from the motors on the beam used for a process in the process chamber P can be minimized.

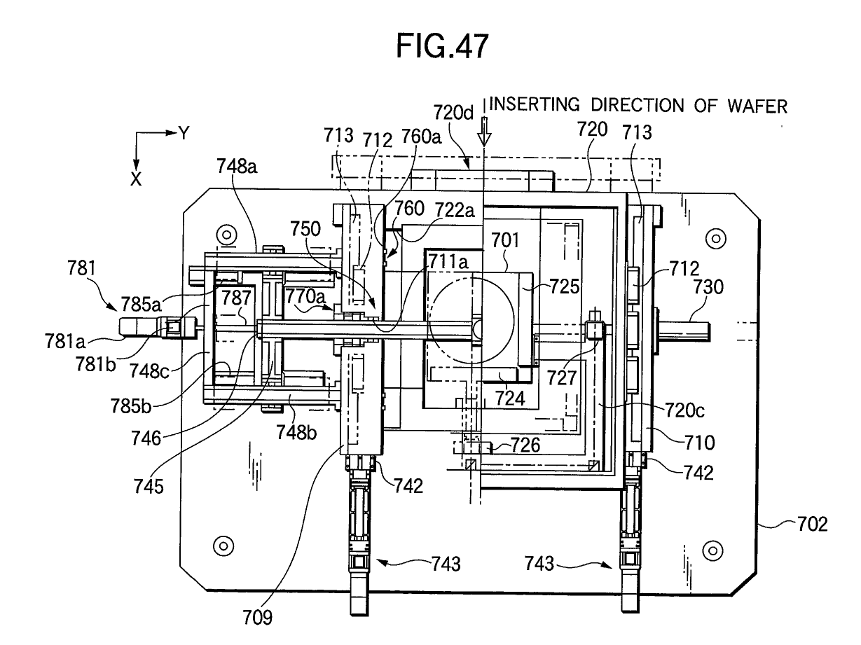

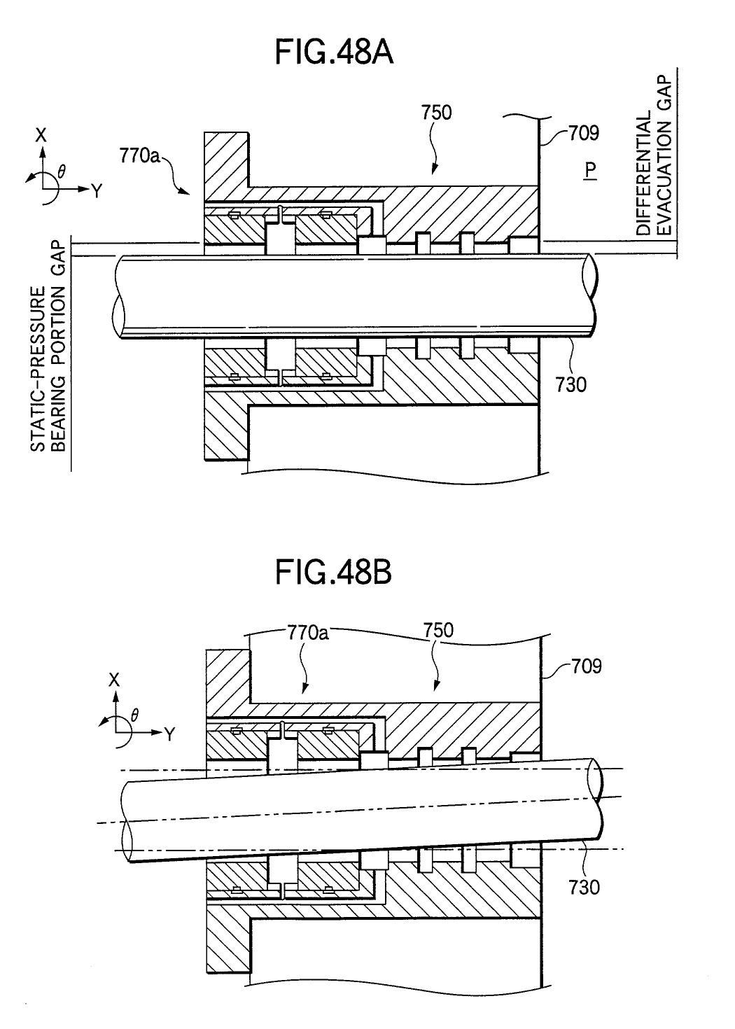

The sixteenth embodiment of the invention will be described below with reference to FIG. 47 and FIGS. 48A and 48B. FIG. 47 is a plan view (partial sectional view) of a positioning device according to the embodiment. FIGS. 48A and 48B are detailed views of a Y-axis bearing portion in the embodiment. In FIG. 47, the up-down direction is defined as an X-axis direction and the left-right direction as a Y-axis direction. In this embodiment, parts the same as those in the fifteenth embodiment are referenced correspondingly and the description thereof will be therefore omitted.

The positioning device according to this embodiment is different from the positioning device according to the fifteenth embodiment in that actuators 743 are connected to the X-axis stages 709 and 710 through coupling members 742 respectively. The two actuators 743 are driven in synchronism with each other.

Although the fifteenth embodiment has shown the case where pulleys and a belt are used for driving the Y-axis slider 784, this embodiment shows the case where a ball screw 787 is used. A nut of the ball screw is fixed onto the lower surface of the Y-axis slider 784.

The same effect as in the fifteenth embodiment can be obtained also in this embodiment. This embodiment has a further feature in that the two X-axis stages 709 and 710 are synchronously driven by the actuators 743 provided individually. Moreover, in this embodiment, the motors 743e and 781a for performing driving in the two, X and Y directions are far from the process chamber P and the motors 743e and 781a themselves do not move. Hence, the influence of magnetic field from the motors on the beam used for a process in the process chamber P can be minimized.

Incidentally, in this embodiment, when the two X-axis stages 709 and 710 are displaced by equal quantities, the distance between the shaft member 730 and each of the two X-axis stages 709 and 710 is kept constant as shown in FIG. 48A. However, when the quantities of displacement of the two X-axis stages 709 and 710 are different from each other, the distance between each of the two X-axis stages 709 and 710 and the shaft member 730 varies in accordance with the place as shown in FIG. 48B. Therefore, to prevent such inclination from occurring, the quantities of X-direction displacement of the X-axis stages 709 and 710 may be controlled to be equal to each other by the two actuators. Inversely, when the quantities of X-direction displacement of the X-axis stages 709 and 710 are controlled to be slightly different from each other by the two actuators 743, the inclination angle of the shaft member 730 in the X-Y plane with the Z axis as its center can be adjusted finely. Incidentally, the adjustable range in this case is limited to a range in which the shaft member 730 touches neither the differential evacuation seal 750 nor the bearing portion 770, as shown in FIG. 48B. As a result, high-accurate positioning can be made.

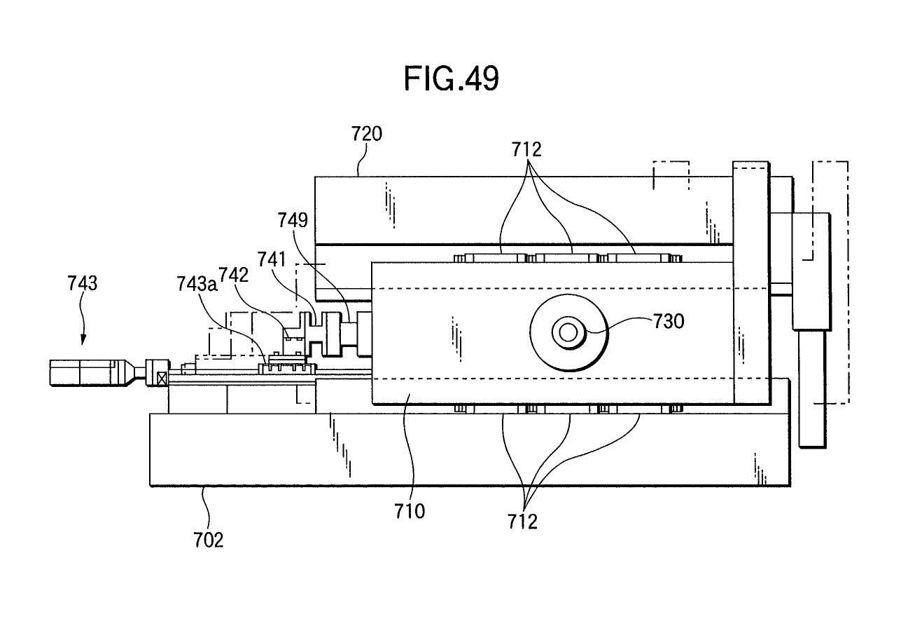

The seventeenth embodiment of the invention will be described below with reference to FIG. 49. FIG. 49 is a side view of the positioning device according to this embodiment and corresponds to FIG. 45. In this embodiment, parts the same as those in the fifteenth embodiment are referenced correspondingly and the description thereof will be therefore omitted.

This embodiment is different from the fifteenth embodiment in that the coupling member 741 and the X-axis slider 709 (710) are connected to each other by a piezoelectric element 749 capable of expanding and contracting in accordance with an electric signal supplied thereto. Hence, the shaft member 730 can be finely rotated around the Z axis by controlling the quantity of expansion and contraction of the left and right piezoelectric elements 749. That is, the same operation and effect as in the sixteenth embodiment can be obtained. Besides the piezoelectric element 749, a magnetostrictive element can be used as an element by which the same effect as in the piezoelectric element can be obtained. In consideration of the change of magnetic field, the piezoelectric element is preferably used.

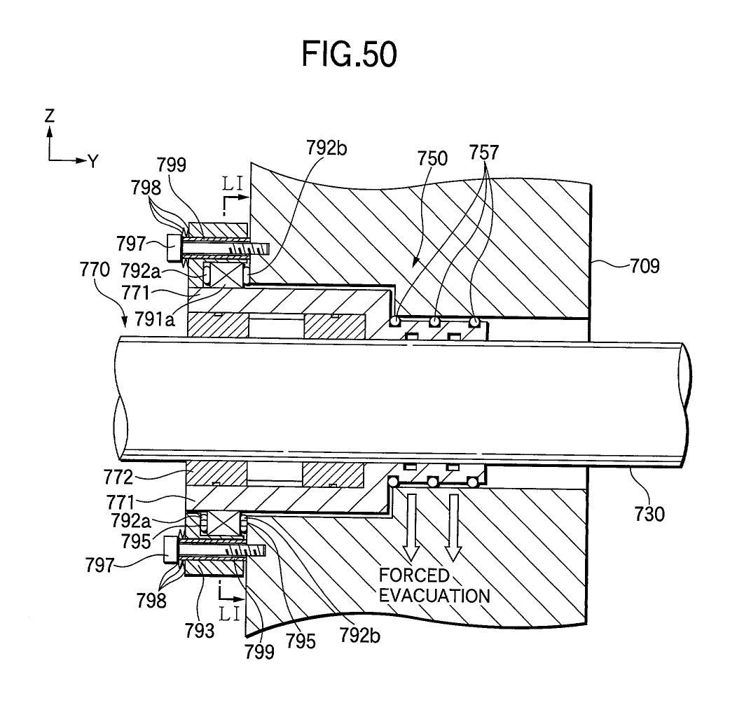

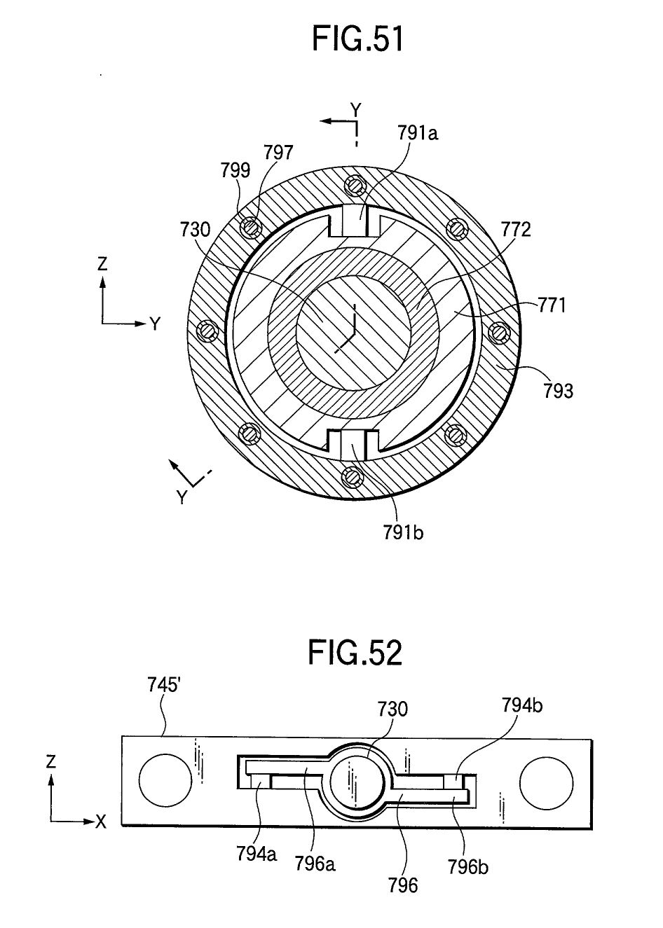

The eighteenth embodiment of the invention will be described below with reference to FIGS. 50 to 52. FIG. 50 is a side view of important part of a positioning device according to the embodiment (showing a section taken along the line Y-Y in FIG. 51). FIG. 51 is a sectional view taken along the line LI-LI in FIG. 50. FIG. 52 is a typical view of a rotation stopper portion in the positioning device according to the embodiment. In this embodiment, parts the same as those in the fifteenth embodiment are referenced correspondingly and the description thereof will be therefore omitted.

As shown in FIGS. 50 and 51, in this embodiment, O-rings 757 are disposed between an X-axis stage 709 and a housing 771 which has a differential evacuation seal 750 and a bearing portion 770 in its inside. An annular pre-load ring 793 is disposed on the outside of the housing 771. An outward flange portion of the housing 771 is sandwiched between an inward flange portion of the pre-load ring 793 and the X-axis stage 709. Two piezoelectric elements 791a and 791b are disposed in two, upper and lower notch portions in the flange portion of the housing 771 and held between the pre-load ring 793 and the housing 771. The pre-load ring 793 is fixed to the X-axis stage 709 through bolts 797, dish springs 798, sleeves 799, steel balls 795 (which will be described later) and a flange 771a of the housing 771. Ring-like retainers 792a and 792b are disposed in the front and rear of the flange 771a of the housing 771 and the piezoelectric elements 791a and 791b. A large number of holes are formed in each of portions of the retainers 792a and 792b opposite to the flange portion of the housing 771. Steel balls 795 each having a small diameter (slightly larger than the width of each of the retainers 792a and 792b) are embedded in the holes respectively. As light gap is formed between the pre-load ring 793 and the X-axis stage 709. The flange portion of the housing 771 is held by the elastic force of the dish springs 798 in a state in which the flange portion suffers pre-load of the steel balls 795 from the front and rear. The sleeves 799 are fitted onto the bolts 797 respectively. The length of each of the sleeves 799 is set so that pre-load due to the dish springs 798 takes a moderate value when the bolt 797 is tightened to abut against an end surface of the sleeve 799 so that the sleeve 799 is sandwiched between the bolt 797 and the X-axis stage 109. Further, a slight gap is also formed between the housing 771 and the X-axis stage 709. The flange portion of the pre-load ring 793, the retainers 792a and 792b and the steel balls 795 constitutes an X-Z plane guide. The X-Z plane guide permits the housing 771 of the bearing portion 770 to move finely in the X-Z plane but prohibits it from moving in the Y direction. Incidentally, the roller guide provided with the steel balls 795 may be replaced by a static-pressure guide. The X-axis stage 710 side has the same configuration as described above.

In this embodiment, the piezoelectric elements 791a and 791b expand and contract in the Z direction on the basis of electric signals given from the outside. On this occasion, when the quantity of expansion and contraction of the piezoelectric element 791a and the quantity of expansion and contraction of the piezoelectric element 791b are controlled to be inverted in sign but equal in magnitude, the housing 771 moves finely in the radial direction (Z-axis direction) on the basis of the expansion and contraction of the piezoelectric elements 791a and 791b in the radial direction and the deformation of the O-rings 757. When the housings 771 of the X-axis stages 709 and 710 are controlled to move finely in directions reverse to each other, the shaft member 730 can be rotated around the X axis within the range of the gap between the shaft member 730 and each housing 771 with the bearing 772. Hence, fine adjustment of the inclination angle of the shaft member 730 in the Y-Z plane with the X axis as its center can be achieved.

Further, in this embodiment, at the rotation stopper 745′, the shaft member 730 is inserted and fixed into a fine rotation portion 796 having two arm portions 796a and 796b. Piezoelectric elements 794a and 794b are disposed between the arm portion 796a and the lower wall of the opening provided in the rotation stopper 745′ and between the arm portion 796b and the upper wall of the opening in the rotation stopper 745′ respectively. Hence, the rotation angle of the shaft member 730 around the Y axis can be adjusted finely by controlling the quantity of expansion and contraction of the piezoelectric element 794a and the quantity of expansion and contraction of the piezoelectric element 794b to be equal to each other. Incidentally, when this embodiment is combined with the sixteenth or seventeenth embodiment, the shaft member 730 can be rotated finely around the Z axis as well as around the X axis and around the Y axis. Either of the piezoelectric elements 791a and 791b maybe replaced, for example, by a coiled spring, rubber, or another elastic body.

Further, O-rings may be provided between the pre-load ring 793/X-axis stage 709 or 710 and the outward flange of the housing 771 instead of the plurality of steel balls 795 and the pre-load ring may be fixed to the X-axis stage 709 or 710 without interposition of any dish spring. In this case, the inclination of the housing 771 can be changed as well as the housing 771 can be moved finely in the radial direction (Z-axis direction), so that the adjustable range can be widened more greatly.

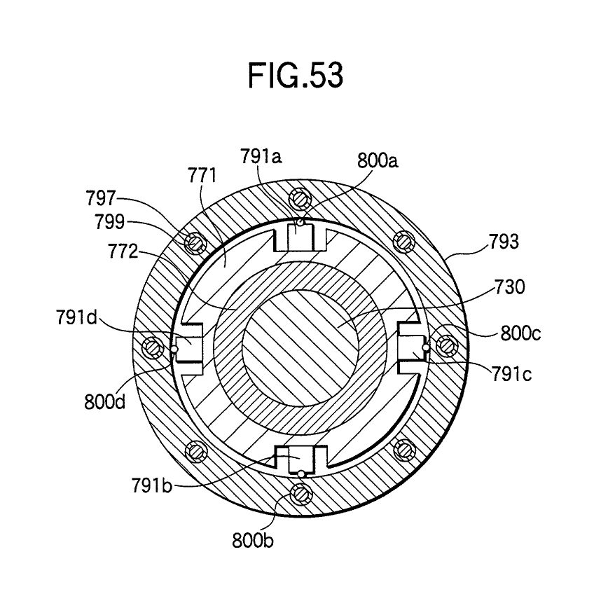

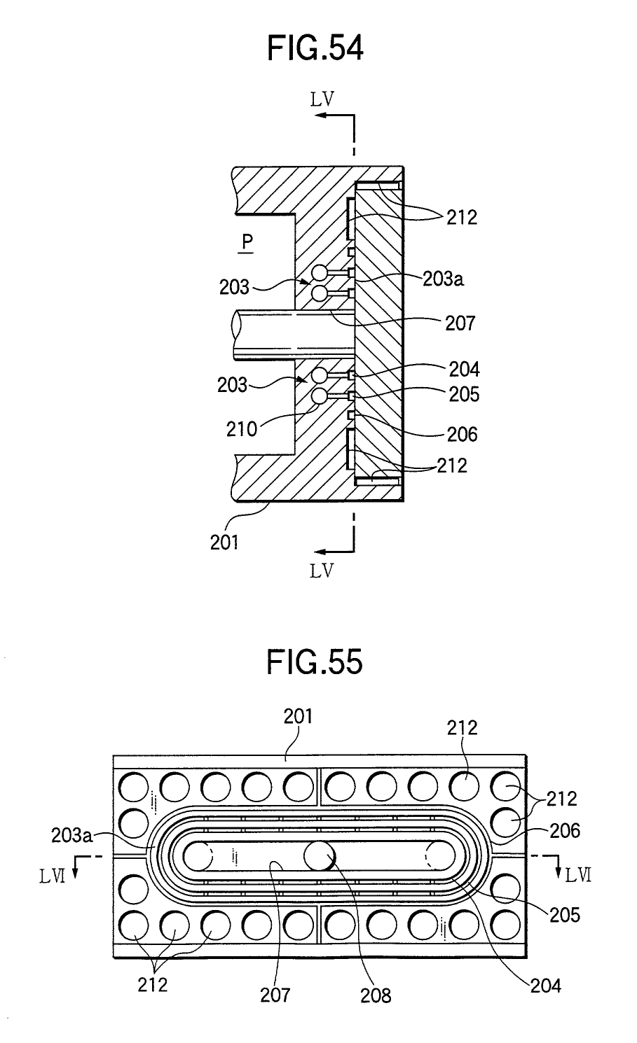

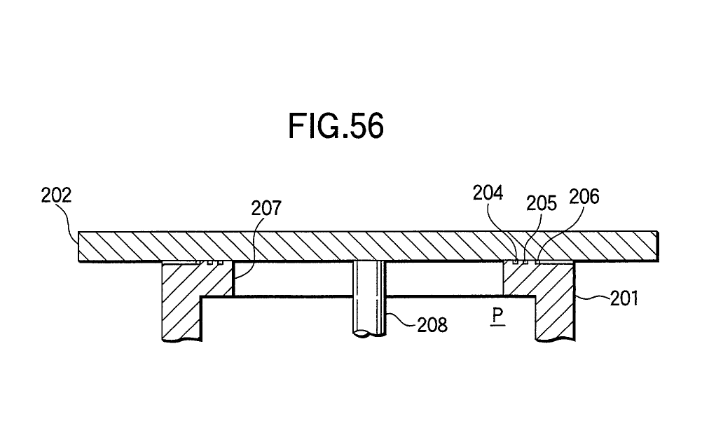

The nineteenth embodiment of the invention will be described below with reference to FIG. 53. FIG. 53 is a sectional view of a shaft member incorporated in a positioning device according to the embodiment. In this embodiment, parts the same as those in the eighteenth embodiment are referenced correspondingly and the description thereof will be therefore omitted.

The positioning device according to this embodiment is different from the positioning device according to the eighteenth embodiment in that two pairs of opposite piezoelectric elements 791a, 791b; 791c, 791d are disposed and in that small-diameter balls 800a, 800b; 800c, 800d are disposed respectively between the piezoelectric elements 791a, 791b; 791c, 791d and the pre-load ring 793. Hence, in this embodiment, fine adjustment of the inclination angle of the shaft member 730 in the Y-Z plane with the X axis as its center and fine adjustment of the inclination angle of the shaft member 730 in the X-Y plane with the Z axis as its center can be achieved. Incidentally, the balls 800a, 800b; 800c, 800d may be omitted if the quantity of expansion and contraction is slight. Further, the balls 800a, 800b; 800c, 800d may be replaced by hinges. One piezoelectric element in each pair of piezoelectric elements may be replaced by a coiled spring or another elastic body.

In the positioning device according to any one of the twelfth, thirteenth, fourteenth, fifteenth, sixteenth, seventeenth, eighteenth and nineteenth embodiments, the introduction shaft passes through a pair of openings opposite to each other, so that suction forces (or repulsion forces) acting on the introduction shaft cancel out each other. That is, because no thrust force acts on the introduction shaft, there is no excessive load imposed on the device of driving the introduction shaft. Hence, imbalance in accordance with the direction of the movement is eliminated and distortion of the introduction shaft is suppressed. Hence, positioning accuracy is improved.

Various changes and modifications may be made upon the first to nineteenth embodiments and these embodiments may be combined suitably.

What is claimed is:

1. A sealing device comprising:
a box including a process chamber communicating with an outside through an opening;
a slider slidable relative to said box in a state that said opening is closed with a gap therebetween;
a differential evacuation seal provided on the box side for sealing said gap; and
a roller bearing disposed between said box and said slider in said outside.

2. A sealing device according to claim 1, wherein said roller bearing is constituted by a linear guide including a bearing which is fixed to said box.

3. A sealing device according to claim 1, further comprising:
an introduction shaft facing said process chamber through said opening,
wherein said introduction shaft is supported by said slider so as to be slidable in an axial direction thereof.

4. A sealing device according to claim 1, further comprising:
an introduction shaft facing said process chamber through said opening,
wherein said differential evacuation seal includes a first differential evacuation seal provided in said gap between said box and said slider, and a second differential evacuation seal provided in another gap between said slider and said introduction shaft,
wherein said second differential evacuation seal has a first region adjacent to said process chamber, and a second region farther from said process chamber than said first region,
wherein at least one portion of said first region is made of a material excellent in vacuum characteristic compared with said second region, and
wherein a gap distance between said first region and said introduction shaft is larger than another gap distance between said second region and said introduction shaft.

5. A sealing device according to claim 1, further comprising:
an introduction shaft facing said process chamber through said opening,
wherein said differential evacuation seal includes a plurality of differential evacuation sealing units provided in said gap between said box and said slider and another gap between said slider and said introduction shaft, and
wherein said plurality of differential evacuation sealing units communicate with one another through a passage provided in an inside of at least one of said box and said slider, whereby evacuation from said plurality of differential evacuation sealing units is performed through said passage.

6. A sealing device according to claim 1, further comprising:
an introduction shaft movable with at least one degree of freedom relative to said slider,
wherein said opening of said box includes a pair of openings opposite to each other; and
wherein said introduction shaft passes through said pair of openings while sealing said process chamber.

7. A sealing device comprising:
a box including a process chamber communicating with an inside or an outside through an opening;
a slider slidable relative to said box in a state that said opening is closed with a gap therebetween;
a differential evacuation seal including an evacuating mechanism for sealing said gap, said differential evacuation seal including a first region adjacent to said process chamber, and a second region farther from said process chamber than said first region,
wherein said differential evacuation seal having a first region adjacent to said process chamber, and a second region farther from said process chamber than said first region,
wherein at least one portion of said first region is made of a material excellent in vacuum characteristic compared with said second region, and
wherein a gap distance between said first region and said slider is larger than another gap distance between said second region and said slider.

8. A sealing device according to claim 7, wherein said slider is constituted by an introduction shaft facing said process chamber through said opening of said box.

9. A sealing device according to claim 7, wherein said first region is made of ceramics with which a portion of said first region facing said process chamber is coated.

10. A sealing device according to claim 7, wherein:
said first region is made of a material selected from the group consisting of ceramics, stainless steel, titanium alloy and aluminum alloy; and
said second region is made of one of a porous material and a resin.

11. A sealing device comprising:
first, second and third members which are movable relative to one another and each of which has at least one portion exposed to an outside, and the other portion exposed to a process chamber isolated from said outside; and
first and second differential evacuation seals for performing sealing among said first, second and third members,
wherein said first and second differential evacuation seals communicate with each other through a passage provided in the inside of at least one of said first, second and third members, whereby evacuation from said first and second differential evacuation seals is performed through said passages.

12. A sealing device according to claim 11, wherein said first and second differential evacuation seals communicate with each other in series through said passage, and
wherein one end of said passages is formed in the fixed one of said first, second and third members.

13. A positioning device comprising:
said sealing device according to claim 1;
an introduction shaft movable with at least one degree of freedom relative to said box;
a base;
a first actuator including a first motor fixed to said base, and a first drive mechanism for positioning said slider in a first direction by said first motor;
a second actuator including a second motor fixed to said base, and a second drive mechanism for positioning said introduction shaft in a second direction by said second motor; and
an auxiliary stage permitting said introduction shaft to move in said first direction in accordance with the movement of said slider by said first actuator.

14. A positioning device according to claim 13, further comprising:
a fine adjustment mechanism for expanding/contracting a piezoelectric element to finely move said slider in at least one direction.

15. A positioning device according to claim 13, further comprising:
a fine adjustment mechanism for expanding/contracting a piezoelectric element to finely move said introduction shaft in at least one direction.

16. positioning device comprising:
said sealing device according to claim 7;
a base; and
an actuator including a motor fixed to said base, and a drive mechanism for positioning said slider in a predetermined direction by said motor.

17. A positioning device according to claim 16, further comprising:
a fine adjustment mechanism for expanding/contracting a piezoelectric element to finely move said slider in at least one direction.

18. A positioning device comprising:
said sealing device according to claim 11;
a base;
a first actuator including a first motor fixed to said base, and a first drive mechanism for positioning said first member in a first direction by said first motor;
a second actuator including a second motor fixed to said base, and a second drive mechanism for positioning said third member in a second direction by said second motor; and
an auxiliary stage permitting said third member to move in said first direction in accordance with the movement of said first member by said first actuator.

19. A positioning device according to claim 18, further comprising:
a fine adjustment mechanism for expanding/contracting a piezoelectric element to finely move said first member in at least one direction.
